(19) United States
(12) Patent Application Publication
(10) Pub. No.: US 2014/0019311 A1
(43) Pub. Date: Jan. 16, 2014

(54) STORE SYSTEM, CONTROL METHOD THEREOF, AND NON-TRANSITORY COMPUTER-READABLE MEDIUM STORING A CONTROL PROGRAM THEREOF

(71) Applicant: Akio Tanaka, Tokyo (JP)

(72) Inventor: Akio Tanaka, Tokyo (JP)

(73) Assignee: NEC CORPORATION, Tokyo (JP)

(21) Appl. No.: 14/008,481

(22) PCT Filed: Mar. 21, 2012
(86) PCT No.: PCT/JP2012/001933

§ 371 Date: Sep. 27, 2013

(30) Foreign Application Priority Data
Mar. 31, 2011 (JP) 2011-078444

(51) Int. Cl. G06Q 30/06

(52) U.S. Cl. CPC G06Q 30/0643
USPC 705/27.2

(57) ABSTRACT

It comprises a front yard including a display unit that displays commodity images, a receiving unit that receives selection of a commodity desired by the purchaser from among commodities corresponding to the displayed commodity images, an association instruction unit that acquires purchaser identification information identifying the purchaser and makes an instruction to associate commodity identification information identifying the selected commodity and the acquired purchaser identification information with each other, and a handover unit that hands over the selected commodity to the purchaser, and a backyard adjacent to the front yard, the backyard including, a commodity storage unit that stores the commodities corresponding to the commodity images, and a sending unit that takes out the selected commodity from the commodity storage unit on the basis of the associated commodity identification information and purchaser identification information and sends the taken-out commodity as the commodity desired by the purchaser to the handover unit.

### TECHNICAL FIELD

The present invention relates to a store system, a control method thereof, and a non-transitory computer-readable medium storing a control program thereof. In particular, the invention relates to a store system including a front yard that receives, from a purchaser, selection of a commodity and hands over the selected, desired commodity to the purchaser and a backyard which is adjacent to the front yard and includes a commodity storage unit storing multiple commodities; a control method of such a store system; and a non-transitory computer-readable medium storing a control program of such a store system.

### BACKGROUND ART

Patent Literature 1 discloses a technology related to a desired commodity collective handover system for collectively handing over commodities to a purchaser who is purchasing multiple commodities while wandering from store to store. FIG. 27 is a block diagram showing a configuration of a purchased commodity collective handover system according to Patent Literature 1 (hereafter referred to as the store system 900). The store system 900 according to Patent Literature 1 includes a purchaser 91, a store A 92, a store B 93, a store C 94, a common warehouse 95, and a receiving place 96. The store A 92, the store B 93, and the store C 94 correspond to a front yard. The stores 92, 93, and 94 include salesclerks 921, 931, and 941, commodity samples 922, 932, and 942, and store terminals 923, 933, and 943, respectively. The common warehouse 95 corresponds to a backyard. The common warehouse 95 includes a worker 951 and store-specific commodity inventories (store A inventory 952, store B inventory 953, and store C inventory 954). The commodity handover place 96 is located at a place different from the stores 92 to 94 and the common warehouse 95. The purchaser 91 possesses an IC card 911 storing a purchaser ID 912 and moves to the stores 92 to 94 to purchase (order) commodities. In this case, the salesclerks 921 to 941 of the stores register commodities to be purchased by the purchaser 91 in the store terminals 923 to 943, respectively, using the IC card 911 possessed by the purchaser 91. In the common warehouse 95, the worker 951 sorts out the commodities for the purchaser in accordance with information registered at the store terminals 923 to 943 and delivers the commodities to the handover place 96. Subsequently, the purchaser 91 moves to the handover place 96 to receive the purchased commodities.

Examples of an information terminal at which a purchaser selects a commodity include vending machines disclosed in Patent Literature 2 and 3. The vending machine according to Patent Literature 2 includes a flat display that can display approximately full-scale commodity sample images. Thus, the depth of the vending machine can be reduced compared to the case where the vending machine contains real commodity samples.

The vending machine according to Patent Literature 3 is provided with independent sensors adjacent to commodity samples. The purchaser can make payment by bringing a non-contact card close to any of the independent sensors. Thus, it is possible to write commodity-specific sales promotion information to the non-contact card to promote sales on a commodity basis.

Patent Literature 4 discloses a technology related to a method and apparatus for monitoring the state of an elderly person or the like in a home environment.

### CITATION LIST

### Patent Literature

[Patent Literature 1] Japanese Unexamined Patent Application Publication No. 2006-11755
[Patent Literature 2] Japanese Unexamined Patent Application Publication No. 11-232537
[Patent Literature 3] Japanese Unexamined Patent Application Publication No. 2003-6717
[Patent Literature 4] Published Japanese Translation of PCT International Publication for Patent Application, No. 2007-502634

### SUMMARY OF INVENTION

### Technical Problem

However, the technologies according to Patent Literature 1 to 3 described above have a problem that the technologies cannot output selected commodities to each purchaser immediately when each purchaser makes payment. First, the technology according to Patent Literature 1 is not a mechanism for allowing a purchaser to immediately receive purchased commodities. That is, in Patent Literature 1, the purchaser determines whether to purchase a commodity by looking at a real commodity or actually touching the commodity with his or her hand, for example, by checking information or the like described on a side of the commodity. For this reason, each store needs a place which displays real commodities, for example, space including shelves or the like and also needs store staff who manage commodities on display. For example, the store staff need to organize commodities and put them on shelves so that purchasers can see them easily, or need to monitor the commodities to protect them from theft. Further, for a purchaser to purchase a variety of commodities, he or she needs to move in stores, between stores, and to the handover place. Furthermore, in the common warehouse, the worker needs to take out and sort out purchased commodities and also needs to deliver them from the common warehouse to the handover place using a track or the like. These processes take time.

The technologies according to Patent Literature 2 and 3 are targeted at a single purchaser, allow the purchaser to immediately pay for one commodity selected from a single type of commodities, such as cigarette or juice, and output the commodity to hand over it to the purchaser. For this reason, unlike retailers, these technologies are not intended to receive selection of commodities from multiple purchasers in parallel or hand over the selected commodities to each purchaser.

The present invention has been made in view of the above problems, and an object thereof is to provide a store system that minimizes the moving distance of each purchaser, as well as outputs commodities selected by each purchaser immediately when he or she makes payment, thereby increasing the convenience of the purchaser and reducing the cost of the store; a control method of such a store system; and a non-transitory computer-readable medium storing a control program of such a store system.

### Solution to Problem

A first exemplary aspect of the present invention is a store system includes a front yard including a display means that displays a plurality of commodity images, a receiving means that receives selection of a commodity desired by the purchaser from among commodities corresponding to the displayed commodity images, an association instruction means that acquires purchaser identification information identifying the purchaser and makes an instruction to associate commodity identification information identifying the selected commodity and the acquired purchaser identification information with each other, and a handover means that hands over the selected desired commodity to the purchaser, and a backyard adjacent to the front yard, the backyard comprising, a commodity storage means that stores the commodities corresponding to the commodity images, and a sending means that takes out the selected commodity from the commodity storage means on the basis of the associated commodity identification information and purchaser identification information and sends the taken-out commodity as the commodity desired by the purchaser to the handover means.

A second exemplary aspect of the present invention is a method for controlling a store system, the store system including a front yard that receives, from a purchaser, selection of a commodity and hands over the selected, desired commodity to the purchaser and a backyard adjacent to the front yard, the backyard including a commodity storage unit that stores a plurality of commodities, the method includes, displaying a plurality of commodity images on a display apparatus included in the front yard, in the front yard, receiving selection of a commodity desired by the purchaser from among commodities corresponding to the displayed commodity images, in the front yard, acquiring purchaser identification information identifying the purchaser, in the front yard, associating commodity identification information identifying the selected commodity and the acquired purchaser identification information with each other, in the backyard, taking out the selected commodity from the commodity storage unit on the basis of the associated commodity identification information and purchaser identification information, and in the backyard, sending the taken-out commodity as the commodity desired by the purchaser to the front yard.

A third exemplary aspect of the present invention is a non-transitory computer-readable medium storing a control program for causing a computer to perform a process of controlling a store system, the store system including a front yard that receives, from a purchaser, selection of a commodity and hands over the selected, desired commodity to the purchaser and a backyard adjacent to the front yard, the backyard including a commodity storage unit that stores a plurality of commodities, the process including the steps, displaying a plurality of commodity images on a display apparatus included in the front yard, in the front yard, receiving selection of a commodity desired by the purchaser from among commodities corresponding to the displayed commodity images, in the front yard, acquiring purchaser identification information identifying the purchaser, in the front yard, associating commodity identification information identifying the selected commodity and the acquired purchaser identification information with each other, in the backyard, taking out the selected commodity from the commodity storage unit on the basis of the associated commodity identification information and purchaser identification information, and in the backyard, sending the taken-out commodity as the commodity desired by the purchaser to the front yard.

### Advantageous Effects of Invention

According to the present invention, it is possible to provide a store system that minimizes the moving distance of each purchaser, as well as outputs commodities selected by each purchaser immediately when he or she makes payment, thereby increasing the convenience of the purchaser and reducing the cost of the store; a control method of such a store system; and a non-transitory computer-readable medium storing a control program of such a store system.

### BRIEF DESCRIPTION OF DRAWINGS

FIG. 1 is a block diagram showing a configuration of a store system according to a first embodiment of the present invention.

FIG. 2 is a sequence diagram showing a flow of the process performed by the store system according to the first embodiment of the present invention.

FIG. 3 is a block diagram showing a configuration of a store system according to a second embodiment of the present invention.

FIG. 4 is a block diagram showing a configuration of a backyard according to the second embodiment of the present invention.

FIG. 5 is a diagram showing an example of the commodity selection information according to the second embodiment of the present invention.

FIG. 6 is a diagram showing an example of a sending information according to the second embodiment of the present invention.

FIG. 7 is a flowchart showing the flow of a selection receiving process according to the second embodiment of the present invention.

FIG. 8 is a flowchart showing a flow of a sending information generation process according to the second embodiment of the present invention.

FIG. 9 is a flowchart showing a flow of a sending process according to the second embodiment of the present invention.

FIG. 10 is a flowchart showing a flow of an after-temporary standby sending process according to the second embodiment of the present invention.

FIG. 11 is a block diagram showing a configuration of a store system according to a third embodiment of the present invention.

FIG. 12 is a flowchart showing a flow of a refund process according to the third embodiment of the present invention.

FIG. 13 is a block diagram showing a configuration of a store system according to the fourth embodiment of the present invention.

FIG. 14 is a block diagram showing example configurations of a display apparatus, a commodity receiving unit, and a commodity refund unit according to the fourth embodiment of the present invention.

FIG. 15 is a flowchart showing the flow of parallel processing, performed by the store system according to a fifth embodiment of the present invention.

FIG. 16 is a flowchart showing the flow of another parallel processing performed by the store system according to the fifth embodiment of the present invention.

FIG. 17 is a block diagram showing a configuration of a display apparatus according to a sixth embodiment of the present invention.

FIG. 18 is a block diagram showing a configuration of a display apparatus according to a seventh embodiment of the present invention.

FIG. 19 is a flowchart showing the flow of a selection receiving process according to the seventh embodiment of the present invention.

FIG. 20 is a block diagram showing a configuration of a display apparatus according to an eighth embodiment of the present invention.

FIG. 21 is a sequence diagram showing the flow of a selection receiving process according to the eighth embodiment of the present invention.

FIG. 22 is a block diagram showing another configuration of the display apparatus according to the eighth embodiment of the present invention.

FIG. 23 is a block diagram showing another configuration of the display apparatus according to the eighth embodiment of the present invention.

FIG. 24 is a block diagram showing an example hardware configuration of a control apparatus according to another embodiment of the present invention.

FIG. 25 is a block diagram showing a configuration of a backyard according to another embodiment of the present invention.

FIG. 26 is a block diagram showing an example of sending information according to another embodiment of the present invention.

FIG. 27 is a block diagram showing a configuration of a store system according to a related art.

FIG. 28 is a block diagram showing a configuration of a display apparatus according to a tenth embodiment of the present invention.

FIG. 29 is an example configuration in which vertical electrodes form multiple loops in the configuration of the display apparatus according to the tenth embodiment of the present invention.

FIG. 30A is a flowchart showing an example operation of the tenth embodiment of the present invention.

FIG. 30B is a diagram showing an example in which a single IC card is held over a predetermined position of a display apparatus.

FIG. 31A is a flowchart showing an example operation of the tenth embodiment of the present invention.

FIG. 31B is a diagram showing an example of a case that a user holds two IC, card over a predetermined position on the display apparatus.

FIG. 32A is a flowchart showing an example operation of the tenth embodiment of the present invention.

FIG. 32B is a flowchart showing an example operation of the tenth embodiment of the present invention.

FIG. 32C is a diagram showing an example in which two IC cards are held over the same axis on a display apparatus.

FIG. 33A is a flowchart showing an example operation of the tenth embodiment of the present invention.

FIG. 33B is a diagram showing an example in which a single IC card is held over a predetermined position of a display apparatus.

FIG. 34 is a graph showing an example of changes in signal power in an x-axis direction.

FIG. 35 is a graph showing an example of changes in signal power in an y-axis direction.

FIG. 36 is a graph showing an example of changes in signal power in an x-axis direction.

FIG. 37 is a graph showing an example of changes in signal power in an y-axis direction.

FIG. 38 is an assembly diagram schematically showing a three-dimensional configuration of the display apparatus according to the tenth embodiment of the present invention.

FIG. 39 is a block diagram showing a configuration of a store system according to an eleventh embodiment of the present invention.

FIG. 40 is a block diagram showing a configuration of another example, a store system, according to the eleventh embodiment of the present invention.

FIG. 41 is a block diagram showing a configuration of an information access system according to a twelfth embodiment of the present invention.

FIG. 42 is a block diagram showing a configuration of another example, an information access system according to the twelfth embodiment of the present invention.

FIG. 43 is a flowchart showing an operation of the information access system according to the twelfth embodiment of the present invention.

FIG. 44 is a block diagram showing a configuration of another example, an information access system according to the twelfth embodiment of the present invention.

FIG. 45 is a flowchart showing an operation of the information access system according to the twelfth embodiment of the present invention.

FIG. 46 is a block diagram showing a configuration of a display apparatus according to a thirteenth embodiment of the present invention.

FIG. 47 is a circuit diagram of X-side control and Y-side control of the display apparatus according to the thirteenth embodiment of the present invention.

FIG. 48 is a device-level circuit diagram of the transmission amplifier circuit according to the thirteenth embodiment of the present invention.

FIG. 49 is a device-level circuit diagram of the filter/matching/detection circuit according to the thirteenth embodiment of the present invention.

FIG. 50 is a timing chart showing the operation of the display apparatus according to the thirteenth embodiment of the present invention.

FIG. 51 is a block diagram showing a configuration of an information access system according to a fourteenth embodiment of the present invention.

FIG. 52 is a block diagram showing a configuration of another example of the information access system according to the fourteenth embodiment of the present invention.

FIG. 53 is, a block diagram showing a configuration of a position detection apparatus according to a fifteenth embodiment of the present invention.

FIG. 54 is a flowchart showing the flow of a position detection process according to the fifteenth embodiment of the present invention.

FIG. 55 is a block diagram showing a configuration of a position detection apparatus according to a sixteenth embodiment of the present invention.

FIG. 56 is a flowchart showing the flow of a position detection process according to the sixteenth embodiment of the present invention.

FIG. 57 is a block diagram showing a configuration of a position detection apparatus according to a seventeenth embodiment of the present invention.

FIG. 58 is a flowchart showing the flow of a selected information association process according to the seventeenth embodiment of the present invention.

FIG. 59 is a block diagram showing a configuration of a position detection apparatus according to a twentieth embodiment of the present invention.

FIG. 60 is a block diagram showing a configuration of another example of a position detection apparatus according to the twentieth embodiment of the present invention.

FIG. 61 is a block diagram showing a configuration of another example of a position detection apparatus according to the twentieth embodiment of the present invention.

FIG. 62 is a block diagram showing a configuration of a position detection apparatus according to the twenty-first embodiment of the present invention.

FIG. 63 is a block diagram showing a configuration of a position detection apparatus according to the twenty-second embodiment of the present invention.

FIG. 64 is a flowchart showing the flow of a selection receiving process according to the twenty-second embodiment of the present invention.

FIG. 65 is a block diagram showing a configuration of a position detection apparatus according to a twenty-third embodiment of the present invention.

FIG. 66 is a sequence diagram showing the flow of a selection receiving process according to the twenty-third embodiment of the present invention.

FIG. 67 is a block diagram showing a configuration of a position detection apparatus according to the twenty-third embodiment of the present invention.

FIG. 68 is a block diagram showing a configuration of a position detection apparatus according to the twenty-third embodiment of the present invention.

### DESCRIPTION OF EMBODIMENTS

Now, specific embodiments of the present invention will be described in detail with reference to the drawings. The same components are given the same reference signs in the drawings and therefore repeated description thereof will be omitted as necessary to clarify the description.

### First Embodiment of Invention

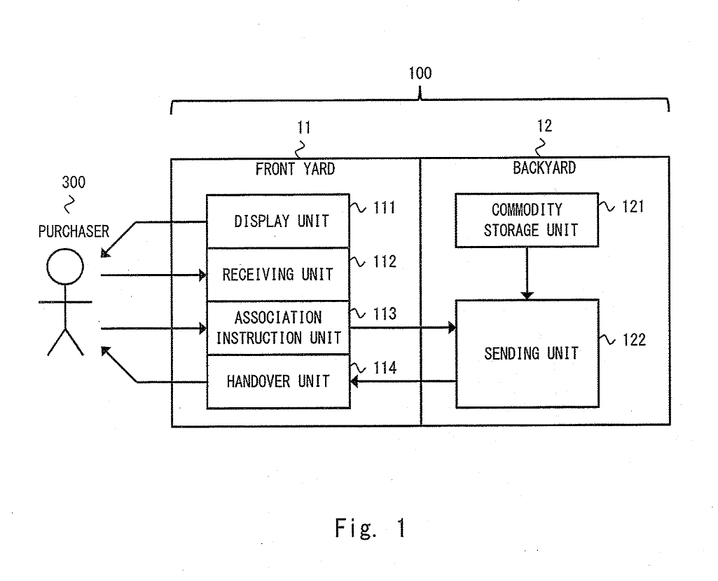

FIG. 1 is a block diagram showing a configuration of a store system 100 according to a first embodiment of the present invention. The store system 100 includes a front yard 11 and a backyard 12. The front yard 11 receives, from a purchaser 300, selection of a commodity desired by the purchase and hands over the selected, desired commodity to the purchaser. The front yard 11 includes a display unit 111, a receiving unit 112, an association instruction unit 113, and a handover unit 114.

The display unit 111 displays multiple commodity images. The receiving unit 112 receives, from the purchaser 300, selection of a commodity desired by the purchaser 300 from among commodities corresponding to the displayed commodity images. The association instruction unit 113 acquires purchaser identification information identifying the purchaser, who has made the selection. The association instruction unit 113 also makes an instruction to associate commodity identification information identifying the selected commodity and the acquired purchaser identification information with each other. The handover unit 114 hands over the selected, desired commodity to the purchaser 300.

The backyard 12 is adjacent to the front yard 11. The backyard 12 includes a commodity storage unit 121 and a sending unit 122. The commodity storage unit 121 is storing the commodities corresponding to the commodity images. The sending unit 122 sends the selected one of the commodities stored in the commodity storage unit 121 to the handover unit 114. Specifically, the sending unit 122 takes out the desired commodity from the commodity storage unit 121 on the basis of the associated commodity identification information and purchaser identification information and sends the taken-out commodity to the handover unit 114 as the commodity desired by the purchaser 300.

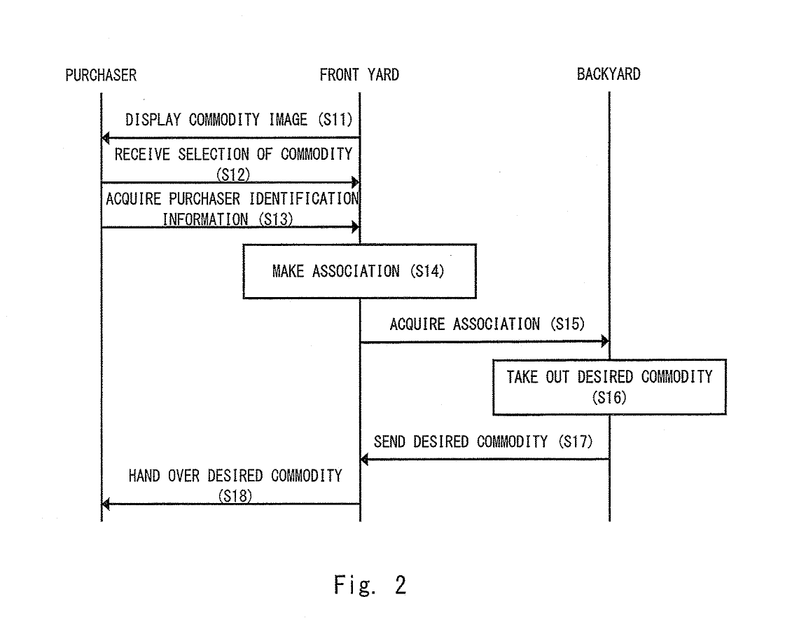

FIG. 2 is a sequence diagram showing the flow of the process performed by the store system according to the first embodiment of the present invention. First, the display unit 111 of the front yard 11 displays multiple commodity images (S11). The commodity images displayed by the display unit 111 correspond to commodities stored in the commodity storage unit 121. Next, the receiving unit 112 receives selection of a commodity from the purchaser 300 (S12). The association instruction unit 113 acquires purchaser identification information from the purchaser 300 (S13). The association instruction unit 113 then makes an instruction to associate commodity identification information identifying the received commodity and the acquired purchaser identification information with each other (S14).

The backyard 12 acquires the associated information from the front yard 11 (S15). Subsequently, the sending unit 122 of the backyard 12 takes out the desired commodity from the commodity storage unit 121 on the basis of the associated information (S16). The sending unit 122 then sends the desired commodity to the handover unit 114 (S17). Subsequently, the handover unit 114 of the front yard 11 hands over the desired commodity to the purchaser 300 (S18).

As seen above, according to the first embodiment of the present invention, the purchaser 300 can select the desired commodity from among the commodity images displayed on the display unit 111 in the front yard 11. At this time, the receiving unit 112 receives selection of the commodity, and the association instruction unit 113 acquires the purchaser identification information from the purchaser 300 and makes an instruction to associate the purchaser identification information and the commodity identification information with each other. Thus, the commodity identification information and the purchaser identification information are associated with each other. Note that the association process may be performed in any of the front yard 11, the backyard 12, and the outside. The sending unit 122 can take out desired commodities by purchaser, and the handover unit 114 can immediately hand over the desired commodities by purchaser. The purchaser 300 can receive the desired commodities in the handover unit 114 of the front yard 11 without having to moving from the front yard 11. That is, by minimizing the moving distance of each purchaser, as well as by immediately outputting commodities selected by each purchaser when he or she makes payment, it is possible to increase the convenience of the purchaser, as well as to reduce the cost of the store.

### Second Embodiment of Invention

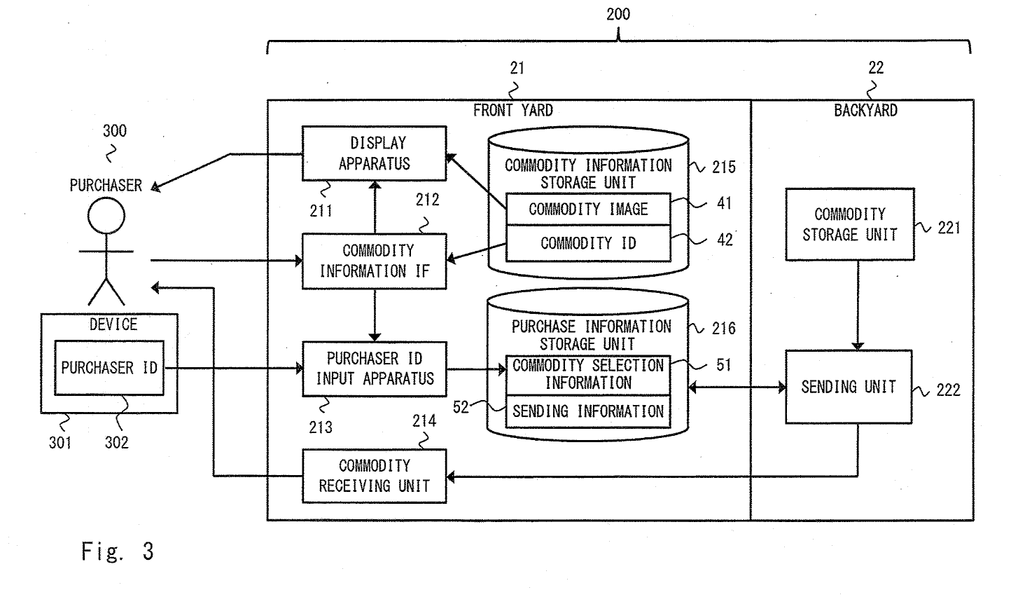

FIG. 3 is a block diagram showing a configuration of a store, system 200 according to a second embodiment of the present invention. The store system 200 is one example of the store system 100 described above. The store system 200 receives selection of two or more commodities from the purchaser 300 and collectively hands over all desired commodities whose selection has been received, by each of the purchasers.

Now assume that the purchaser 300 purchases commodities while holding a device 301. The device 301 is a storage medium storing a purchaser ID 302, which is purchaser identification information identifying the purchaser 300, or an electronic apparatus including such a storage medium. Examples of the device 301 include IC cards and mobile terminals.

The store system 200 includes a front yard 21 and a backyard 22. The front yard 21 includes a place that receives selection of commodities desired by the purchaser 300 and a place that hands over real commodities to the purchaser. On the other hand, the backyard 22 is adjacent to the front yard 21 and is a place that is storing real commodities. Accordingly, the front yard 21 does not need to store commodities. To prevent ordinary purchasers from entering the backyard 22, it is preferred to provide a partition or wall between the front yard 21 and the backyard 22.

Further, to protect equipment or the like included in the front yard 21, it is preferred to dispose a television camera or shock sensor in the front yard 21. Thus, the front yard 21 can be unmanned. The backyard 22 has a function of storing real commodities, as well as a function of sorting out, each of the purchaser 300, commodities needed by the purchaser 300 and then delivering the commodities to the purchaser 300 on the basis of an instruction from the purchaser 300 in the front yard 21.

The front yard 21 includes a display apparatus 211, a commodity information IF (user interface) 212, a purchaser ID input apparatus 213, a commodity receiving unit 214, a commodity information storage unit 215, and a purchase information storage unit 216. The display apparatus 211, the commodity information IF 212, the purchaser ID input apparatus 213, and the commodity receiving unit 214 are examples of the display unit 111, the receiving unit 112, the association instruction unit 113, and the handover unit 114, respectively. For this reason, functions equivalent to those of the first embodiment will not be described.

The commodity information storage unit 215 is a storage unit that stores commodity images 41 and commodity IDs 42. The commodity images 41 are pieces of image data corresponding to commodities. The commodity images 41 are, for example, images obtained by imaging real commodities or commodity samples on commodity shelves. The commodity IDs 42 correspond to the commodity images 41 and are pieces of commodity identification information identifying the commodities.

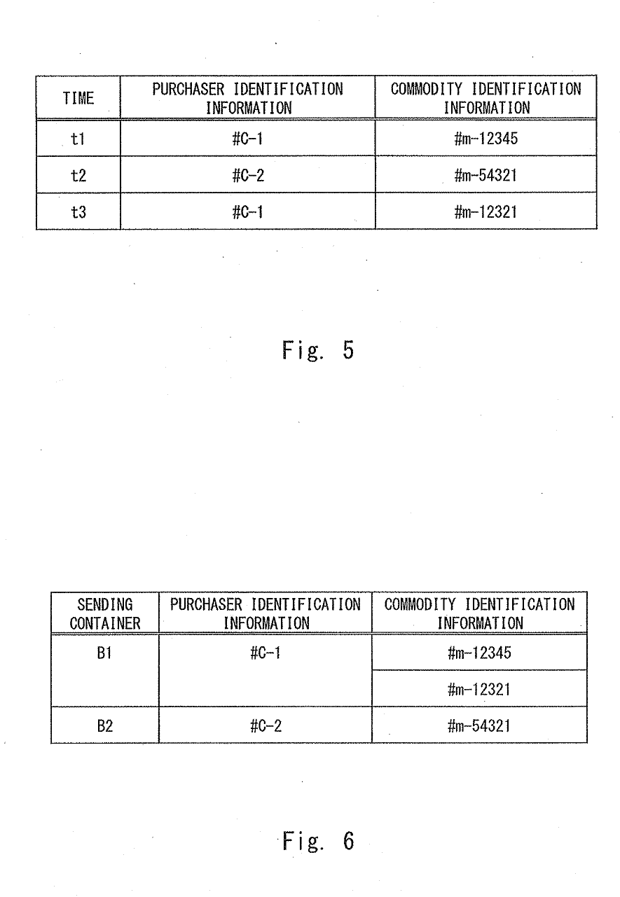

The purchase information storage unit 216 is a storage apparatus that stores commodity selection information 51 and sending information 52. The commodity selection information 51 is information obtained by associating commodity identification information and purchaser identification information with each other. For example, the commodity selection information 51 is information obtained by associating commodity identification information and purchaser identification information with each other one-on-one. Alternatively, the commodity selection information 51 may be information obtained by associating a piece of purchaser identification information and pieces of commodity identification information of all commodities selected by the purchaser with each other. FIG. 5 is a diagram showing an example of the commodity selection information 51 according to the second embodiment of the present invention. Now assume that a piece of commodity identification information and a piece of purchaser identification information are associated with each other on a time-of-day basis. However, the commodity selection information 51 is not limited to this example. The sending information 52 is a list of pieces of commodity identification information of selected two or more commodities corresponding to each purchaser identification information. FIG. 6 is a diagram showing an example of the sending information 52 according to the second embodiment of the present invention. Now assume that each purchaser identification information is associated with a sending container. However, the sending information 52 is not limited to this example.

The commodity information storage unit 215 and the purchase information storage unit 216 may be embodied as the same storage apparatus. The commodity information storage unit 215 and the purchase information storage unit 216 do not need to be disposed in the front yard 21 and may be disposed, for example, in the backyard 22 or in a computer system connected to the store system via a network. Such a computer system may be multiple computer apparatuses achieved by cloud computing or the like.

The display apparatus 211 is, for example, a display device. The display apparatus 211 reads multiple commodity images 41 from the commodity information storage unit 215 and displays the read commodity images 41 appropriately in full scale. For example, the screen of the display apparatus 211 includes pixels that allow the commodity images 41 to be displayed appropriately in full scale. Thus, the purchaser 300 can search for commodities with a feeling that he or she searches for them in an ordinary store, as well as can reduce the time which is taken until he or she finds the commodities. In the store system 200, no real commodities are displayed in front of the purchaser 300, while he or she can receive real commodities corresponding to commodities selected by him or her. In this sense, the store system 200 can be called a semi-real, semi-cyber environment. On the other hand, the store system 200 can be said to provide an environment which is similar to what is felt actually, since the display apparatus 211 displays approximately full-scale multiple commodity images. As a result, it is possible to produce an effect of allowing even a person who enters such a store for the first time to make purchases with a feeling that he or she is present in a real store. Further, since the display apparatus 211 displays approximately full-scale multiple commodity images, it is possible to reduce the possibility that the purchaser 300 may feel a deviation from expected commodity characteristics, such as size, when he or she receives a real desired commodity at the commodity receiving unit 214. As a result, it is possible to reduce the frequency at which a refund occurs.

In view of the foregoing, the display apparatus 211 may be a display apparatus capable of three-dimensional (3D) display. A naked eye-type 3D apparatus may be used as the display apparatus 211. Thus, it is possible to make displays which are easily acceptable for an indefinite number of purchasers. The display apparatus 211 may be a head-mounted display, which has been developed in recent years. Thus, the purchaser 300 who is wearing a head-mounted display can recognize a commodity as if a full-scale commodity were present before his or her eyes.

The commodity information IF 212 receives selection of commodities from the purchaser 300. For example, the commodity information IF 212 may be integral with a display apparatus 211 which is a touchscreen. In this case, the commodity information IF 212 detects that the purchaser 300 has touched one of commodity images displayed on the screen with his or her finger or the like and receives a commodity corresponding to the touched commodity image as having been selected. The commodity information IF 212 then reads, from the commodity information storage unit 215, a commodity ID 42 corresponding to the commodity whose selection has been received and notifies the purchaser ID input apparatus 213 of the commodity ID 42. The commodity information IF 212 also can receive selection of two or more commodities from the purchaser 300. In this case, the commodity information IF 212 reads, from the commodity information storage unit 215, multiple commodity IDs 42 corresponding to the commodities whose selection has been received and notifies the purchaser ID input apparatus 213 of the commodity IDs 42. In this case, each time it receives selection of a single commodity, the commodity information IF 212 may notify the purchaser ID input apparatus 213 of the commodity ID 42. Alternatively, when it receives information indicating that the selection is complete from the purchaser 300, the commodity information IF 212 may notify the purchaser ID input apparatus 213 of all the received commodity IDs 42 collectively. Note that, instead of the commodity information IF 212, the purchaser ID input apparatus 213 described below may read the commodity ID 42 from the commodity information storage unit 215.

The commodity information IF 212 can receive selection of multiple commodities from multiple purchasers. The results are stored as multiple pieces of commodity selection information 51 in the purchase information storage unit 216. For example, the commodity selection information 51 of FIG. 5 shows that a purchaser C-1 has made selection at a certain time, t1; that another purchaser, C-2, has made selection at a subsequent time, t2; and that the purchaser C-1 again has made selection at a subsequent time, t3. As seen above, whenever each purchaser makes selection, it is possible to associate purchaser identification information and commodity identification information with each other and to register the associated information as commodity selection information 51.

The purchaser ID input apparatus 213 acquires the purchaser ID 302 from the device 301 possessed by the purchaser 300. The purchaser ID input apparatus 213 is, for example, an information reader configured to perform wireless communication or the like with the device 301, and reads the purchaser ID 302 from the device 301 when the purchaser 300 holds the device 301 over the purchaser ID input apparatus 213. Alternatively, a purchaser ID input apparatus 213 which is a general-purpose input apparatus, such as a keyboard, may receive the purchaser ID 302 when the purchaser 300 directly inputs the purchaser ID 302 to the keyboard. The purchaser ID input apparatus 213 also may acquire information other than, the purchaser ID 302 from the purchaser 300. For example, the purchaser ID input apparatus 213 may associate information about multiple purchasers, such IDs and passwords, and information identifying the purchasers in the store system 200 with each other and then store the associated information in the purchase information storage unit 216 or the like. In this case, the front yard 21 can receive selection of a commodity from the purchaser 300 after the purchaser ID input apparatus 213 receives information, such as an ID and a password, from the purchaser 300 and then the ID and password are authenticated.

The purchaser ID input apparatus 213 may acquire the purchaser ID 302 at any timing, including the following: when the purchaser 300 comes to the store system 200; each time the purchaser 300 selects a commodity for the commodity information IF 212; and after the purchaser 300 completes selection of all of commodities. If the purchaser ID input apparatus 213 acquires the purchaser ID 302 each time the purchaser 300 shows selection of a commodity to the commodity information IF 212, the purchaser ID input apparatus 213 is preferably integral with the display apparatus 211 and the commodity information IF 212.

The purchaser ID input apparatus 213 receives the commodity ID 42 from the commodity information IF 212. The purchaser ID input apparatus 213 then associates the received commodity ID 42 and the acquired purchaser ID 302 with each other to generate commodity selection information 51. The purchaser ID input apparatus 213 then stores the generated commodity selection information 51 in the purchase information storage unit 216. For example, each time the purchaser 300 selects a commodity, the purchaser ID input apparatus 213 associates the commodity ID 42 of the selected commodity and the acquired purchaser ID 302 with each other and stores the associated information as commodity selection information 51 in the purchase information storage unit 216. Alternatively, when the purchaser ID input apparatus 213 receives multiple commodity IDs 42 collectively, it associates the commodity IDs 42 and a single purchaser ID 302 with each other. In this case, the information associated by the purchaser ID input apparatus 213 may be used as sending information 52. The purchaser ID input apparatus 213 only has to make an instruction to associate the commodity ID 42 and the purchaser ID 302 with each other or make an instruction to store the commodity selection information 51 in the purchase information storage unit 216. In this case, a processing unit that performs such an association process (for example, an association unit) is preferably disposed in the front yard 21, backyard 22, cloud computing described above, or the like. The association unit generates commodity selection information 51 in accordance with the instruction from the purchaser ID input apparatus 213 and stores it in the purchase information storage unit 216.

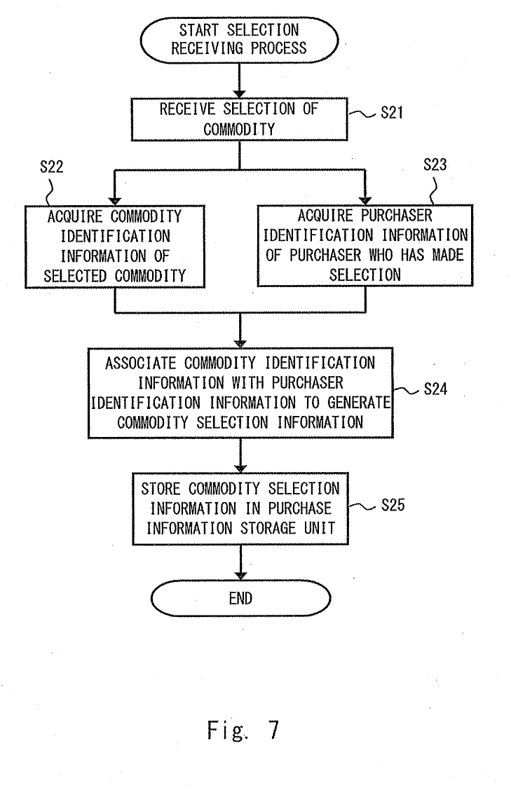

FIG. 7 is a flowchart showing the flow of a selection receiving process according to the second embodiment of the present invention. First, the commodity information IF 212 receives selection of a commodity from the purchaser 300 (S21). Next, the commodity information IF 212 acquires commodity identification information of the selected commodity (S22). Specifically, the commodity information IF 212 reads the commodity ID 42 of the selected commodity from the commodity information storage unit 215. The commodity information IF 212 then notifies the purchaser ID input apparatus 213 of the read commodity ID 42.

Further, after step S21, the purchaser ID input apparatus 213 acquires purchaser identification information of the purchaser, who has made the selection (S23). Specifically, the purchaser ID input apparatus 213 reads the purchaser ID 302 from the device 301 possessed by the purchaser 300. After steps S22 and S23, the purchaser ID input apparatus 213 associates the commodity identification information and the purchaser identification information with each other to generate commodity selection information 51 (S24). The purchaser ID input apparatus 213 then stores the generated commodity selection information 51 in the purchase information storage unit 216 (S25).

Among actions similar to real experience of the purchaser 300 is an action in which each time the purchaser 300 finds a desired commodity, he or she puts it into a basket. Such an action means that the purchaser will make payment collectively later, as well as means that the purchaser hastens to select one desired commodity and then starts examining a subsequent commodity. In the semi-real, semi-cyber store of the present invention, real commodities are placed in the backyard and therefore the purchaser 300 does not have to carry real commodities until he or she makes payment for the commodities. The commodity selection information 51 only has to be managed at any place while the purchaser 300 selects commodities. That is, the commodity selection information 51 is information necessary to be stored temporarily until the purchaser 300 makes payment. As described above, the commodity selection information 51 may be stored and managed in the front yard 21 or backyard 22 of the store, in the infrastructure, including cloud computing, or in a storage apparatus of the device 301 possessed by the purchaser 300.

If the commodity selection information 51 is stored and managed in the device 301, the purchaser 300 can closely examine the desired commodities and select a commodity additionally or delete any selected commodity. At this time, the purchaser ID input apparatus 213 preferably causes the device 301 to update the commodity selection information 51, as necessary. When the purchaser 300 confirms the selected commodities, the purchaser ID input apparatus 213 acquires the final commodity selection information 51 from the device 301 and stores it in the purchase information storage unit 216. Alternatively, both the device 301 and the purchase information storage unit 216 may always store the commodity selection information 51 in synchronization with each other for backup.

After the purchaser 300 selects all desired commodities and, then confirms the commodity selection information 51 for the first time as described above, it may happen a waiting time until receiving the desired commodities at the commodity receiving unit 214, depending on the number of commodities handled by the store system 200 or the processing speed of the sending unit 222 described below. Accordingly, considering a reduction in the time which may be taken until the purchaser 300 receives the variety of commodities, it may be preferred to, each time the purchaser 300 selects a commodity, send commodity selection information 51 to the backyard 22, cause the sending unit 222 of the backyard 22 to take out the selected commodity from the commodity storage unit 221 or start preparation of such take-out. In this case, regardless of when the purchaser 300 makes final selection, it is preferred to send the purchaser ID 302 thereof to the backyard 22. As seen above, by touching the desired commodity image with his or her IC card, the purchaser 300 performs a process equivalent to a process of putting a commodity into a basket. Thus, the store system 200 identifies the commodity ID 42 of a commodity corresponding to the commodity image touched by the purchaser 300, reads the purchaser ID 302 of the purchaser 300, associates both IDs with each other, and temporarily stores the associated information as commodity selection information 51 in the purchase information storage unit 216. In this case, the purchaser ID input apparatus 213 reads the purchaser ID 302. Further, the commodity information IF 212 is used to identify the commodity image touched by the purchaser 300.

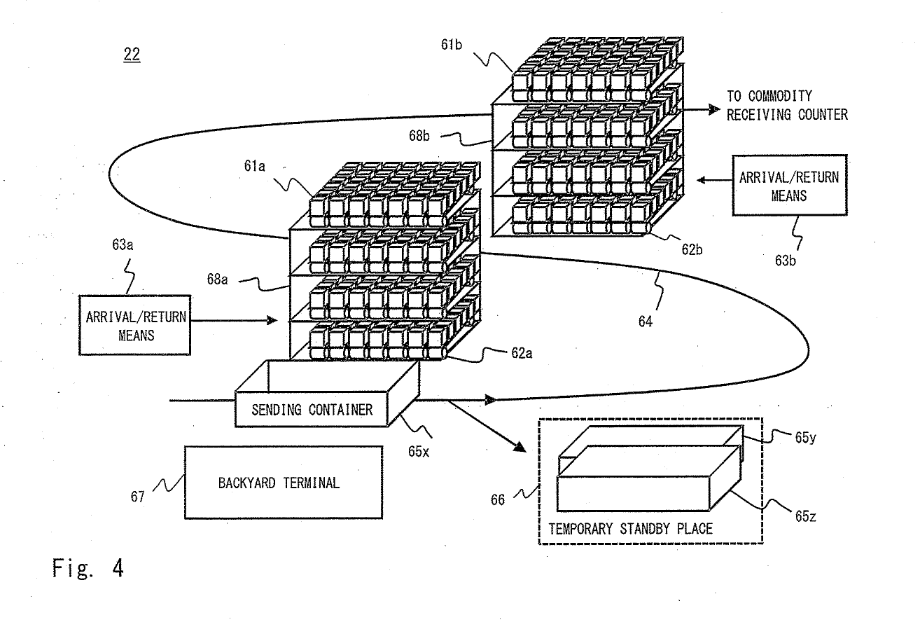

The backyard 22 includes the commodity storage unit 221 and the sending unit 222. The display apparatus 211 and the sending unit 222 are examples of the commodity storage unit 121 and the sending unit 122, respectively. Details of the backyard 22 will be described later with reference to FIG. 4.

The commodity receiving unit 214 receives a sending container sent from the sending unit 222 and containing the desired commodities and hands over the commodities to the purchaser 300.

FIG. 4 is a block diagram showing a configuration of the backyard 22 according to the second embodiment of the present invention. The backyard 22 includes commodity shelves 68a and 68b, arrival and return means 63a and 63b, shipping means 64, sending containers 65x, 65y, and 65z, a temporary standby place 66, and a backyard terminal 67.

The sending containers 65x, 65y, and 65z are containers for containing real commodities selected by the purchaser 300, such as baskets.

Multiple real commodities 61a are placed on the commodity shelf 68a and can be taken out of the commodity shelf 68a into to any sending container using sending means 62a. Similarly, multiple commodities 61b of a type different from the commodities 61a are placed on the commodity shelf 68b and can be taken out of the commodity shelf 68b into any sending container using sending means 62b. The sending means 62a and 62b can be embodied as belts or the like.

The arrival and return means 63a and 63b are means that when commodities 61a and 62b arrive or when a commodity is returned from a purchaser, place the commodities 61a and 62b on the commodity shelves 68a and 68b.

The temporary standby place 66 is a region in which the sending containers 65x, 65y, and 65z to be sent to the commodity receiving unit 214 are temporarily placed on standby. A sending container containing no commodity may be placed on standby in the temporary standby place 66.

The shipping means 64 is a belt or the like obtained by joining one or more lines together and extends from a standby place for a container containing no commodity (not shown) through in front of the commodity shelves 68a and 68b to the commodity receiving unit 214. The shipping means 64 moves the sending containers 65x, 65y, and 65z.

The backyard terminal 67 is a computer apparatus that controls processes, including access to the purchase information storage unit 216, take-out of the commodities 61 and 61b selected by the purchaser 300 from the commodity shelves 68a and 68b, and sending of the taken-out commodities to the commodity receiving unit 214. Specifically, the backyard terminal 67 controls the arrival and return means 63a and 63b, the shipping means 64, and the sending means 62a and 62b. For example, when a certain purchaser 300 selects a commodity 61a, the backyard terminal 67 identifies a sending container 65x corresponding to the purchaser ID 302 acquired from the purchaser 300. The backyard terminal 67 controls the shipping means 64 to move the sending container 65x to in front of the commodity shelf 68a, on which the commodity 61a is placed. The backyard terminal 67 then controls the sending means 62a of the commodity shelf 68a to put the commodity 61a into the sending container 65x. The backyard terminal 67 then controls the shipping means 64 to move the sending container 65x to the temporary standby place 66 or commodity receiving unit 214.

The commodity storage unit 221 may correspond, for example, to the commodity shelves 68a and 68b. The sending unit 222 may be formed, for example, by the backyard terminal 67, the shipping means 64, the sending containers 65x, 65y, and 65z, and the like. The backyard terminal 67 may be embodied as a computer system, such as external cloud computing. In this case, the computer system is included in the backyard 22.

The sending unit 222 takes out all the selected commodities from the commodity storage unit 221 on the basis of the associated commodity ID 42 and purchaser ID 302 and sends all the taken-out commodities collectively to the commodity receiving unit 214. The sending unit 222 also reads commodity selection information 51 from the purchase information storage unit 216, organizes commodity IDs 42 for each purchaser ID 302, and stores the organized information as sending information 52 in the purchase information storage unit 216.

Alternatively, each time the purchaser ID input apparatus 213 stores commodity selection information 51 in the purchase information storage unit 216, the sending unit 222 may read the commodity selection information 51, update the sending information 52, and each time the sending information 51 is updated, take out a selected commodity from the commodity storage unit 221 on the basis of the updated sending information 51.

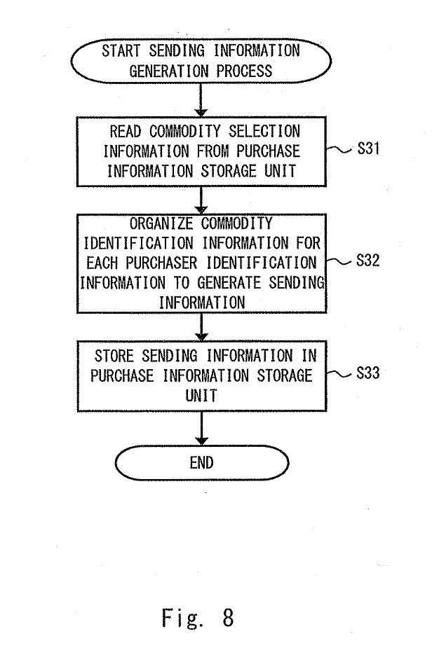

FIG. 8 is a flowchart showing the flow of a sending information generation process according to the second embodiment of the present invention. The sending information generation process will be described with reference to examples of FIGS. 5 and 6. First, the sending unit 222 reads commodity selection information 51 from the purchase information storage unit 216 (S31). For example, the sending unit 222 reads pieces of commodity selection information 51 corresponding to times t1 to t3 from the purchase information storage unit 216.

Next, the sending unit 222 organizes pieces of commodity identification information for each purchaser identification information to generate sending information 52 (S32). Specifically, the sending unit 222 sorts the read multiple pieces of commodity selection information 51 by purchaser identification information and, if consecutive pieces of the sorted commodity selection information 51 share the same purchaser identification information, organizes the pieces of commodity identification information into a single piece of sending information 52. For example, since pieces of purchaser identification information corresponding to times t1 and t3 share “#C-1”, commodity identification information “#m-12345” and “#m-12321” corresponding to purchaser identification information “#C-1” are included in the same sending information 52. Note that the purchaser identification information “#C-1” is associated with a sending container “B1.” For this reason, the sending information 52 can be said to be a collection of commodities to be contained in the sending container “B1.”

Subsequently, the sending unit 222 stores the generated sending information 52 in the purchase information storage unit 216 (S33). Thus, thereafter, the sending unit 222 can put, into each sending container, purchased commodities selected by a purchaser corresponding to the sending container on the basis of the sending information 52.

That is, the backyard terminal 67 performs sorting for each purchaser on the basis of the commodity selection information 51. An example of the sending information 52 resulting from the sorting is FIG. 6 described above. For example, pieces of identification information of commodities selected by the purchaser C-1 are organized so as to be associated with purchaser identification information. As seen above, by organizing selected commodities by purchaser, commodities to be put into the sending container 65x or the like, which operates in the backyard 22, are identified. For example, real commodities corresponding to commodities selected by the purchaser C-1 are sequentially put into the sending container “B1” in the backyard 22. Since these are performed in parallel with selection made by the purchaser, it is possible to reduce waiting time which is taken until the purchaser receives the commodities. Accordingly, the backyard terminal 67 needs sending information 52 for controlling the shipping means 64 and the sending means 62a and 62b. That is, at least, the sending information 52 needs to be stored in the purchase information storage unit 216. In other words, information, such as the commodity selection information 51, may be stored in a computer system in cloud computing or in a mobile terminal or the like, which is an example of the device 301 possessed by the purchaser 300. However, in terms of the waiting time, it is preferred to update the sending information 52 in real time each time the purchaser makes selection.

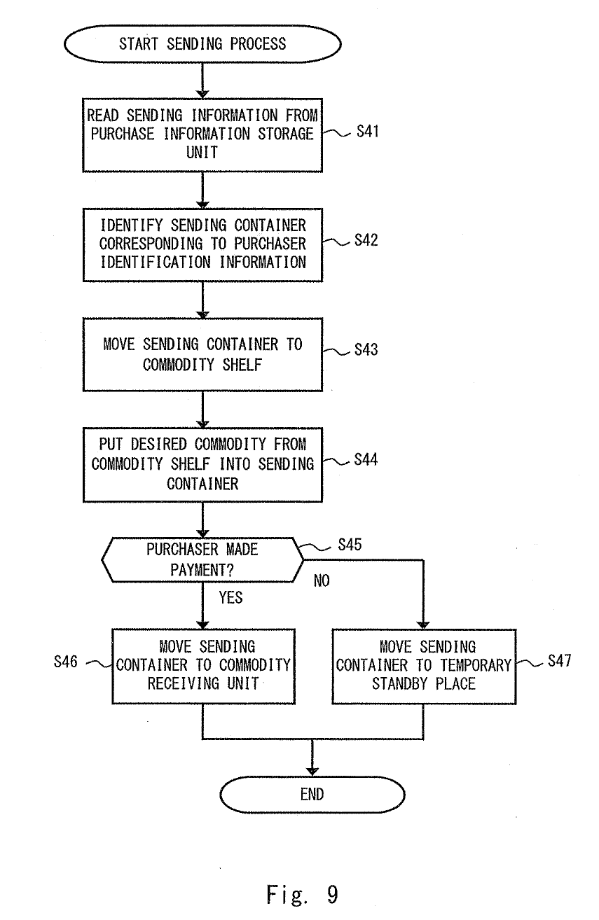

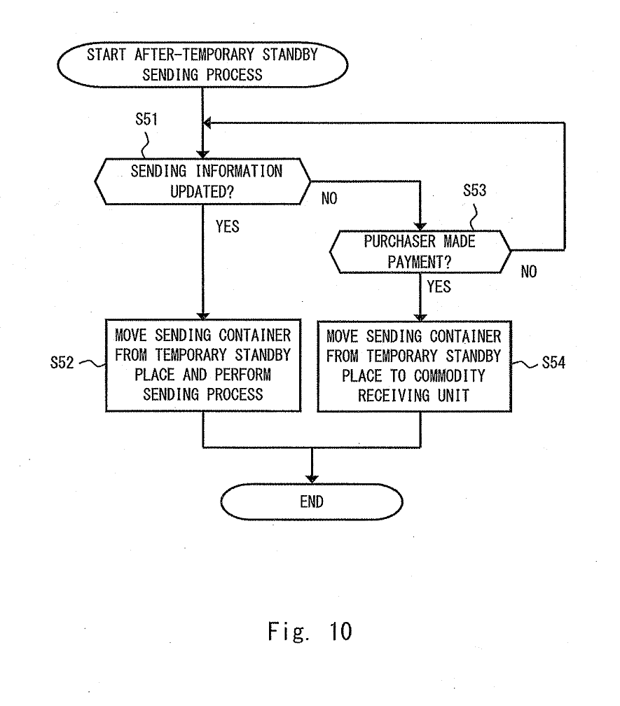

FIG. 9 is a flowchart showing the flow of a sending process according to the second embodiment of the present invention. First, the sending unit 222 reads sending information 52 from the purchase information storage unit 216 (S41). Next, the sending unit 222 identifies a sending container corresponding to purchaser identification information (S42). That is, the sending unit 222 identifies a sending container from purchaser identification information included in the sending information 52. For example, it is assumed that the backyard 22 is provided with multiple sending containers and that the sending containers are placed on standby as being movable by the shipping means 64. The backyard terminal 67 then selects any sending container from among sending containers containing no commodity to determine a sending container corresponding to the purchaser identification information. The sending unit 222 then moves the determined sending container to a commodity shelf (S43). Specifically, the sending unit 222 moves the sending container to a commodity shelf having thereon commodities corresponding to the pieces of commodity identification information included in the sending information 52. The sending unit 222 then puts the commodities from the commodity shelf into the sending container (S44).

The sending unit 222 then determines whether the purchaser has made payment (S45). For example, the sending unit 222 makes this determination on the basis of whether it has received, from the front yard 21, notification as to whether the purchaser 300 has confirmed the selected commodities by operating the commodity information IF 212, whether the purchaser 300 has inputted his or her purchaser ID 302 to the commodity receiving unit 214, or the like.

If the purchaser has made payment in step S45, the sending unit 222 moves the sending container to the commodity receiving unit 214 (S46). If the purchaser has not made payment in step S45, the sending unit 222 moves the sending container to the temporary standby place (S47).

Alternatively, the backyard terminal 67 may hold the commodities taken out of the commodity storage unit 221 by purchaser and, when the commodity receiving unit 214 receives input of a purchaser ID 302, identify commodities corresponding to the inputted purchaser ID 302 from among the held commodities, and then send the identified purchased commodities to the commodity receiving unit 214.

For example, when a purchaser makes the first selection, the backyard terminal 67 moves a sending container 65x using the shipping means 64. When the sending container 65x arrives at in front of the commodity shelf 68a having thereon a commodity 61a selected by the purchaser, the backyard terminal 67 pushes out the commodity 61a into the sending container 65x using the sending means 62a. Subsequently, depending on purchases made by the purchaser, another purchaser who has started making a purchase later may complete all purchases first. In this case, the backyard terminal 67 moves the sending container 65x corresponding to the purchaser who has started making a purchase first, to the temporary standby place 66 and places it on standby.

When commodity images are displayed on the display apparatus 211 by commodity type, multiple commodity shelves, including the commodity shelves 68a and 68b, are preferably disposed by commodity type. For example, shelves for real commodities are preferably disposed in the backyard 22 in accordance with the layout of the virtual commodity counters. The route of the shipping means 64 passing through in front of the multiple commodity shelves preferably correspond to the order in which the commodity types are displayed on the display apparatus 211. For example, it is assumed that the virtual counters are displayed on the display apparatus 211 as follows: a preserved food counter is placed near the entrance, and a fresh food counter is placed next to the preserved food counter. In this case, the route of the shipping means 64 in the backyard 22 preferably passes first through in front of a preserved food shelf and then through in front of a fresh food shelf in accordance with the traffic line of the purchaser. According to a commodity type displayed on the display apparatus 211, the backyard terminal 67 preferably controls the shipping means 64 to move the sending container to in front of a commodity shelf corresponding to the commodity type, as necessary. Subsequently, based on a sign indicating that the purchaser has completed selection, the shipping means 64 sends the sending container to the commodity receiving unit 214.

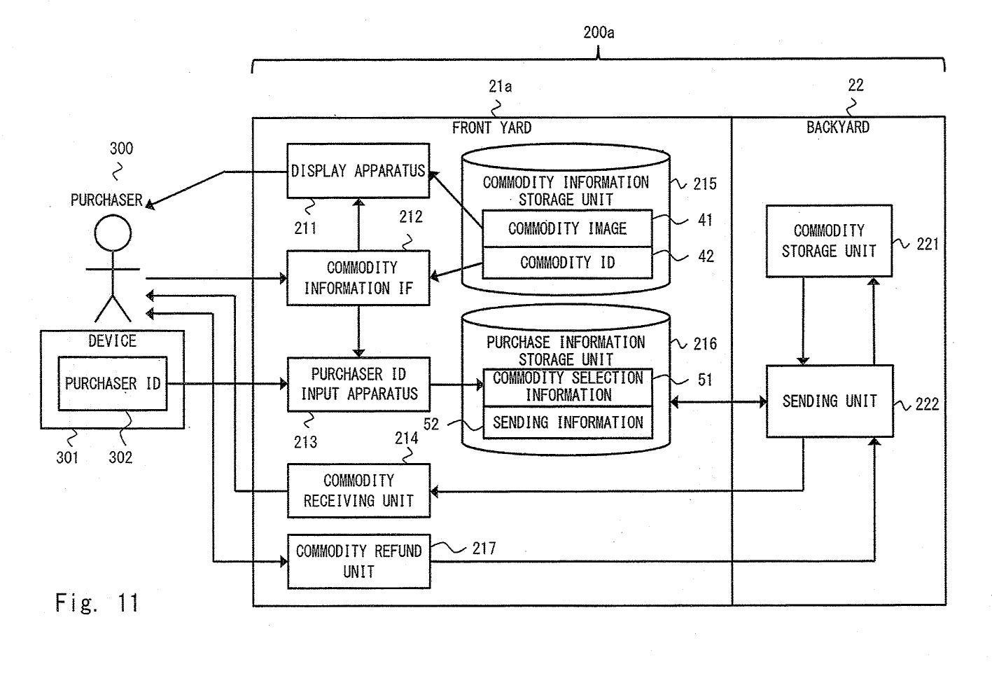

FIG. 10 is a flowchart showing the flow of an after-temporary standby sending process according to the second embodiment of the present invention. The sending unit 222 determines whether the sending information 52 has been updated (S51). For example, the sending unit 222 refers to the purchase information storage unit 216 to determine whether each sending information 52 has undergone addition, change, or deletion since the last access thereto.

If the sending unit 222 determines in step S51 that any sending information 52 has been updated, it moves a corresponding sending container, which has been temporarily on standby, out of the temporary standby place 66 and performs a sending process (S52). Specifically, the sending unit 222 controls the shipping means 64 to move the sending container out of the temporary standby place 66 and to perform steps S43 and later of FIG. 9.

If the sending unit 222 determines in step S51 that any sending information 52 has not been updated, it determines whether the corresponding purchaser has made payment, as in step S45 (S53). If the sending unit 222 determines in step S53 that the purchaser has made payment, it moves the corresponding sending container, which has been on standby temporarily, from the temporary standby place 66 to the commodity receiving unit 214 (S54).

As seen above, according to the second embodiment of the present invention, even when selection of two or more commodities is received from the purchaser 300, it is possible to collectively hand over all desired commodities whose selection has been received, to the purchaser.

### Third Embodiment of Invention

In the store system 200 described above, during selection of desired commodities in the front yard 22, the purchaser 300 may want to clear the selection of a commodity that he or she has made once. For this reason, in the store system 200, payment is preferably made lastly. For payment, two methods are conceivable: the purchaser 300 makes payment before receiving real commodities; and the purchaser 300 makes payment after receiving real commodities. In a case where in an unmanned store or a store having a configuration similar to an unmanned store, the purchaser makes payment after receiving commodities, there is a risk that he or she may make off with the commodities without making payment. Such a store preferably provides the real commodities to the purchaser after he or she makes payment. For this reason, the commodity receiving unit 214 receives input of the purchaser ID 302 from the device 301, such as an IC card, which the purchaser 300 has used when selecting commodities. If the IC card is electronic money of prepaid or other types, the commodity receiving unit 214 directly deducts payment from the electronic money. The commodity receiving unit 214 may receive payment through cash or the like. Upon completion of this process, the commodity receiving unit 214 sends the commodities purchased by the purchaser 300 to the receiving window of the front yard. What becomes a problem at this time is a measure to be taken after the purchaser 300 makes a purchase different from his or her expectation. In view of the foregoing, a store system 200a according to a third embodiment of the present invention includes a commodity refund unit 217 at which the purchaser can receive a refund for a commodity.

FIG. 11 is a block diagram showing a configuration of the store system 200a according to the third embodiment of the present invention. The store system 200a is formed by adding the commodity refund unit 217 to the store system 200 according to the second embodiment. The other components are equivalent to those of FIG. 3 and therefore will not be described in detail.

After the purchaser 300 makes payment for a purchased commodity and then the commodity receiving unit 214 hands over the purchased commodity to him or her, the commodity refund unit 217 receives the purchased commodity and, if no abnormality is found when the received commodity is checked, makes a refund for the commodity to the purchaser 300. The sending unit 222 according to the third embodiment of the present invention again stores the commodity, where no abnormality has been found in the check, in the commodity storage unit 221.

For example, if the purchaser 300 wants to receive a refund for one commodity after making payment for commodities and receiving the real commodities, he or she leaves the commodity in the sending container and puts the sending container into the return counter of the commodity refund unit 217. That is, the commodity refund unit 217 receives, from the purchaser 300, at least one of the purchased commodities.

At this time, the commodity refund unit 217 acquires commodity identification information of the received commodity from bar code, RFID, or the like described on the commodity, as, well as checks the state of the commodity using a camera or on the basis of the weight or the like. If the check indicates that there is no problem, the commodity refund unit 217 urges the purchaser 300 to input purchaser identification information using his or her IC card and acquires the purchaser ID 302 from the purchaser 300 via the device 301. The commodity refund unit 217 then confirms that the purchaser 300 is a purchaser who has purchased the commodities at the store system 200a a certain length of time before. The commodity refund unit 217 then makes a refund through electronic money, cash, or the like.

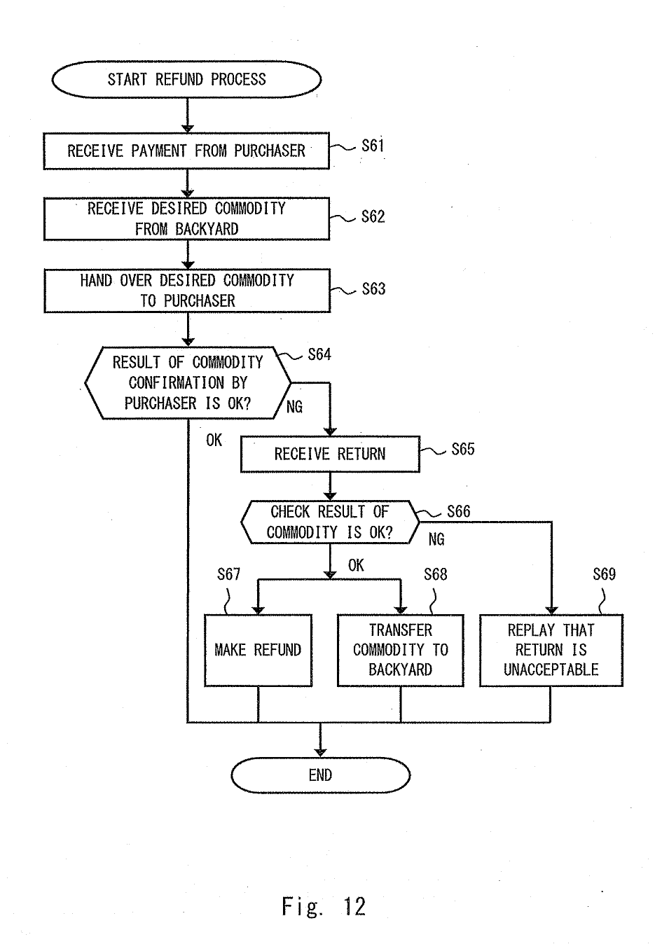

FIG. 12 is a flowchart showing the flow of a refund process according to the third embodiment of the present invention. Note that the refund process is required to include at least steps S65 to S69. First, the store system 200a receives payment from the purchaser 300 (S61). Next, the commodity receiving unit 214 receives the purchased commodity from the backyard 22 (S62). The commodity receiving unit 214 then hands over the purchased commodity to the purchaser 300 (S63).

At this time, the store system 200a receives the result of commodity confirmation from the purchaser 300 (S64). If the purchased commodity is not a commodity desired by the purchaser 300, the commodity refund unit 217 receives return of the commodity from the purchaser 300 (S65). The commodity refund unit 217 then checks the received commodity. At this time, the commodity refund unit 217 determines whether the check result of the commodity is OK (S66).

If the commodity refund unit 217 determines in step S66 that the check result of the commodity is OK, it makes a refund to the purchaser 300 (S67). In this case, preferably, the commodity refund unit 217 receives the purchaser ID 302 from the purchaser 300 in advance and confirms that the returned commodity has been purchased by the purchaser within a certain length of time. The commodity refund unit 217 also transfers the commodity to the sending unit 222 of the backyard 22 (S68). The sending unit 222 again stores the transferred commodity in the commodity storage unit 221. Note that the sending unit 222 does not necessarily need to store the returned commodity again. If the commodity refund unit 217 determines in step S66 that a problem is found in the check result of the commodity, it replies to the purchaser 300 that the commodity cannot be returned (S69). The commodity refund unit 217 then returns the commodity received as a return, to the purchaser 300.

### Fourth Embodiment of Invention

The second or third configuration described above eliminates the need to place real commodities in the front yard and instead displays approximately full-scale commodity images. In a fourth embodiment of the present invention, there will be described an example of a method for providing commodity information in the front yard, including displaying commodity images or the like.

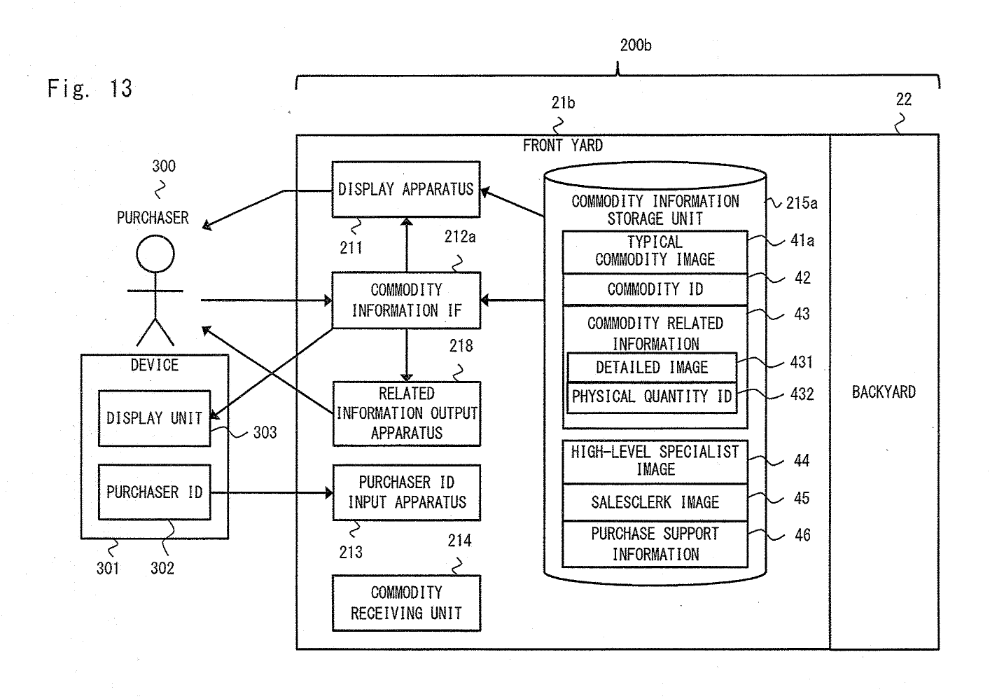

FIG. 13 is a block diagram showing a configuration of a store system 200b according to the fourth embodiment of the present invention. The store system 200b includes a front yard 21b obtained by making improvements to the front yard 21 of the store system 200 of FIG. 3. The front yard 21b additionally includes a related information output apparatus 218. Note that the purchase information storage unit 216 of FIG. 3 is included in the front yard 21b but not shown in FIG. 13. The front yard 21b may include the commodity refund unit 217 according to the third embodiment. Hereafter, only the difference between the fourth embodiment, and the second or third embodiment will be described.

A commodity information storage unit 215a is storing typical commodity images 41a, commodity IDs 42, commodity-related information 43, high-level specialist images 44, salesclerk images 45, and purchase support information 46. A typical commodity image 41a, which is an example of a commodity image 41, is an image typical of a commodity, for example, an image obtained by imaging the front of the commodity, or the whole commodity. A commodity ID 42 is associated with a typical commodity image 41a.

Commodity-related information 43 corresponds to a typical commodity image 41a and is information related to a commodity corresponding to the typical commodity image 41a. The commodity-related information 43 includes commodity characteristic information, such as the size, weight, design, maturity degree, freshness date, or the like of the commodity. Multiple pieces of commodity-related information 43 may be associated with a single typical commodity image 41a. The commodity-related information 43 includes a detailed image 431, a physical quantity ID 432, and the like. The detailed image 431 is an image representing only the side or back of the commodity, a label thereon, or the like. The detailed image 431 may be images formed by imaging a real commodity from various angles. The detailed image 431 may be multiple images forming a moving image. The physical quantity ID 432 is information identifying a physical quantity that simulates the sense of sight, hearing, smell, taste, or touch related to the commodity. The commodity-related information 43 includes other various types of information described below.

A high-level specialist image 44 is an image corresponding to a person who sells commodities which must be sold face-to-face, such pharmaceuticals. A salesclerk image 45 is an image corresponding to a salesclerk who, serves the purchaser 300. Purchase support information 46 includes various types of information for supporting purchase of commodities by the purchaser 300, such as the method for operating the front yard 21b.

The display apparatus 211 displays multiple typical commodity images 41a and multiple detailed images 431. Preferably, the typical commodity images 41a and detailed images 431 displayed on the display apparatus 211 are images obtained by imaging, commodities when the commodities arrive. For example, the arrival and return means 63a and 63b of the backyard 22 may have a function of imaging commodities that have just arrived using a camera or the like before placing them on the commodity shelves 68a and 68b. The arrival and return means 63a and 63b preferably store the images captured at the time of arrival in the commodity information storage unit 215a, as typical commodity images 41a or detailed images 431.

For example, if commodities are fresh food, such as vegetable, fish, or meat, characteristics thereof vary among the commodities. For fresh food, even if commodities are of the same type, the state varies among them. If the display apparatus 211 displays images obtained by imaging commodities at the time of arrival, the purchaser 300 can check the state of each real commodity to determine whether to purchase the commodity. Further, the purchaser 300 can select a commodity to be purchased from among the same commodities on the basis of the relative states of the commodities. Thus, it is possible to more effectively assist the purchaser 300 in selecting commodities.

A commodity information IF 212a receives, from the purchaser 300, a request to output commodity-related information 43 related to a commodity corresponding to a typical commodity image 41a displayed on the display apparatus 211 and causes the display apparatus 211 or the like to output the commodity-related information 43. Thus, the purchaser 300 can acquire various types of specific information related to the commodity corresponding to the typical commodity image 41a. Thus, it is possible to more effectively assist the purchaser 300 in selecting commodities.

For example, the purchaser 300 finds desired commodities while viewing full-scale commodity images. When the purchaser 300 finds an image of a desired commodity, he or she usually wants to know characteristics of the commodity. When the purchaser 300 attempts to acquire information that he or she wants to know about the commodity, the commodity information IF 212a serves as an interface between the purchaser 300 and the store system 200b (including a server disposed in a remote place, such as cloud computing). Through such an interface, the purchaser 300 can read, for example, a label written on the back of the real commodity to acquire detailed information of the commodity. Preferably, after displaying the commodity-related information 43 for a certain length of time, the display apparatus 211 again displays the original typical commodity images 41a for another purchaser 300.

Particularly, if, while the display apparatus 211 displays a typical commodity image 41a of a commodity, the commodity information IF 212a receives, from the purchaser 300, a request to display detailed images 431 of the commodity as a request to output commodity-related information 43, the commodity information IF 212a causes the display apparatus 211 to display the detailed images 431 in place of the typical commodity image 41a. Preferably, the display apparatus 211 displays some or all of multiple detailed images 431 corresponding to the typical commodity image 41a side by side. As seen above, since the display apparatus 211 presents commodity characteristic information to the purchaser 300, it is possible to more effectively assist the purchaser 300 in selecting commodities.

Instead of using information inputted when the purchaser 300 touches the screen, such as touchscreen, with his or her finger, the commodity information IF 212a may convert a motion of a hand of the purchaser 300 into a numerical value, such as a vector quantity, or convert a motion of the face, eyes, or body into a numerical value. For example, by forming a circle with a finger, a commodity image on the display apparatus 211 may be rotated. By making a gesture expanding the distance between both hands, the commodity image may be expanded. The relationship between a gesture and a change in image is preferably set such that the relationship is similar to actual experience as much, as possible. As means for inputting such a gesture, the commodity information IF 212a may use an ultrasonic sensor or camera, or infrared transmission/reception apparatus. That is, the commodity information IF 212a converts a motion of the purchaser 300 into a predetermined vector quantity and causes the display apparatus 211 to output commodity-related information 43 according to the vector quantity obtained.

Further, the commodity information IF 212a receives a request to output commodity-related information 43 from the purchaser 300 and causes the display apparatus 211 to output, as commodity-related information 43, a physical quantity that stimulates the sense of sight, hearing, smell, taste, or touch related to the commodity. In outputting such information, it is preferred to provide, to the purchaser 300, commodity characteristics which are as similar to real experience as possible. Examples of the destination of the commodity-related information 43 include the display apparatus 211, as well as the related information output apparatus 218. The related information output apparatus 218 is a dedicated apparatus that generates a physical quantity which specifically stimulates the sense of sight, hearing, smell, taste, or touch on the basis of the physical quantity ID 432 and outputs the physical quantity to the purchaser 300.

For example, assume that the related information output apparatus 218 is a dedicated apparatus that outputs sound on the basis of the physical quantity ID 432. Also assume that the commodity information storage unit 215a is storing a physical quantity ID 432 for identifying sound which occurs when beating a watermelon and that physical quantity IDs 432 are associated with the commodity IDs 42 of individual watermelons. In this case, the commodity information IF 212a receives, from the purchaser 300, a request to output commodity-related information 43 related to the maturity degree of a watermelon and selects, from the commodity information storage unit 215a, a physical quantity ID 432 identifying sound associated with the maturity degree, sugar content, or density of the watermelon, which has just arrived. The commodity information IF 212a then notifies the related information output apparatus 218 of the physical quantity ID 432. The related information output apparatus 218 emits sound which is similar to sound which occurs when beating the watermelon, on the basis of the physical quantity ID 432.

Assume that the related information output apparatus 218 is a smell synthesis apparatus that outputs a smell on the basis of a physical quantity ID 432. Also assume that the commodity information storage unit 215a is storing physical quantity IDs 432 identifying smells associated with commodity IDs 42, such as perfume or bath powder. In this case, the commodity information IF 212a receives, from the purchaser 300, a request to output commodity-related information 43 related to perfume or bath powder and selects a corresponding physical quantity ID 432 from the commodity information storage unit 215a. The commodity information IF 212a then notifies the related information output apparatus 218 of the physical quantity ID 432. The related information output apparatus 218 then outputs a smell of the commodity on the basis of the physical quantity ID 432. Thus, the purchaser 300 can select a commodity whose smell characteristics are of importance, such as perfume or bath powder, on the basis of the sense of smell. For the sense of taste or touch, the commodity information IF 212a may cause a related information output apparatus 218 which is previously disposed for stimulating the sense of taste or touch to output taste-sense or touch-sense information based on a selected commodity to the purchaser 300.

A device 301a possessed by the purchaser 300 may include the purchaser ID 302, as well as a display unit 303. In this case, the commodity-related information 43 may be outputted to the display unit 303.

For example, if the commodity-related information 43 represents the size of underwear, the commodity information IF 212a transmits the commodity-related information 43 to the device 301a. The device 301a then displays the size of the underwear. As seen above, it is difficult to display information, such as the size of underwear, on the main display apparatus 211, since the purchaser 300 does not want others to see such information. For this reason, by displaying such information on a mobile terminal or the like possessed by the purchaser 300, the purchaser 300 can check information that he or she alone wants to see, without hesitation.

Assume that the screen size of the display apparatus 211 is limited. In this case, while the commodity information IF 212a usually causes the display device 211 to display a typical commodity image 41a, it may, upon receipt of a request to output detailed images 431 from the purchaser 300, cause the display apparatus 211 to display the detailed images 431 and, upon receipt of selection of a detailed image 431, identify the commodity ID 42. In the present invention, the display apparatus 211 usually displays approximately full-scale commodity images so that the purchaser 300 becomes satisfied when receiving a real purchased commodity at the commodity receiving unit 214. However, for commodities, which subtly differ from each other in commodity characteristics, typical commodity images 41a or detailed images 431 thereof may be displayed with sizes smaller than the real commodities.

When the commodity information IF 212a receives, from the purchaser 300, a request to display detailed images 431, including three-dimensional information, such as the display angle of a commodity, it preferably identifies corresponding detailed images 431 from the commodity information storage unit 215a on the basis of the three-dimensional information and causes the display apparatus 211 to display the detailed images 431. Thus, the purchaser 300 can view the desired areas of the three-dimensional structure.

If the commodity is a watermelon or the like, detailed images 431 thereof preferably represent the contents of the commodity. Thus, the purchaser 300 can view the color or density of the inside of the watermelon before purchasing it to know commodity characteristics thereof in advance. As a result, the customer can become satisfied with the purchase result.

If information, such as the height, weight, age, sex, preference, illness, or budget of the purchaser 300, or information related to the family of the purchaser 300 (hereafter referred to as “purchaser characteristics information”) is previously registered in the device 301a, the commodity information IF 212a or purchaser ID input apparatus 213 may acquire the purchaser characteristics information from the device 301a. The commodity information IF 212a preferably selects commodity-related information 43 from the commodity information storage unit 215a on the basis of the acquired purchaser characteristics information. In this case, the commodity information IF 212a or purchaser ID input apparatus 213 preferably acquires the purchaser characteristics information shortly after the purchaser 300 starts selecting commodities.

For example, if the purchaser 300 must select commodities except for commodities containing a particular allergen and if typical commodity images 41a or detailed images 431 displayed on the display apparatus 211 include a commodity containing the allergen, the commodity information IF 212a preferably displays a warning on the display apparatus 211 or restricts the display of the image itself. If the purchaser 300 must be subjected to caloric restriction due to obesity or diabetes, the commodity information IF 212a preferably causes the display apparatus 211 to output a warning when the purchaser 300 selects a high-caloric commodity.

If the commodity is clothes or the like and if the commodity information IF 212a can acquire the clothes size of the purchaser 300 from the device 301a, the commodity information IF 212a preferably causes the display apparatus 211 to display typical commodity images 41a or the like corresponding to a size according to the body shape of the purchaser 300. Even if no clothes size is registered in the device 301a, if the front yard 21b is provided with detection means, such as a camera, for detecting the body shape or the like of the purchaser 300, the detection means can detect the body shape or sex of the purchaser 300 and thus the commodity information IF 212a can select an appropriate commodity size or design.

Further, by causing the detection means to estimate the age of the purchaser 300, the commodity information IF 212a can properly control the display apparatus 211 even when the purchaser 300 selects a commodity which requires the check of the age, such as a cigarette or alcoholic liquor.

The display apparatus 211 is large in size, since it displays approximately full-scale multiple commodity images. However, since the purchaser 300 needs to view commodity images, there is a limit to the height of the display apparatus. Specifically, the height of the display apparatus 301 is preferably similar to that of a shelf having real commodities thereon in an ordinary store. For this reason, particularly in a store system 200b which handles various types of commodities, the width of the display apparatus 211 for displaying these commodities would be increased.

In view of the foregoing, the display apparatus 211 preferably selectively displays multiple commodity images on a commodity type basis. Thus, it is possible to eliminate the limit on the size of the display apparatus 211 to use a small display apparatus 211. For example, if a virtual counter in the front yard 21b handles alcoholic liquors, the display apparatus 211 preferably selectively displays commodities, for example, by displaying sake images for a certain period of time, wine images for another period of time, and Western liquor images for yet another period of time. In this case, the display may be changed automatically every given period of time, or the purchaser 300 himself or herself may change the display.

Depending on the location of the store system 200b, visitors may be generally large in number, or may be large in number in a particular time zone. In these cases, it may be preferred not to perform the selective display described above. The reason is that when one purchaser and another purchaser are viewing commodities at the same counter, change of the display by an operation of the one purchaser may prevent the other purchaser from selecting a commodity. In such a case, the one purchaser may be prohibited from changing the display. Alternatively, change of the display by the one purchaser may be confined within a certain range of the front of the one purchaser. Alternatively, it is possible to prohibit change of the display in one area and to permit change of the display in another area.

As seen above, changing the display on the display apparatus 211 allows the display apparatus 211 to be effectively used. Thus, it is possible to effectively utilize the store area of the store system 200b to handle purchases of more purchasers during busy hours.

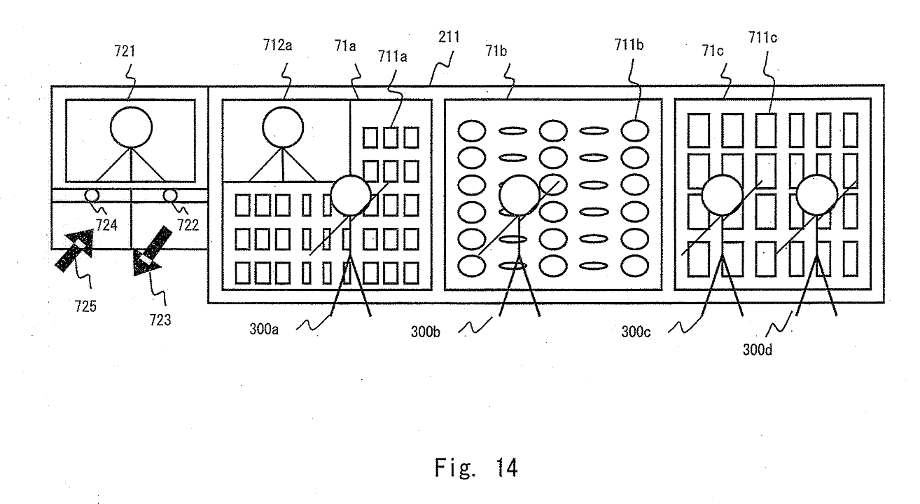

FIG. 14 is a block diagram showing example configurations of the display apparatus 211, the commodity receiving unit 214, and the commodity refund unit 217 according to the fourth embodiment of the present invention. Counter regions 71a, 71b, and 71c and a salesclerk image 721 are an example of the display apparatus 211. Purchaser ID input means 722 and a commodity receiving window 723 are an example of the commodity receiving unit 214. Purchaser ID input means 724 and a commodity refund window 725 are an example of the commodity refund unit 217.

The counter regions 71a, 71b, and 71c are regions corresponding to particular commodity type counters. Displayed on the counter region 71a are multiple commodity images 711a and a high-level specialist image 712a. A purchaser 300a is doing selection of a commodity, or the like in the counter region 71a. Displayed in the counter region 71b are multiple commodity images 711b. A purchaser 300b is doing selection of a commodity, or the like in the counter region 71b. Displayed in the counter region 71c are multiple commodity images 711c. Purchasers 300c and 300d are doing selection of a commodity, or the like in the counter region 71c.

Examples of the display apparatus 211 include various types of displays, including LCDs, PDPs, ELDs, FEDs, thin CRTs, and projectors that project images from the back or front. To display more commodity images, the display apparatus 211 is preferably low in per-unit cost and wide in per-unit displayable area. This is because the number of image signal lines that provide image signals to the display apparatus 211 or the number of image generation apparatuses that generate image signals is proportional to the number of displays. However, since there is a limit to the displayable area of a single display, multiple displays may be connected together to form a display apparatus 211.

The display apparatus 211 may be a head-mounted display. A head-mounted display refers to means that sends information visually by changing light entering the eyes using a liquid crystal apparatus or laser apparatus which is disposed in front of the eyes like an eyeglass. By using a head-mounted display possessed by the purchaser, the purchaser can obtain images provided by the store to select commodities. Alternatively, the store may lend such a head-mounted display to the purchaser. Of course, use of such a display is also included in the store system 200b according to the fourth embodiment of the present invention, since the purchaser selects a commodity in the front yard 21b.

Further, using a head-mounted display, or a camera, sensor, or the like included in a head-mounted display, the purchaser may send information to the store, that is, the commodity information IF 212a or purchaser ID input apparatus 213. Such a case is also included in the store system 200b according to the fourth embodiment of the present invention, since the purchaser selects commodities in the front yard 21b.

The sale of drugs or the like may require that a high-level specialist, such as a pharmaceutist, be present at the store. The high-level specialist image 712a is used in such a case. Specifically, if commodities corresponding to commodity images displayed on the display apparatus 211 are commodities which are required to be sold by a high-level specialist, the commodity information IF 212a causes the display apparatus 211 to display the commodity images, as well as the high-level specialist image 44. In this way, the commodity information IF 212a mediates the communication of information about the commodities between the purchaser 300a and the high-level specialist. The real high-level specialist is on standby in the backyard 22, and the high-level specialist image 712a may be a moving image or the like. In addition to the high-level specialist image 712a, real-time communication, including a conversation between the purchaser 300a and a salesclerk, may be realized using a microphone, speaker, camera, or the like disposed in the front yard 21b. Further, if legally permitted, an actual high-level specialist may be present at a remote place.

Thus, the purchaser 300a can select a drug which is applicable to a symptom of an illness, or the like. The following method is also possible: the purchaser 300a sends medical information, such as prescription data, written by a doctor to the backyard 22 via the commodity information IF 212a or the like; and a pharmaceutist as a high-level specialist prepares a drug on the basis of the medical information in the backyard 22 and sends the drug to the commodity receiving unit 214. Further, if legally permitted, services provided by the high-level specialist may be provided by an artificial intelligence that can access medical information to make recognition or determination and that operates according to a computer program.

The purchaser ID input means 722 may be the purchaser ID input apparatus 213. In this case, it at least receives input of the purchaser ID 302, which is used for verification when the commodity receiving unit 214 hands over a purchased commodity. The commodity receiving window 723 is a receiving window for receiving real commodities from the backyard 22 and handing over them to the purchasers 300a to 300d.

The salesclerk image 721 is obtained by displaying the salesclerk image 45 stored in the commodity information storage unit 215a on the screen of the display apparatus 211. The salesclerk image 721 is an image of a salesclerk who performs hand-over of a purchased commodity at the commodity receiving unit 214, acceptance of the return of a commodity at the commodity refund unit 217, or the like. The salesclerk image 721 may be a moving image, such as animation, or a moving image of a real salesclerk who is on standby in the backyard 22. In addition to the salesclerk image 721, real-time communication, including a conversation between the purchaser 300 and a salesclerk, may be performed using a microphone, speaker, camera, or the like disposed in the front yard 21b.

The salesclerk image 721, the purchaser ID input means 722, and the commodity receiving window 723 can accurately provide the purchaser with a commodity selected by the purchaser in conjunction with each other, as well as can obtain payment for the commodity. For example, when the purchaser 300a stands in front of the salesclerk image 721 in the front yard 21b, the salesclerk image 721 requests, through characters or voice, the purchaser 300a to show the purchaser ID 302 thereto. The purchaser 300a then holds the device 301a, such as an IC card, over the purchaser ID input means 722. After the purchaser 300a makes payment using an IC card or cash, the backyard 22 sends a sending container containing a commodity purchased by the purchaser 300a to the commodity receiving window 723. These services provided by the salesclerk may be provided by artificial image/voice recognition means or voice synthesis means which operates according to a computer program or the like.

The purchaser ID input means 724 may be the purchaser ID input apparatus 213. In this case, it at least receives input of the purchaser ID 302, which is used for verification when the commodity refund unit 217 makes a refund for a commodity. The commodity refund window 725 receives return of commodities from the purchasers 300a to 300d and makes refunds. Note that the purchaser ID input means 722 and the purchaser ID input means 724, and the commodity receiving window 723 and the commodity refund window 725 may be the same, respectively.

Specifically, when the purchaser 300a or the like wants to receive a refund for a purchased commodity, he or she holds an IC card which he or she has used when purchasing the commodity, over the purchaser ID input means 724. The purchaser ID input means 724 acquires the purchaser ID 302 from the IC card. The commodity refund unit 217 checks whether the refund is a refund within a certain length of time from the purchase. If the refund is determined to be possible, for example, the purchaser or an actual salesclerk throws the commodity into the commodity refund window 725. The commodity refund unit 217 checks the commodity thrown into the commodity refund window 725 and, if no problem is found, makes a refund through an IC card, cash, or the like. These processes may also be performed by the artificial intelligence or artificial salesclerk, which operates according to a computer program, if an actual salesclerk can support the purchaser or monitor an illegal act by the purchaser.

The display apparatus 211 may display the salesclerk image 721 at any of the following the timings: the display apparatus 211 always displays the salesclerk image 721; and when the purchaser 300a or the like makes a predetermined instruction to the commodity information IF 212a, the display apparatus 211 displays the salesclerk image 721.

Preferably, the front yard 21b further includes a detection unit that detects the positions or motions of the purchasers 300a to 300d. The detection unit is, for example, a customer detection apparatus, such as a camera, that monitors the motion of the purchaser 300a or the like. When the detection unit detects that the purchaser 300a or the like has stood at a predetermined position in the front yard 21b, the display apparatus 211 preferably displays the salesclerk image 721. Further, when the detection unit detects that the purchaser has performed no operation in the front yard 21b for a predetermined length of time or more, the display apparatus 211 preferably displays purchase support information 46 for supporting purchase of the purchaser. Alternatively, the detection unit recognizes a purchaser standing in front of the commodity information IF 212a or purchaser ID input apparatus 213 using a cameral or the like and, when it detects that the purchaser has not operated these apparatuses for a predetermined length of time, the display apparatus 211 displays the salesclerk image 721 or purchase support information 46.

The salesclerk image 721 does not necessarily need to be displayed around the commodity receiving unit 214 and may be displayed in each of the counter regions 71a to 71c. In this case, the salesclerk image 721 serves as an attendant for supporting the purchase of the purchaser. For example, when the detection unit detects that the purchaser 300b is present in front of the counter region 71b, the display apparatus 211 displays the salesclerk image 721 in the counter region 71b. Simultaneously, the front yard 21b outputs, to the purchaser 300b, the purchase support information 46a, for example, a guidance or help about the operation method through voice, character information, or the like. For example, the detection unit detects a purchaser who has made no purchase and stood still for a certain length of time and then activates these assistant functions to advise the purchaser about the operation method or the like.

### Fifth Embodiment of Invention

A store system according to a fifth embodiment of the present invention is a store system for, even when a single counter like the counter region 71c of FIG. 14 simultaneously receives selection of commodities from multiple purchasers 300c and 300d, performing processes in parallel. A schematic configuration of the store system according to the fifth embodiment of the present invention is equivalent to that according to any of the first to fourth embodiments and therefore illustration and description thereof will be omitted.

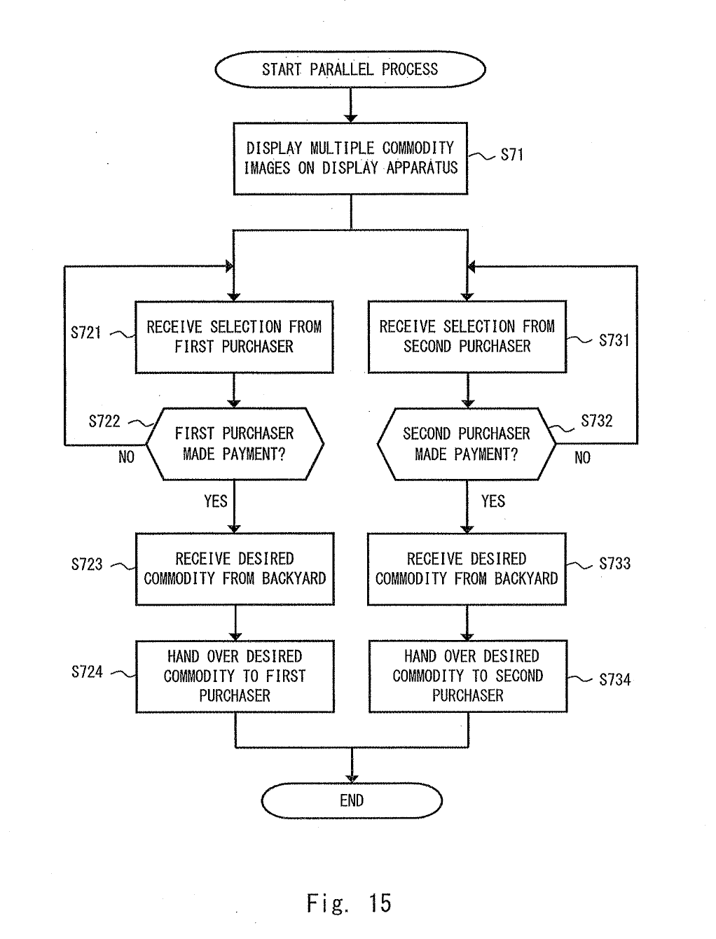

FIG. 15 is a flowchart showing the flow of parallel processing performed by the store system according to the fifth embodiment of the present invention. First, the store system displays multiple commodity images on the display apparatus 211 (S71). Next, when the store system receives selection of a commodity from a first purchaser, it performs a selection receiving process on the first purchaser (S721). When the store system receives selection of a commodity from a second purchaser during step S721, it performs a selection receiving process on the second purchaser (S731).

The store system then determines whether the first purchaser has made payment (S722). If the store system determines that the first purchaser has not made payment, it returns to step S721. If the store system determines that the first purchaser has made payment, it receives the purchased commodity from the backyard (S723). The store system then hands over the purchased commodity to the first purchaser (S724). In parallel with steps S721 to S724, steps S731 to S734 are performed on the second purchaser.

In addition to the processes described above, the store system according to the fifth embodiment of the present invention may perform the refund process according to the third embodiment in parallel. This parallel refund processing can be performed by paralleling the backyard-to-front yard commodity sending process, the payment window, the commodity hand-over process, and the commodity refund process on the basis of an estimated number of visitors.

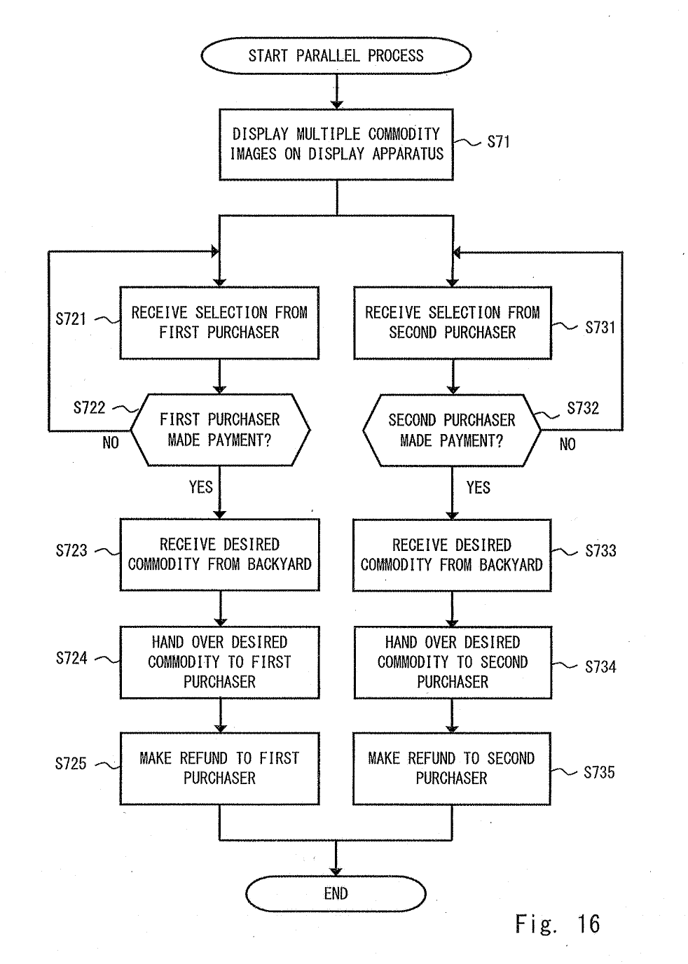

FIG. 16 is a flowchart showing the flow of parallel processing, including refund processing, performed by the store system according to the fifth embodiment of the present invention. In FIG. 16, in addition to the steps of FIG. 15, a refund step is performed on the first purchaser after step S724 (S725), and a refund step is performed on the second purchaser after step S735 (S735). Thus, large stores can simultaneously handle more purchasers.

### Sixth Embodiment of Invention

As large-screen displays are developed in recent years, displays having a width exceeding the width of a human are becoming common. Displays having a height exceeding the height of a human are also becoming available at relatively low cost. As the area of a single display is increased in terms of cost as described above, multiple purchasers may stand in front of such a single display and operate it separately. In the sixth embodiment of the present invention, a configuration for coping with the above situation will be also described. A schematic configuration of the store system according to the sixth embodiment of the present invention is similar to that according to any one of the first to fifth embodiments and therefore illustration and description thereof will be omitted. Hereafter, the difference between the sixth embodiment and the first to fifth embodiments will be mainly described.

A display apparatus 211a according to the sixth embodiment of the present invention is divided into multiple regions. Disposed in each region of the display apparatus 211a are multiple receiving units that detect a motion of a purchaser. That is, the multiple receiving units are disposed in the multiple regions, respectively. For this reason, when the receiving units detect a motion of a purchaser, it is possible to identify a receiving unit which is closest to the purchaser. Based on the region to which the identified receiving unit belongs, it is possible to identify a commodity selected by the purchaser.

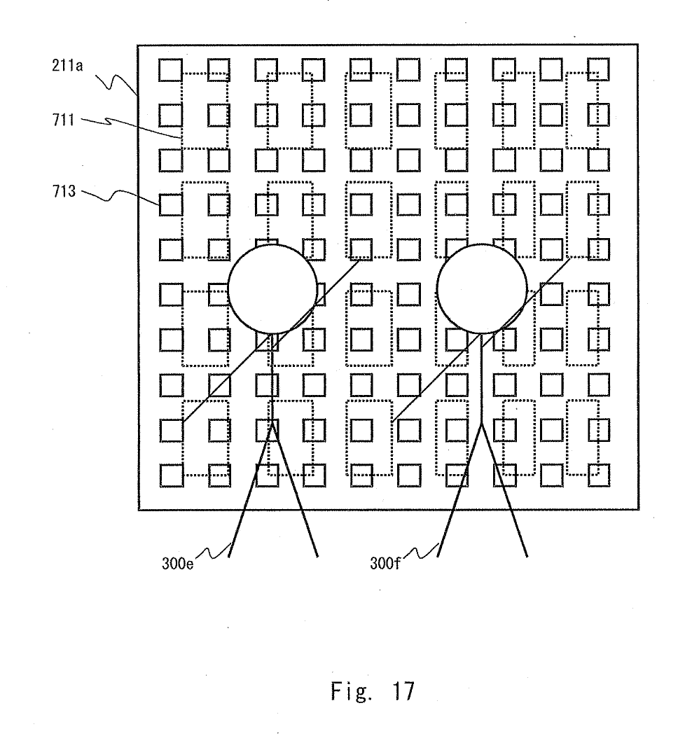

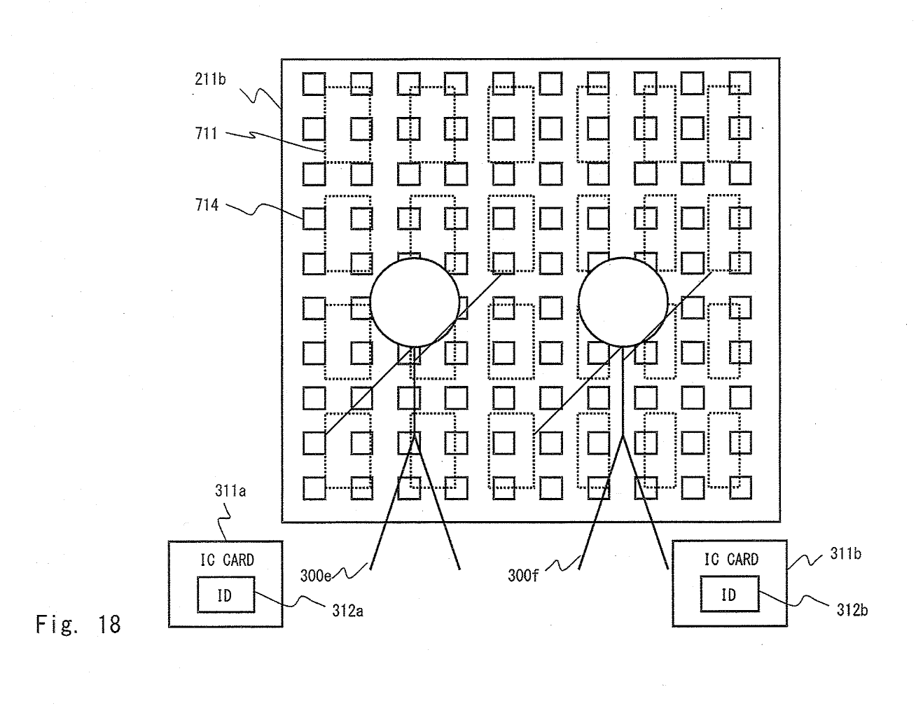

FIG. 17 is a block diagram showing a configuration of the display apparatus 211a according to the sixth embodiment of the present invention. The display apparatus 211a displays multiple commodity images 711. The commodity images 711 correspond to the regions described above. Disposed in each region of the display apparatus 211a are multiple ultrasonic actuator-sensor arrays 713. The ultrasonic actuator-sensor arrays 713 are an example of the receiving units described above. For this reason, each ultrasonic actuator-sensor array 713 can be said to be disposed adjacent to any one of the commodity images 711. Since the sizes of the commodity images 711 vary according to the displayed commodities, the multiple regions are changed as necessary. Purchasers 300e and 300f view the commodity images 711 on the same display apparatus 211a and select commodities.

FIG. 17 shows an example disposition in which the ultrasonic actuator-sensor arrays 713 are disposed on the display apparatus 211a in a matrix. However, the disposition is not limited to the above example. Any disposition may be used as long as the following are met: multiple receiving units are disposed on the display apparatus 211a; and a commodity selected by a purchaser is identified from the position of a receiving unit which has received the selection from the purchaser.

Each ultrasonic actuator-sensor array 713 has both an ultrasound emitting function and an ultrasound detection function. Ultrasound emitted from the display apparatus 211a is reflected by the bodies of the purchasers 300e and 300f and returns to around the display apparatus 211a. Each ultrasonic actuator-sensor array 713 detects the returning ultrasound using an ultrasonic sensor. Note that from the time when the ultrasonic actuator-sensor array emits ultrasound and the time when the ultrasound returns thereto, it is also possible to determine the distance between each ultrasonic actuator-sensor array and the purchaser acting as a reflector. By arranging such ultrasonic actuator-sensor arrays on the display apparatus in a matrix, a hand gesture or body gesture made by a purchaser is detected.

For example, when the purchaser makes a hand gesture in space like making a circle, one sensor reacts to the gesture and then an adjacent sensor reacts thereto. From such a chain of reactions of the sensors, it is possible to obtain the vector quantity of the hand gesture. From these sensor signals, as well as the distance information, it is possible to read the hand gesture made by the purchaser.

By causing the sensors to operate in parallel, it is possible to extract the motions of both hands separately or to extract a motion of adjacent another purchaser. Since the purchaser can operate the display apparatus 211a at a distance therefrom, he or she can look out over many commodities and select commodities with a wide view. Further, since the purchaser can operate a commodity image without touching the display apparatus 211a, use of a display apparatus like the display apparatus 211a is preferable in terms of sanitation compared to a touchscreen or the like. There is also produced an effect of reducing the frequency at which the apparatus is shocked or damaged.

What is needed here is to extract changes in the body position of the purchaser. Accordingly, the following configuration is also possible: only sensors for detecting ultrasound are disposed on the display apparatus in a matrix; and ultrasonic actuators for emitting ultrasound are disposed collectively in any one position.

### Seventh Embodiment of Invention

Preferably, multiple association instruction units for acquiring purchaser identification information are disposed in each region of the display apparatus 211a. That is, multiple association instruction units according to a seventh embodiment of the present invention are preferably disposed in each of the multiple regions. When a commodity image displayed in one of the regions of the display apparatus 211a is selected by a purchaser, an association instruction unit disposed in this region acquires purchaser identification information from the purchaser and associates the acquired purchaser identification information and commodity identification information of a commodity corresponding to the selected commodity image with each other.

FIG. 18 is a block diagram showing a configuration of a display apparatus 211b according to the seventh embodiment of the present invention. In comparison with the display apparatus 211a, the display apparatus 211b includes multiple RFID readers/writers 714 in place of the ultrasonic actuator-sensor arrays 713. The RFID readers/writers 714 are IC card readers and are an example of the association instruction units according to the seventh embodiment of the present invention. Now assume that the purchaser 300e holds an IC card 311a storing a purchaser ID 312a and that the purchaser 300f holds an IC card 311b storing a purchaser IC 312b.

FIG. 18 shows an example disposition in which the RFID readers/writers 714 are disposed on the display apparatus 211b in a matrix. However, the disposition is not limited to the above example. Any disposition may be used as long as the following are met: multiple association instruction units are disposed on the display apparatus 211b; a commodity selected by a purchaser is identified from the position of an association instruction unit which has acquired purchaser identification information from the purchaser; and commodity identification information and the purchaser identification information are associated with each other. For this reason, each RFID reader/writer 714 can be said to function as a receiving unit and an association instruction unit. The receiving units and association instruction units are disposed on the display apparatus 211b at predetermined intervals.

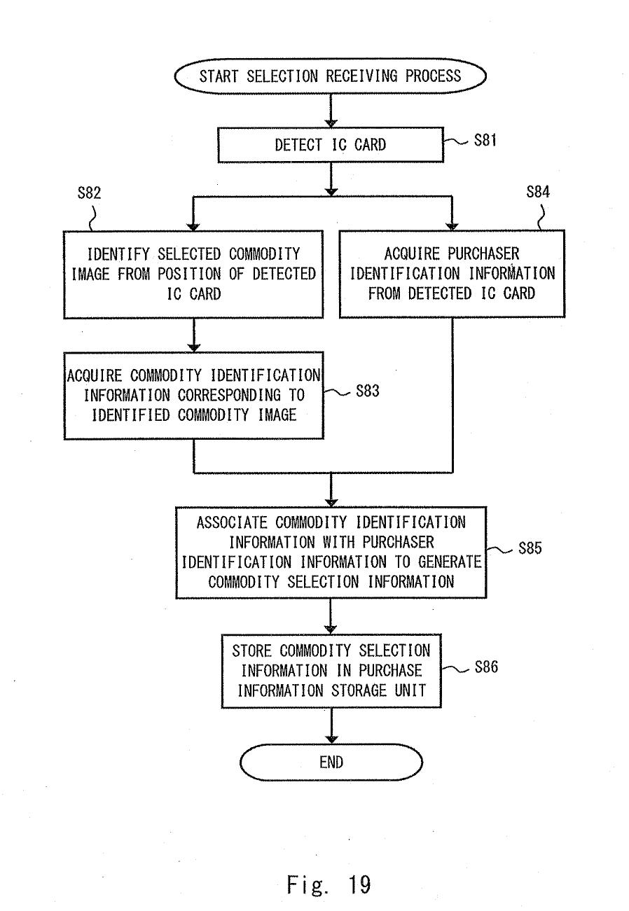

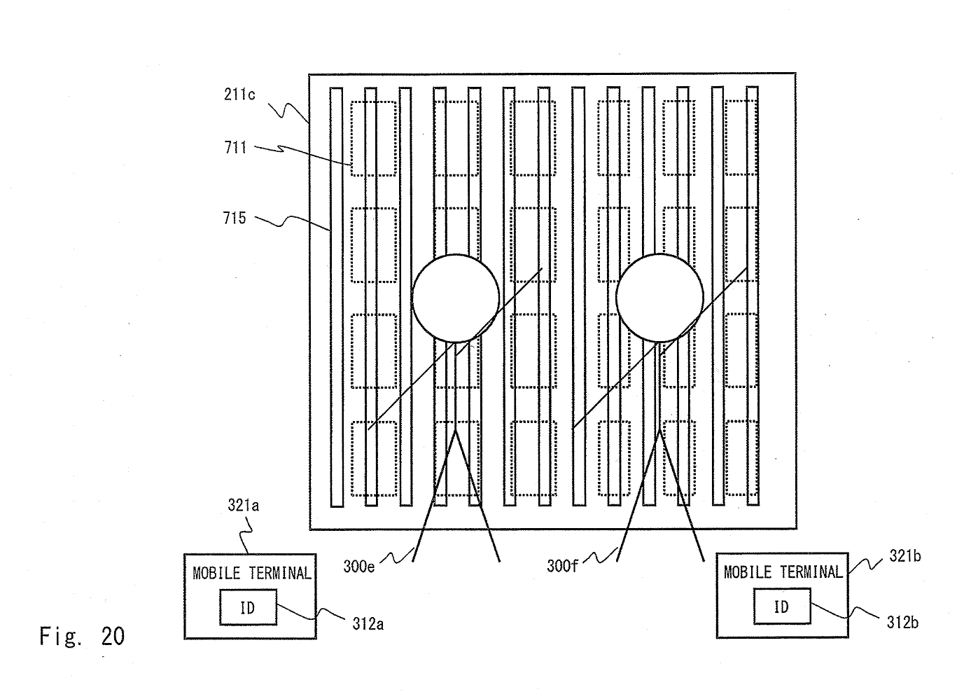

FIG. 19 is a flowchart showing the flow of a selection receiving process according to the seventh embodiment of the present invention. First, the purchaser 300e touches the desired commodity image 711 on the display apparatus 211b with the IC card 311a on hand. At this time, an RFID reader/writer 714 disposed closest to the commodity image 711 detects the IC card 311a (S81).

Next, the RFID reader/writer 714 identifies a selected commodity image from the position of the detected IC card 311a (S82). That is, from the coordinate position of the RFID reader/writer 714, which has detected the IC card 311a, the RFID reader/writer 714 determines that a commodity image disposed closest to the RFID reader/writer 714 has been selected. The RFID reader/writer 714 then acquires commodity identification information corresponding to the identified commodity image (S83). At this time, the RFID reader/writer 714 may write, to the IC card 311a, the commodity identification information or the like of the commodity image 711 selected by the purchaser 300e.

After step S81, the RFID reader/writer 714 acquires the purchaser ID 312a from the detected IC card 311a in parallel with steps S82 and S83 (S84). After steps S83 and S84, the RFID reader/writer 714 associates the commodity identification information and the purchaser identification information with each other to generate commodity selection information (S85). The RFID reader/writer 714 then stores the commodity selection information in the purchase information storage unit (S86). Thus, the purchaser 300e can receive the desired commodity at the commodity receiving window. Alternatively, in steps S85 and S86, the association unit or the like may separately generate commodity selection information in accordance with an association instruction from the RFID reader/writer 714 and store the commodity selection information in the purchase information storage unit.

The RFID readers/writers 714 are arranged in an array in FIG. 18. Thus, when the purchaser 300e holds the IC card 311a over a certain RFID reader/writer 714, it is possible to determine, from the position of the excited RFID reader/writer 714, which of the commodity images on the display apparatus 211b has been selected. By causing the arrayed RFID readers/writers 714 to operate in parallel, the adjacent another purchaser, 300f, can select a commodity in parallel. As a result, it is possible to increase the per-unit time purchaser handling capacity. There is also obtained an advantage that the purchaser can, with one motion, perform the two operations, selection of a commodity and sending of purchaser identification information. The purchaser then directly moves to the receiving window and can make payment there using the same card.

In recent years, there have also been developed body area networks, in which communication is performed by passing a weak current signal through a human body serving as a communication channel. The above object can also be accomplished by performing communication between a body area network terminal carried by the purchaser, instead of the RFID reader/writer 714, and the display apparatus using a human body as a communication channel.

The reason for acquiring purchaser identification information is to associate a particular purchaser with a particular commodity while multiple purchasers select commodities in parallel. For this reason, an association instruction unit according to the seventh embodiment of the present invention may identify purchaser identification information on the basis of the recognition result of an image obtained by imaging the purchaser. In recent years, for example, face-based or cloth-based human recognition technology using a camera has enabled an individual to be identified with a very high probability. By identifying a particular purchaser using this technology, it is possible to associate the purchaser with a particular commodity selected by the purchaser without having to use an IC card. When the purchaser stands in front of the receiving window lastly, he or she is authenticated using the same human recognition technology and thus can make payment using an IC card, cash, or the like and then acquire a real commodity.

### Eighth Embodiment of Invention

FIG. 20 is a block diagram showing a configuration of a display apparatus 211c according to an eighth embodiment of the present invention. In comparison with the display apparatus 211b, the display apparatus 211c is provided with multiple electrodes 715 in place of the RFID readers/writers 714. The electrodes 715 are body area network readers and are an example of the association instruction units according to the eighth embodiment of the present invention. Now assume that the purchaser 300e holds a mobile terminal 321a storing the purchaser ID 312a and that the purchaser 300f holds a mobile terminal 321b storing the purchaser IC 312b.

As described above, a body area network is communication performed by passing a weak current signal through a human body. In an example of FIG. 20, the multiple electrodes 715 for body area network are arranged on the display apparatus 211c longitudinally (vertically) in stripes (in strip form). By arranging the electrodes 715 longitudinally, if the purchasers 300e and 300f simultaneously select different commodity images and if the commodity images are displayed at the same height and in different columns, these selection operations can be distinguished from each other and processed in parallel. Note that the electrodes 715 may be arranged laterally. In this case, if the purchasers 300e and 300f simultaneously select different commodity images and if the commodity images are displayed in the same column and at different heights, the same thing is possible.

The mobile terminals 321a and 321b are, for example, watch-type body area network terminals. For example, when the purchaser 300e touches any electrode 715 with a fingertip or the like, a weak current flows from the electrode 715 toward the fingertip (or vice versa) and then flows into the mobile terminal 321a worn by the purchaser 300e.

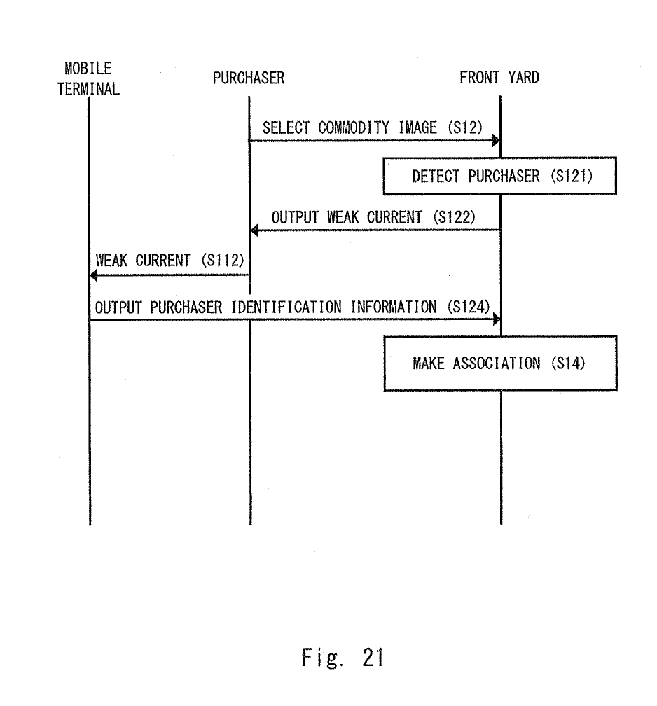

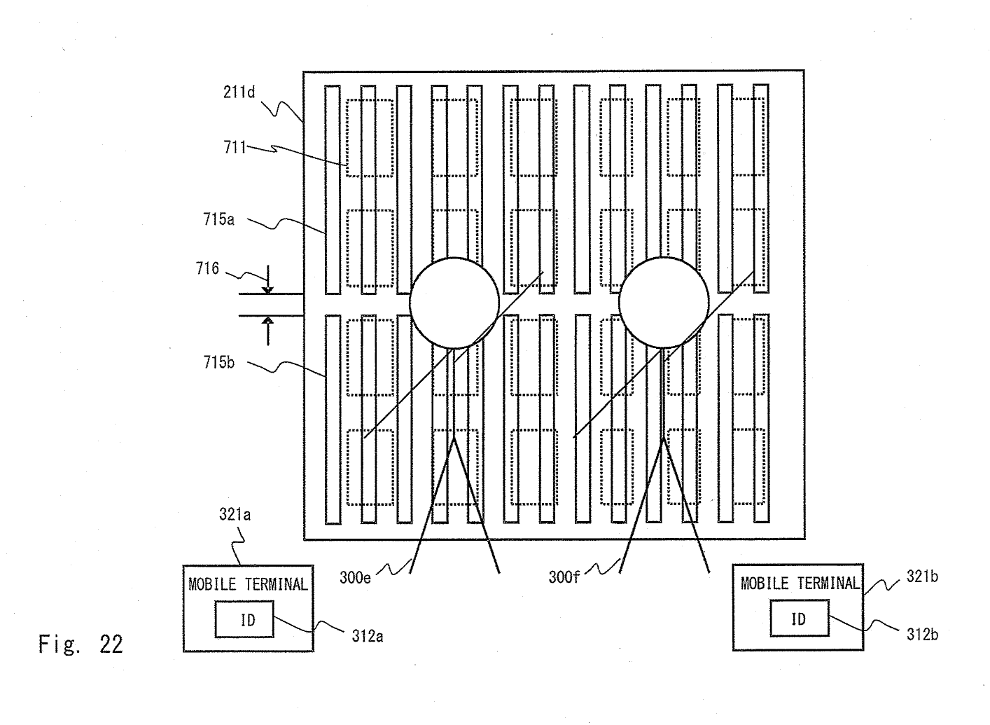

FIG. 21 is a sequence diagram showing the flow of a selection receiving process according to the eighth embodiment of the present invention. Note that FIG. 21 shows improvements made to steps S12 and S13 of FIG. 2. The other steps are the same as those of FIG. 2 and therefore illustration and description thereof will be omitted.

First, the purchaser 300e selects a commodity image 711 on the display apparatus 211c (S12). Next, one electrode 715 detects the purchaser 300e (S121). The electrode 715 then outputs a signal for acquiring the purchaser ID 312a to the purchaser 300e in the form of a weak current (S122). Next, the weak current flows into the mobile terminal 321a possessed by the purchaser 300e (S112). The mobile terminal 321a reads the purchaser ID 312a in response to the weak current and outputs it to the electrode 715 (S 124). Subsequently, the purchaser ID 312a is associated with commodity identification information in the front yard (S 14).

If the electrodes 715 for body area network pass run on the display apparatus 211c from top to bottom as in FIG. 20, the electrodes 715 pass through multiple commodity images 711. For this reason, with only the above steps, it is impossible to determine which of commodities the purchaser has selected. However, by using the commodity information IF 212 described above or the like together, it is possible to clearly determine which of commodities the purchaser has selected. Thus, when the purchaser touches the desired commodity image with a fingertip or the like, the purchaser identification information and commodity identification information can be associated with each other.

By forming the electrodes 715 for body area network in stripes as in FIG. 20 and processing signals from the electrodes 715 separately, it is possible to, even when multiple purchasers simultaneously touch the screen, extract multiple pieces of purchaser identification information without intermingling the pieces of information. A transmission/reception circuit for body area network is disposed for each electrode around the upper edge or lower edge of the display apparatus 211c and transmits or receives a body area network signal. For example, if four commodity images 711 are arranged longitudinally as shown in FIG. 20, the electrode 715 running from top to bottom has the four commodities as candidates. By using the commodity information IF 212 or the like together, it is possible to determine which of the four have been selected.

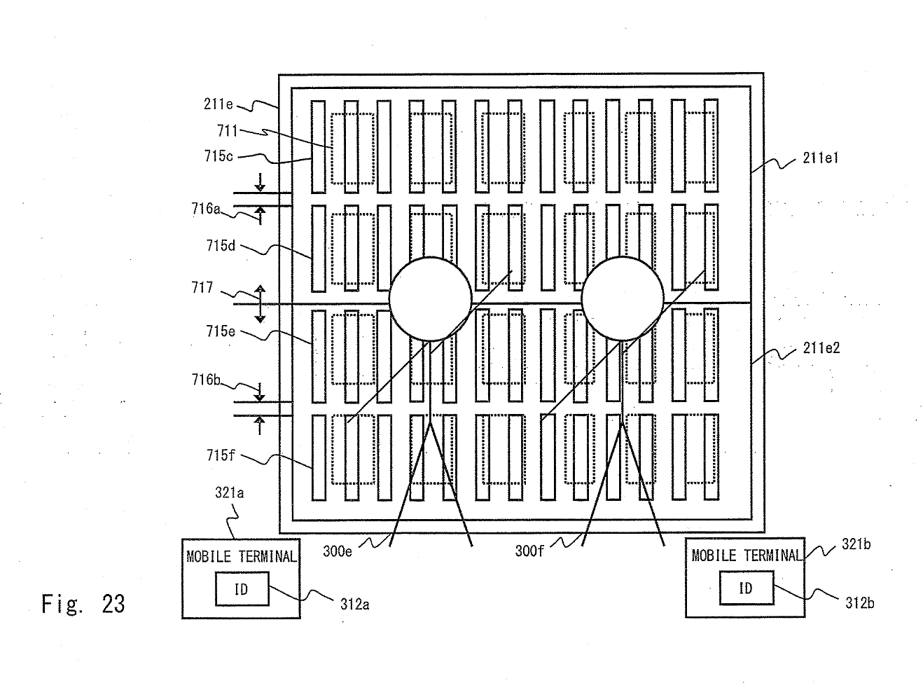

FIG. 22 is a block diagram showing a configuration of a display apparatus 211d according to the eighth embodiment of the present invention. In FIG. 22, electrodes formed longitudinally in stripes are separated by an electrode spacing 716. Body area network transmission/reception circuits for the upper electrodes 715a are disposed around the upper edge of the display apparatus 211d; body area network transmission/reception circuits for lower electrodes 715b are disposed around the lower edge of the display apparatus 211d. Thus, the upper electrodes and the lower electrodes can be handled separately. As a result, for example, when the front of the display apparatus is crowded with purchasers, it is possible to reduce the probability that multiple purchasers may touch the same electrode and thus pieces of purchaser identification information may collide with each other.

FIG. 23 is a block diagram showing a configuration of a display apparatus 211e according to the eighth embodiment of the present invention. In the configuration of FIG. 23, the display apparatus 211e is composed of display regions 211e1 and 211e2, which are two displays partitioned by a display boundary 717. Electrodes are vertically separated by the boundary 717. In the upper display, that is, the display region 211e1, the electrodes are further separated by an electrode spacing 716a; in the lower display, that is, the display region 211e2, the electrodes are further separated by an electrode spacing 716b. That is, each electrode is longitudinally divided into four electrodes: 715c, 715d, 715e, and 715f. Similarly, each electrode may be longitudinally divided into eight or sixteen electrodes. Thus, each divided electrode can be prevented from extending over multiple commodity images, and the need to use the commodity information IF 212 together is eliminated. Further, it is possible to further reduce conflict between pieces of purchaser identification information.

The electrodes for body area network shown in FIGS. 20, 22, and 23 may be used as electrodes for RFID reader/writer.

### Ninth Embodiment of Invention

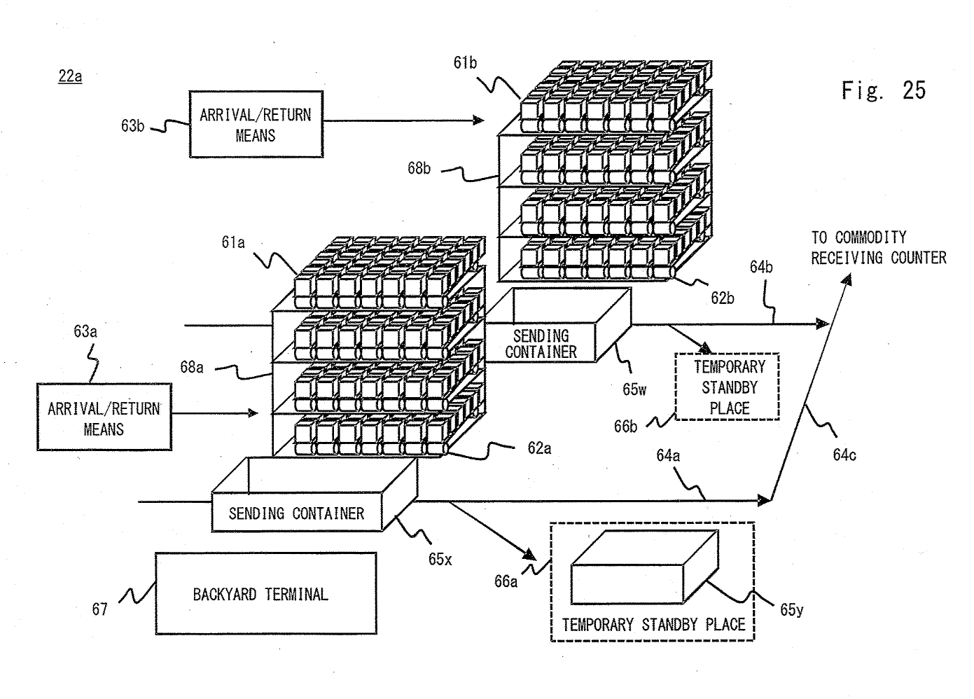

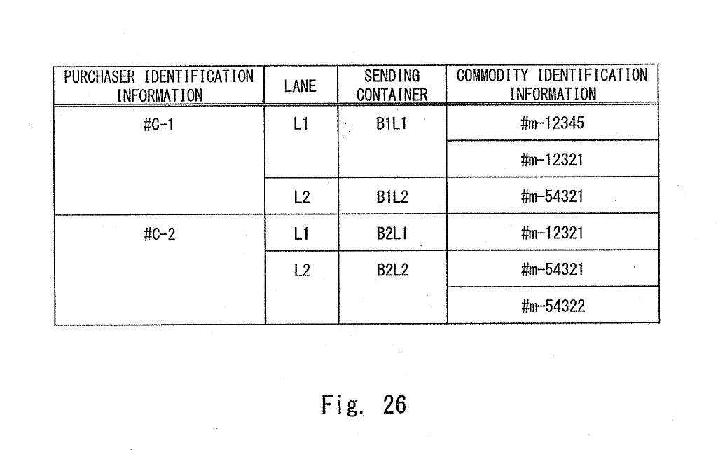

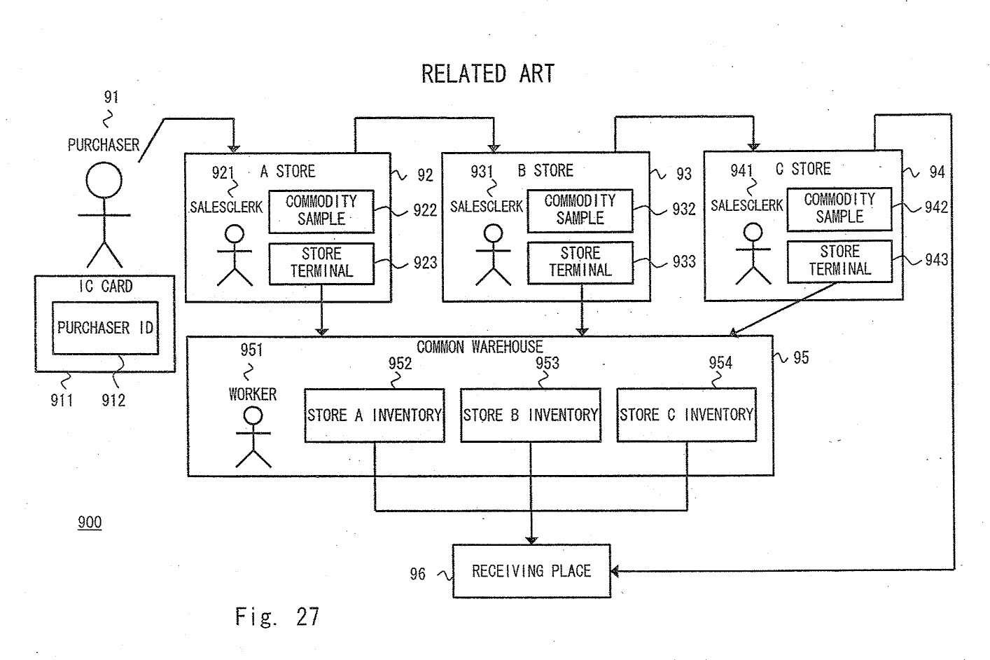

The configuration of the backyard 22 is not limited to that shown in FIG. 4. If the traffic line of customers is predetermined, the configuration of FIG. 4 has no problem; in a store or the like where the traffic line of customers cannot be predicted, the configuration of a backyard 22a shown in FIG. 25 is also possible. This example will be described below while referring to an example of sending information shown in FIG. 26 as necessary.

In comparison with the backyard 22, the backyard 22a is provided with shipping means 64a and 64b that are independent of each other. The shipping means 64a (lane L1) passes through in front of the commodity shelf 68a, and the shipping means 64b (lane L2) passes through in front of the commodity shelf 68b. Ends of the shipping means 64a and 64b are separately connected to shipping means 64c. The shipping means 64a is branched to a temporary standby place 66a; the shipping means 64b is branched to a temporary standby place 66b.

For example, assume that the commodity shelf 68a is a commodity shelf for preserved food and that the commodity shelf 68b is a commodity shelf for fresh food. Also assume that the purchaser C-1 completes selection at a preserved food counter of the front yard and then leaves the counter. At this time, in the backyard 22a, the shipping means 64a moves a sending container 65x (B1L1) for the purchaser C-1 to in front of the commodity shelf 68a in Lane L1. The sending means 62a puts a commodity 61a into the sending container 65x. The shipping means 64a then moves the sending container 65x to the temporary standby place 66a to place it on standby.

Now assume the purchaser C-1 selects fresh food at a fresh food counter of the front yard and then leaves the counter. At this time, in the backyard 22a, the shipping means 64b moves a sending container 65w (B1L2) for the purchaser C-1 to in front of the commodity shelf 68b in Lane L2. The sending means 62b puts a commodity 61b into the sending container 65w. The shipping means 64b moves the sending container 65w to the temporary standby place 66b to place it on standby.

Finally, when the purchaser C-1 indicates that he or she has completed all selection or made payment, the shipping means 64a and 64b move the sending containers 65x and 65w out of the temporary standby places 66a and 66b, respectively. The shipping means 64c then collectively sends all the sending containers allocated to the purchaser C-1, 65x and 65w, to the receiving window.

In the above description, the backyard 22a operates in parallel with the selection made by the purchaser in the front yard. However, the purchaser may change his or her mind while walking around the counters and want to cancel a selected commodity. For this reason, it may be preferred to have means that can cancel a once selected commodity. In this case, after the purchaser indicates that he or she has completed selection or made payment, the backyard 22a preferably starts operating. Since, in the configuration of FIG. 25, lanes L1 and L2 are in parallel with each other and the shipping means 64a and 64b originally operate in parallel with each other, it is possible to send the commodities to the commodity receiving window within several seconds from the indication by the purchaser.

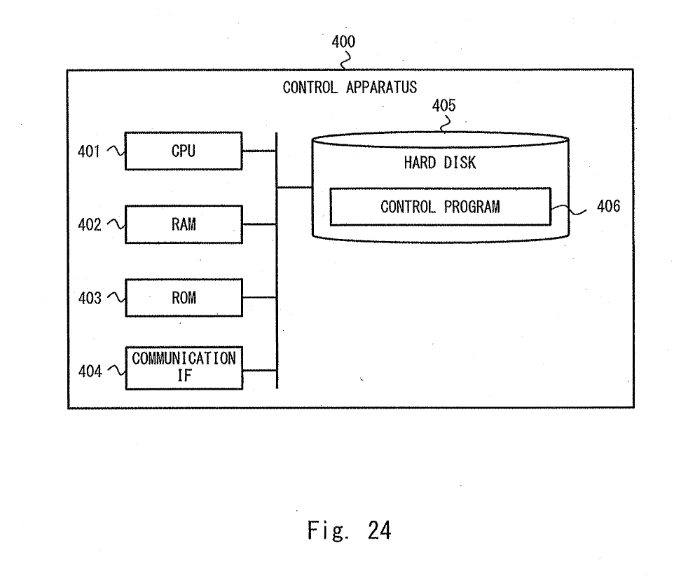

FIG. 24 is a block diagram showing an example hardware configuration of a control apparatus 400 according to another embodiment of the present invention. The control apparatus 400 may be a general-purpose computer that performs various types of processes in the store systems according to the first to eighth embodiments of the present invention. The control apparatus 400 includes a CPU 401, a RAM 402, a ROM 403, a communication IF 404, and a hard disk 405. The hard disk 405 is storing a control program 406. The control program 406 is a computer program on which the various types of processes performed by the store systems according to the first to eighth embodiments of the present invention are implemented. When the CPU 401 reads the control program 406 from the hard disk 405 into the RAM 402 and executes it, various types of processes according to the present invention can be performed.

### Tenth Embodiment of Invention

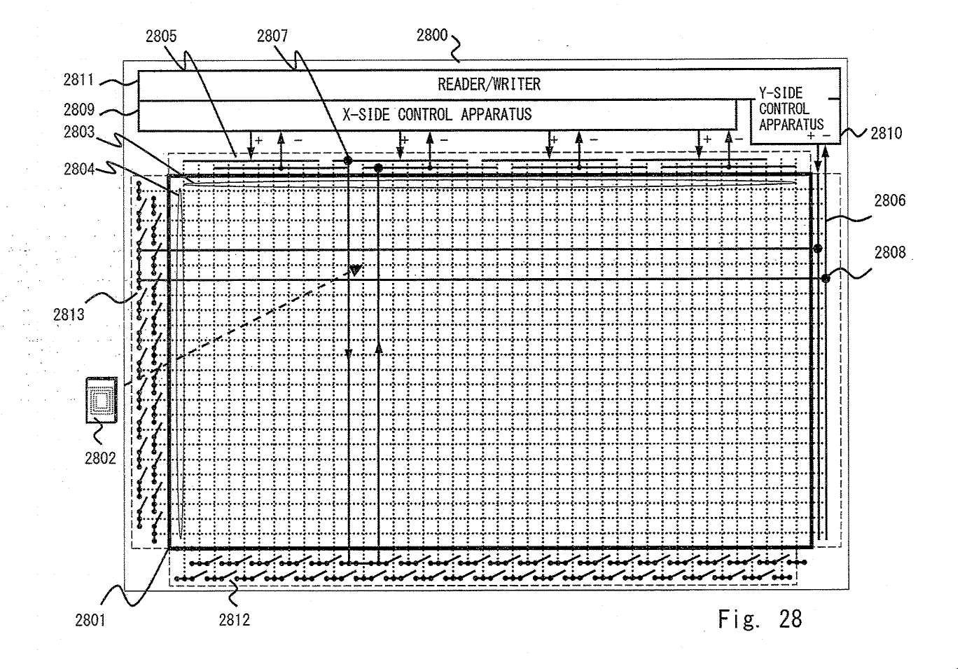

FIG. 28 is a block diagram showing a configuration of a display apparatus 2800 according to a tenth embodiment of the present invention. The display apparatus 2800 has a more detailed configuration than the display apparatuses of FIGS. 18, 20, 22, and 23. While an example in which the display apparatus is used as a body area network reader is mainly shown in FIGS. 20, 22, and 23, an example in which the display apparatus is used as an RFID reader/writer is described in the present embodiment.

The display apparatus 2800 includes a display device 2801, vertical electrodes 2803 vertically extending on the display device 2801, horizontal electrodes 2804 horizontally extending on the display device 2801, a vertical electrode connecting line 2805, a horizontal electrode connecting line 2806, a vertical electrode connecting line switch 2807, a horizontal electrode connecting line switch 2808, an X-side control apparatus 2809, a Y-side control apparatus 2810, a reader/writer 2811, an inter-vertical electrode switch 2812, and an inter-horizontal switch 2813. Virtual objects, such as commodity images, are displayed on the display device 2801. A virtual object is image data serving as an object of selection for a user.

The vertical electrodes 2803 are repeatedly arranged in an x-axis direction (in this diagram, in a horizontal direction), and one end of each vertical electrode 2803 is connected to the X-side control apparatus 2809 via the vertical electrode connecting line switch 2807 and the vertical electrode connecting line 2805. The other end of each vertical electrode 2803 is connected to another vertical electrode 2803 via an inter-vertical electrode switch 2812. These switches can be switched by the X-side control apparatus 2809.

The horizontal electrodes 2804 are repeatedly arranged in a y direction (in this diagram, in a vertical direction). One end of each horizontal electrode 2804 is connected to the Y-side control apparatus 2810 via the horizontal electrode connecting line switch 2808 and the horizontal electrode connecting line 2806. The other end of each horizontal electrode 2804 is connected to another horizontal electrode 2804 via an inter-horizontal electrode switch 2813. These switches can be switched by the Y-side control apparatus 2810.

The X-side control apparatus 2809 and the Y-side control apparatus 2810 are connected to the reader/writer 2811. When the user brings an IC card 2802 close to any position of the display device 2801, coordinates displayed close to the position are detected and thus a virtual object is selected.

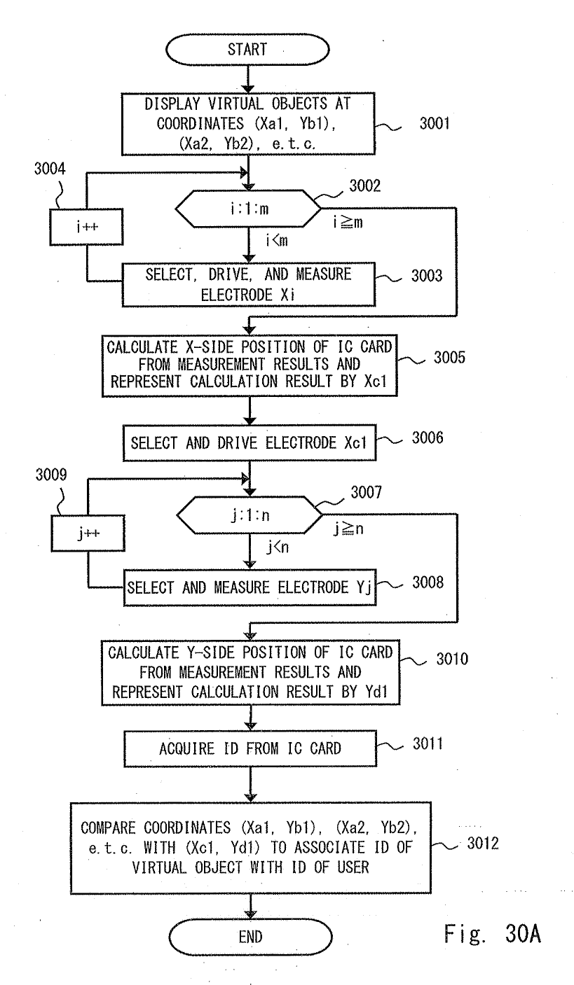

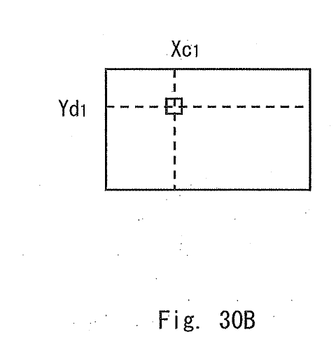

FIG. 30A is a flowchart showing an example operation of the tenth embodiment of the present invention. First, the display apparatus 2800 displays multiple virtual objects at coordinates (Xa1, Yb1), coordinates (Xa2, Yb2), and the like (step 3001). Now assume that the user holds one IC card over a predetermined position (Xc1, Yd1) on the display apparatus 2800, as shown in FIG. 30B.

While a coordinate variable i is changed from 1 to m (step 3002), the display apparatus 2800 selects, drives, and measures a vertical electrode Xi located at i (step 3003) and increases i in increments of 1 (step 3004). The display apparatus 2800 calculates the X-side position of the IC card from the results of the m number of measurements and represents the calculation result as Xc1 (step 3005). Next, the display apparatus 2800 selects and drives the electrode Xc1 (step 3006). While a coordinate variable j is changed from 1 to n (step 3007), the display apparatus 2800 selects and measures an electrode Yj located at j (step 3008) and increases j in increments of 1 (step 3009). The display apparatus 2800 calculates the Y-side position of the IC card from the results of the n number of measurements and represents the calculation result as Yd1 (step 3010). Next, the display apparatus 2800 acquires an ID from the IC card (step 3011). The display apparatus 2800 then compares the respective coordinates of the virtual objects with the calculation result, the coordinates (Xc1, Yd1), to associate the ID of the virtual object with the ID of the user (step 3012).

In step 3001, the virtual objects are displayed on the display device 2801. Examples of the usage of the display apparatus 2800 include the following: various commodity images are displayed on the display device 2800 and then the user selects one of the commodity images; the user selects between two alternatives on the display device 2800; and the user checks one virtual object on the display device 2800. Instead of objects which exist physically, abstract concepts may be displayed as virtual objects. Examples include the names of candidates in an election, a national referendum, and selection of a knowledge database.

FIG. 34 is a diagram showing an example of the measurement result in step 3003. FIG. 34 shows an example of changes in signal power measured when the X-side control apparatus 2809 generates a high-frequency-frequency signal (e.g., 13.56 MHz) and then sequentially drives the vertical electrodes using the signal. The lateral axis represents a coordinate (Xi) of a vertical electrode. For example, these changes occur when the user brings the IC card 2802 close to the display apparatus 2800 or contacts it therewith. By setting threshold power Pth with respect to these power changes, it is possible to obtain coordinates which cross Pth, that is, Xe1 and Xe2. From these coordinates, an estimated X-side coordinate Xc1 of the IC card 2802 can be obtained using the following formula (1) that obtains the midpoint between Xe1 and Xe2 (step 3005).

Xc1=(Xe1+Xe2)/2 (1)

The reason why it is reasonable to obtain the estimated X-side coordinate through the above calculation can be explained as follows. First, assume that, in FIG. 34, the IC card is placed at a position P1. An IC card typically includes a spiral coil (for example, a broken line in the IC card 2802 of FIG. 28; in this case, three loops). Assuming that the vertical electrodes are driven at the positions P2, P3, and P4 in this order, when the position P3 is selected (in this case, the vertical electrode has one loop), a coil formed by the vertical electrode and the coil of the IC card confront each other. At this time, if the vertical electrode is driven by a high-frequency signal, a high-frequency magnetic flux generated by the vertical electrode passes through the coil of the IC card and generates a high-frequency current in the coil of the IC card. Since the high-frequency current passes through the coil of the IC card and thus power is consumed, power being measured by the X-side control apparatus 2809 is increased.

Such increases in the measured power also occur when the IC card and the vertical electrode do not exactly confront each other, that is, when these are slightly displaced from each other. For this reason, as seen at point P5 of FIG. 34, when the IC card and the vertical electrode exactly confront each other, power is appropriately flat around the coordinate Xc1. In particular, when the IC card and the vertical electrode come close to each other and thus the coupling of the two coils is changed from critical coupling to tight coupling, this phenomenon becomes remarkable. Accordingly, it is difficult to find a peak power point from this area having a slight power difference.

On the other hand, as seen at point P2 or point P4 of FIG. 34, when a vertical electrode which is slightly distant from the confronted position is selected, a minimal point like point P6 may appear. Conceptually, this occurs at the position at which both an upward magnetic flux and downward magnetic flux generated by the vertical electrode pass through the coil of the IC card. When the IC card and the vertical electrode are further separated after passing through that point, power slightly arise once and reaches a peak like point P7, and again decreases. The reason is that while the upward magnetic flux has passed through the coil of the IC card at point P5, the downward magnetic flux has passed through the coil of the IC card at point P7. As the distance is increased, the magnetic flux decreases.

By setting the threshold power Pth, for example, between the points P5 and P7 considering the above characteristics, it is possible to extract a point at which power changes abruptly. By extracting the point at which power changes abruptly, it is possible to accurately obtain the positional relationship between the IC card and the vertical electrode.

Since the vertical electrodes are arranged at certain intervals, discrete values, as seen at points P5, P6, and P8, are measured as power changes obtained when the vertical electrodes are switched. By performing an interpolation process using the measured values, it is possible to obtain the power value of any coordinates. For the order of the interpolation process, it is possible to perform several orders of process, although the degree changes according to the memory space allowed by the system, or the computation speed.

While the example in which measurement is made using power has been described, a voltage, current, frequency, or phase change may be used in place of power.

In FIG. 28 or FIG. 34, selection is made such that a one-loop coil is formed by the vertical electrode. Specifically, the vertical electrode connecting line switch 2807 of one vertical electrode is selected, and the positive terminal of the X-side control apparatus 2809 is connected to the vertical electrode connecting line switch 2807; the vertical electrode connecting line switch 2807 of another vertical electrode which is distant from the above vertical electrode by a certain distance is selected, and the negative terminal of the X-side control apparatus 2809 is connected to the vertical electrode connecting line switch 2807; and the two vertical electrodes are connected together using an inter-vertical electrode switch 2812. Preferably, the distance between the two vertical electrodes is set to about the size of the IC card. This is because by doing so, it is possible to effectively pass a magnetic flux formed by the two vertical electrodes through the IC card.

When the two vertical electrodes are selected, the midpoint between the two vertical electrodes can be defined as the coordinates of the selected two vertical electrodes. This is because when a displayed virtual object (a commodity image or the like displayed on the display device 2801) is present around point P1 of FIG. 34, the user holds the IC card over the virtual object or touches the virtual object with the IC card. By defining the center of the virtual object as the coordinates of the virtual object, it is possible to appropriately match the coordinates of the desired virtual object with the coordinates of the IC card, which can be detected through measurement. If the virtual object is oddly shaped, a position around the barycenter of the area used by the virtual object may be defined as the coordinates of the virtual object. When the user touches a virtual object, a back-and-forth or side-to-side error may occur, or an error may occur due to the discrete position of the vertical electrodes and horizontal electrodes. In these cases, by increasing the distance between the displayed virtual objects to the extent that a determination can be made without problem even when such an error occurs, it is possible to associate the virtual object with the IC card without problem.

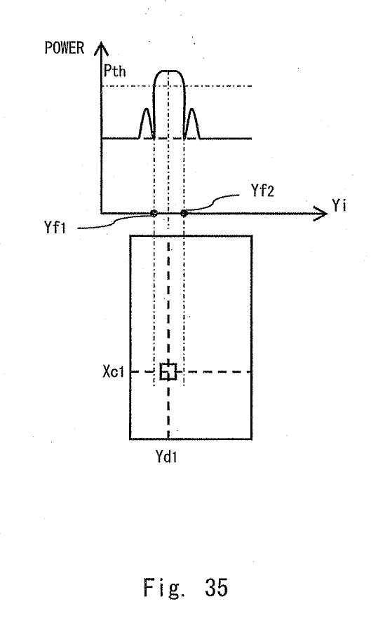

FIG. 35 is a diagram showing an example of the results of power measurements made by the Y-side control apparatus 2810 in step 3008. To obtain a Y-side coordinate, first, selection is fixed to the vertical electrode Xc1 obtained in step 3005 to drive a high-frequency signal (step 3006). Thus, high-frequency power generated by the X-side control apparatus 2809 is propagated from the vertical electrode Xc1 to the horizontal electrode Yd1 via the coil of the IC card. This method is characterized in that since driving power applied to Xc1 is used, it is possible to detect only the Y position of the IC card on the target vertical electrode, Xc1, even when another IC card is present on a vertical electrode other than Xc1 (even when another user touches the vertical electrode). That is, the Y-side control apparatus 2810 selects a horizontal electrode Yd1 using power provided by the X-side control apparatus 2809. Note that when use of a method of causing the Y-side control apparatus 2810 itself to drive the high-frequency signal source causes a problem that an IC card which is not present on the electrode Xc1 would also react.

As in FIG. 34, by setting threshold power Pth with respect to the power changes of FIG. 35, it is possible to obtain coordinates which cross Pth, coordinates Yf1 and Yf2. From these coordinates, an estimated Y-side coordinate Yd1 of the IC card 2802 can be obtained using the following formula (2) that obtains the midpoint between Yf1 and Yf2 (step 3010).

Yd1=(Yf1+Yf2)/2 (2)

In the example of FIG. 28, selection is made such that a one-loop coil is formed by a horizontal electrode. Specifically, the horizontal electrode connecting line switch 2808 of one horizontal electrode is selected, and the positive terminal of the Y-side control apparatus 2810 is connected to the horizontal electrode connecting line switch 2808; the horizontal electrode connecting line switch 2808 of another horizontal electrode which is distant from the above horizontal electrode by a certain distance is selected, and the negative terminal of the Y-side control apparatus 2810 is connected to the horizontal electrode connecting line switch 2808; and the two horizontal electrodes are connected together using an inter-horizontal electrode switch 2813. Preferably, the distance between the two horizontal electrodes is set to about the size of the IC card. This is because by doing so, it is possible to effectively pass a magnetic flux formed by the IC card through the two horizontal electrodes.

Now assume that multiple virtual objects are displayed on the display device 2801 and that one of the virtual objects is touched with an IC card. Since association is made by comparing the estimated coordinates of the IC card detected through the touch with the coordinates of the virtual object, it is possible to perform a process of searching for a combination of the coordinates of the IC card and the coordinates of the virtual object which are the closest to each other. Instead of the method of calculating the distance between the coordinates of the IC card and the coordinates of the virtual object, there may be used a method of defining the coordinate range of virtual objects in advance and determining whether the coordinates of a virtual object fall within the range. Instead of using a rectangle, including a square, as the coordinate range, various coordinate ranges may be defined according to the shape of a virtual object.

Further, by setting a region belonging to no virtual object between adjacent virtual objects, regarding processing of the coordinates of an IC card which has appeared in that region, as an error process, and then urging the user to touch a virtual object again, it is possible to reduce the frequency at which erroneous association is made.

While the sizes of multiple virtual objects may be matched, virtual objects of various sizes similar to those of real objects may be displayed. While the area used by the virtual object on the display device may be used as the coordinate range, the touched position may be indicated by a marker or the like.

By highlighting a virtual object when the user touches the virtual object for the first time, for example, by changing the luminance of the virtual object or blinking the virtual object, it may be clearly indicated that the virtual object has been selected by the user. At this time, to avoid association with an erroneous virtual object (for example, the right next virtual object), the time (interval) during which selection can be cancelled may be set between highlighting and actual association. By perform highlighting, as well as making display indicating the count-down until start of the process, it is possible to notify the user of the timing at which an association process is started.

In step 3012, based on the coordinates of the IC card and the coordinates of the virtual object thus associated, the ID of the IC card and the ID of the virtual object are associated with each other. To read the ID of the IC card (step 3011), the reader/writer 2811 is used. By changing driving and measurement of a high-frequency signal by the X-side control apparatus 2809 to reading or writing by the reader/writer 2811, the ID is read from the x electrode Xc1 having the IC card thereon. The read ID of the IC card is associated with the ID of the selected virtual object.

In FIG. 28, the vertical electrode connecting line 2805 is divided into four portions. This is intended to reduce the parasitic capacitance of the vertical electrode connecting line itself, the vertical electrode connecting line switch 2807 connected thereto, or the like. To easily make critical coupling or close coupling described above, it is necessary to resonate each coil with the frequency of the high-frequency signal. For example, assume that a high-frequency signal having a frequency of 13.56 MHz is used. In this case, by setting the inductance and capacitance of the vertical electrode to about 1 μl and about 140 pF, respectively, it is possible to resonate the coil with the high-frequency frequency. Among the capacitances are the capacitance provided by the capacitor, as well as the parasitic capacitance of the signal source or wiring, switch, electrode, or the like. If the parasitic capacitance is increased, for example, if it exceeds 140 pF described above, it is necessary to reduce the inductance. On the other hand, to easily make critical coupling or close coupling, it is necessary to increase the Q value (quality factor) of the coil. Accordingly, it is preferred to increase the number of windings of the coil. Since an increase in the number of windings of the coil, of course, causes an increase in inductance, it is necessary to first reduce the parasitic capacitance. For this reason, it is effective to divide the vertical electrode connecting line to control increase in parasitic capacitance as much as possible.

For the inter-vertical electrode switches 2812, as seen in the configuration of FIG. 28, connecting two inter-vertical electrode switches 2812 to each vertical electrode, in other words, connecting two inter-vertical electrodes to a single vertical electrode is effective in reducing the parasitic capacitance. Note that if a multiplexer switch (a type of switch which selects a particular signal from among multiple signals) is used as the inter-electrode switch, there occurs a problem that the parasitic capacitances of all switches are increased.

To avoid this resonant frequency problem (the problem that the capacitance or inductance is increased), an impedance adjustment apparatus, such as a negative capacitor or coupler, may be disposed to provide the X-side control apparatus or Y-side control apparatus with a function of resonating these apparatuses to the operating frequency. While the division of the horizontal electrode connecting line 2806 is not shown in FIG. 28, it is divided as in the inter-vertical electrode switch 2812, as a matter of course.

In FIG. 28, it is, of course, possible to combine or separate the functions as necessary, for example, to provide the X-side control apparatus 2809 with the function of the reader/writer 2811.

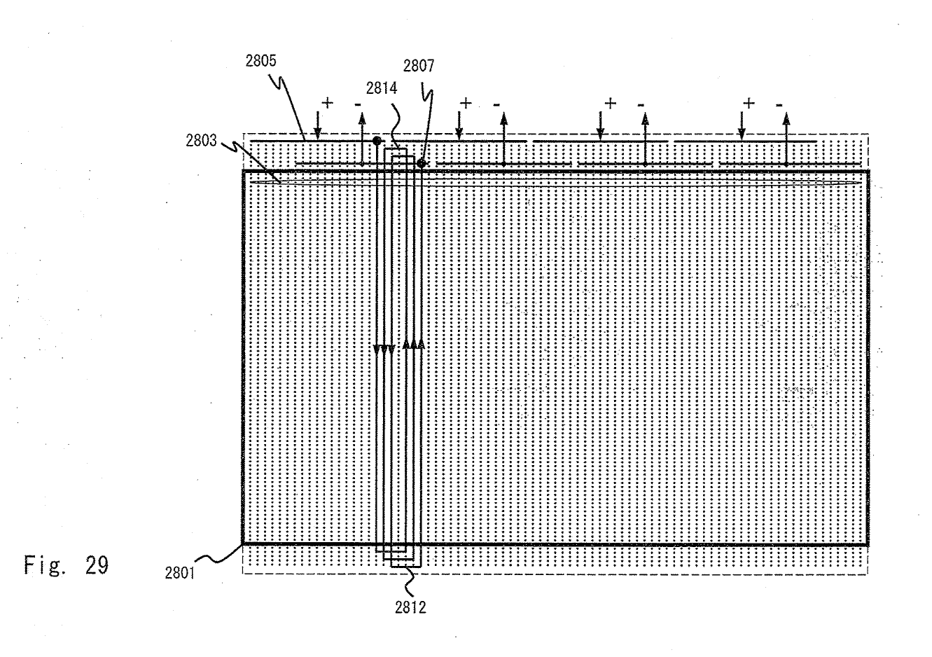

FIG. 29 is an example configuration in which vertical electrodes form multiple loops in the configuration of the display apparatus 2800 according to the tenth embodiment of the present invention. FIG. 29 specializes in the connection between the vertical electrodes for visibility. As with the vertical electrodes, the horizontal electrodes can also form multiple loops.

In an example of FIG. 29, the positive end of the vertical electrode connecting line 2805 is connected to one end of a first vertical electrode 2803 via the vertical electrode connecting line switch 2807; the other end of the vertical electrode connecting line 2805 is connected to one end of a second vertical electrode 2803 via the inter-vertical electrode switch 2812; the other end of the second vertical electrode is connected to one end of a third vertical electrode via the second vertical electrode connecting line switch 2814; similar connection is repeated; and one end of the last vertical electrode is connected to the negative end of the vertical electrode connecting line 2805 via the vertical electrode connecting line switch 2807. Thus, multiple loop-electrode line can be formed.

While the parasitic capacitance R of a vertical electrode is simply proportional to N where N represents the number of loops, inductance L increases in proportional to the square of N. Accordingly, Q ωL/R improves (increases) in proportional to the number of loops. A coupling coefficient kc which reaches critical coupling is expressed as kc=1/Q; kc decreases due to an improvement in Q value; and even a small k (corresponding to a state in which the distance is large) reaches criticality. Thus, the sensitivity (a capability of operating even when the distance is large) of the system is increased.

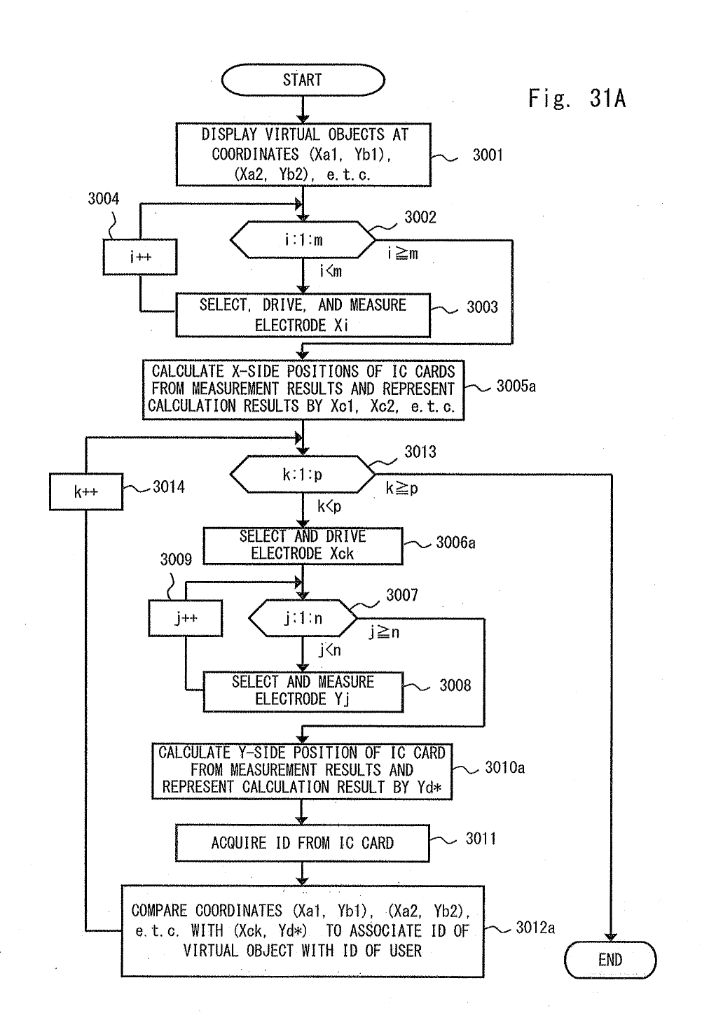

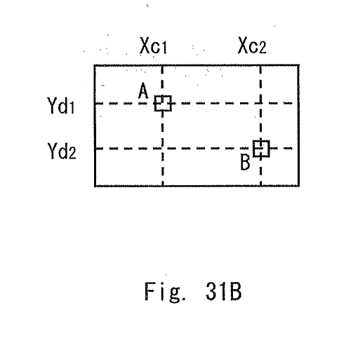

FIG. 31A is a flowchart showing a process performed when multiple IC cards are found during scan of the x side (repeated selection of the vertical electrodes). As shown in FIG. 31B, it is assumed that two IC cards, A and B, are held over different positions, (Xc1, Yd1) and (Xc2, Yd2), on the display apparatus 2800. FIG. 31A differs from FIG. 30A in that when multiple X-side positions having an IC card thereon are found in step 3005a, the process is repeatedly performed p times (where p represents the number of the found X-side positions) in steps 3013 and later. For example, k is set to 1; the electrode Xc1 is selected and driven in step 3006a; and steps up to association step 3012a are performed. Next, k is set to 2, and a similar process is performed on the electrode Xc2. Further, similar processes are performed until k becomes p. Thus, similar processes are performed on all vertical electrodes having an IC card thereon.

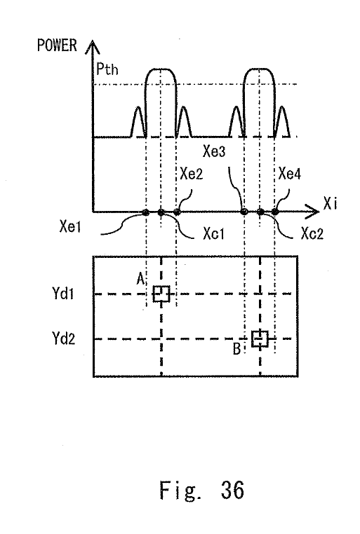

FIG. 36 is an example of power changes measured by the X-side control apparatus during such an x-direction scan. By making determinations on the basis of the threshold power Pth, X-side coordinates Xe1, Xe2, Xe3, and Xe4 are obtained. From these coordinates, respective estimated coordinates Xc1 and Xc2 of the IC cards can be calculated using Formula (1) described above.

If the display apparatus 2800 is large enough for multiple users to simultaneously operate, multiple users may simultaneously operate the display apparatus by touching it with IC cards (FIG. 31B). The configuration of FIG. 31A is suitable for such simultaneous operations by multiple users. On the other hand, if the frequency at which multiple users simultaneously use one display apparatus is low, for example, if the display apparatus is not larger than the display device described above, or if the frequency at which users use the display apparatus is not so high, it is possible to sequentially handle multiple users by sequentially executing an algorithm for handling a single IC card each time as shown in FIG. 30A.

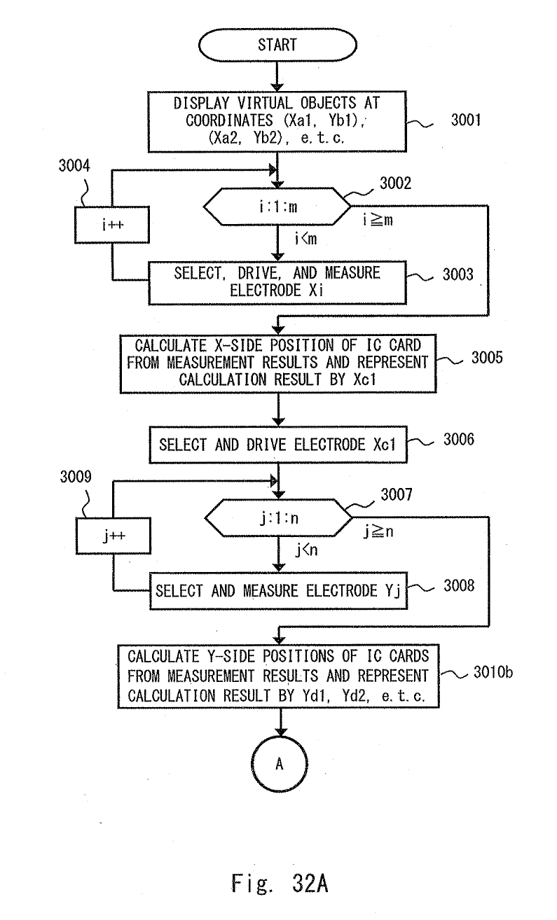

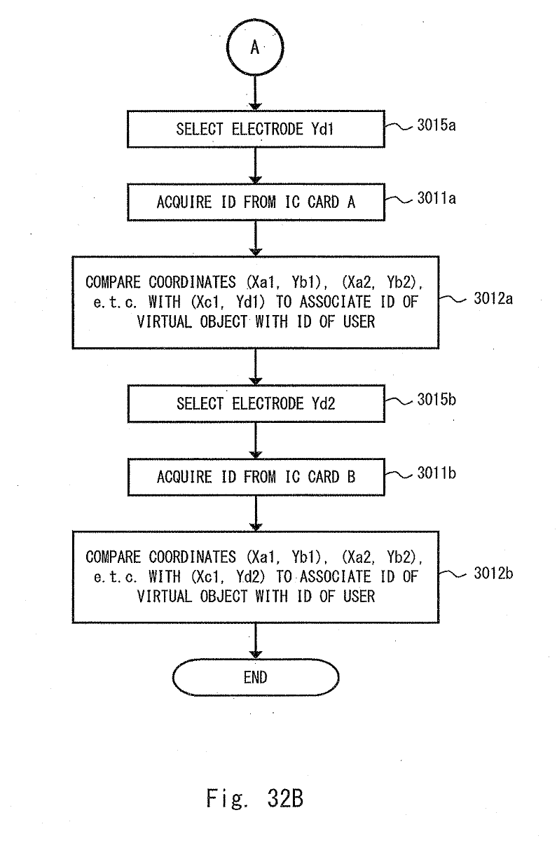

FIGS. 32A and 32B show an example of a process performed when multiple IC cards are present on the same vertical electrode. This example represents an example in which two IC cards are present on the same x coordinate, Xc1 (FIG. 32C). This process can also be performed when three or more IC cards are present. FIGS. 32A and 32B differ from FIG. 30A in that when multiple positions are detected as the Y-side positions of the IC cards in step 3010b, steps, including steps 3015a, 3011a, 3012a, 3015b, 3011b, and 3012b, are performed. Of course, these steps can also be performed when multiple IC cards are present on the same horizontal electrode.

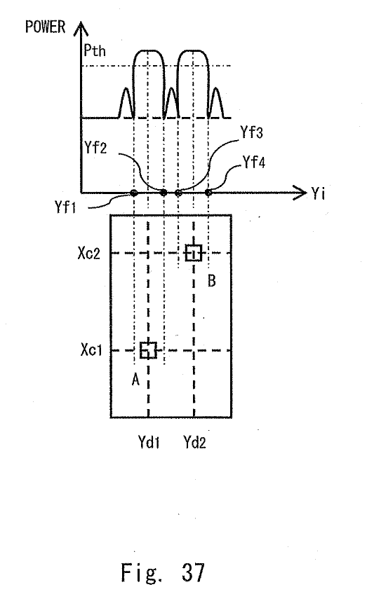

FIG. 37 shows an example of power changes measured by the Y-side control apparatus 2810 when multiple Y-side positions are detected. From coordinates Yf1, Yf2, Yf3, and Yf4 which cross the threshold power Pth, respective estimated coordinates Yd1 and Yd2 of the IC cards can be obtained using Formula (2) described above.

In FIG. 32B, first, a horizontal electrode is fixed to a coordinate Yd1 (step 3015a), and the ID of an IC card A on the electrode Yd1 is obtained using the reader/writer 2811 (step 3011a). After acquiring the ID from the IC card A in step 301a, the ID of the virtual object is associated with the ID of the user (step 3012a). Similarly, the subsequent electrode, the electrode Yd2, is selected (step 3015b); the ID number of an IC card B is acquired (step 3011b); and the IDs are associated with each other (step 3012b). As seen above, by inquiring about and acquiring the IDs of the IC cards through the horizontal electrodes, it is possible to cope with cases in which multiple IC cards are present on an x electrode.

The configuration of FIGS. 32A and 32B assumes that two users simultaneously make touches with IC cards in a vertical direction. Accordingly, this configuration is suitable for a case where a large display apparatus 2800 is used or a case where the display apparatus 2800 is used in a place where multiple users are simultaneously present.

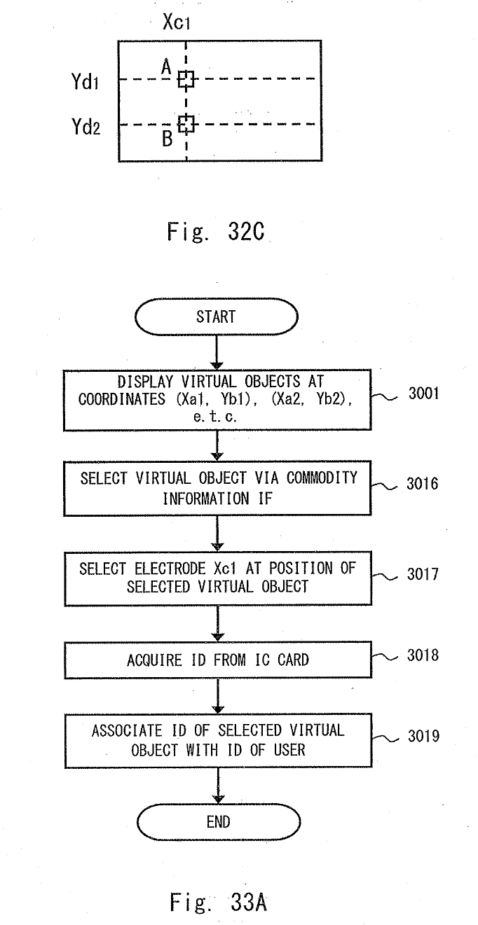

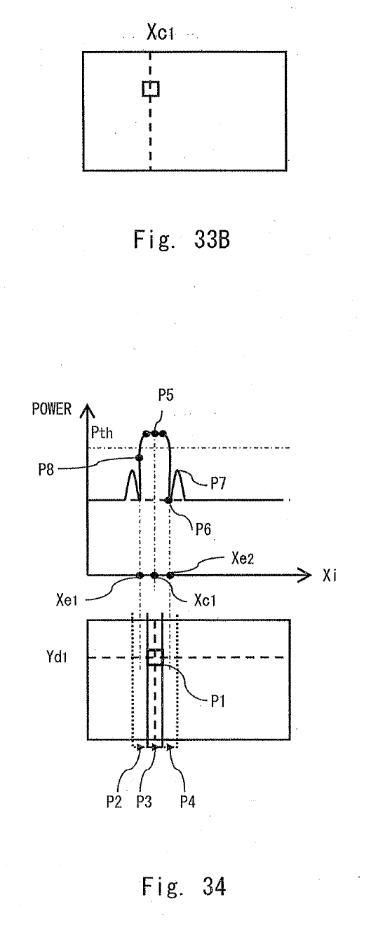

FIG. 33A is an example in which a virtual object is selected via the commodity information IF 212 described in FIG. 3. First, the front yard 21 displays virtual objects at coordinates (Xa1, Yb1), coordinates (Xa2, Yb2), and the like on the display apparatus 2800 (display apparatus 211) (step 3001). Now assume that an IC card is held over the coordinate Xc1, as shown in FIG. 33B. Next, the front yard 21 receives selection of a virtual object via the commodity information IF 212 (step 3016). The front yard 21 then receives selection of an electrode (Xc1) at the position of the selected virtual object (step 3017). The front yard 21 then acquires the ID from the IC card (step 3018). The front yard 21 then associates the ID of the selected virtual object and the ID of the user with each other (step 3019).

As described above, the commodity information IF 212 may be a touchscreen, ultrasonic sensor, camera, infrared transmission/reception apparatus, or the like. The commodity information IF 212 and the display apparatus 2800 may be combined. In step 3016, the user selects the desired virtual object through the commodity information IF 212. To allow the user to recognize that the virtual object has been selected, for example, the selected virtual object may be highlighted. A configuration may be employed in which in case the user makes erroneous selection, the user can cancel the selection, for example, by releasing the touch at that point in time.

After keeping the selected virtual object highlighted appropriately for a length of time within which the user can confirm the selected virtual object, an ID association step is performed. In step 3017, a vertical electrode corresponding to a portion of the selected virtual object (in this case, Xc1) is selected. Alternatively, a horizontal electrode may be used in place of the vertical electrode. However, considering that a human stands in front of the display apparatus, it is preferred to use a vertical electrode. The reason seems that an IC card of another human is less likely to enter from the side. After selecting the vertical electrode, the reader/writer is activated to acquire the ID of the IC card (step 3018). The acquired ID of the IC card is associated with the ID of the selected virtual object (step 3019).

The example configurations of FIGS. 30A, 31A, 32A, 32B, and 33A described above may be combined as necessary. For example, it is, of course, possible to handle IC cards on multiple vertical electrodes, as in FIG. 31A, in the configuration of FIG. 33A, or to handle multiple IC cards on the same vertical electrode, as in FIG. 32C, in the configuration of FIG. 33A.

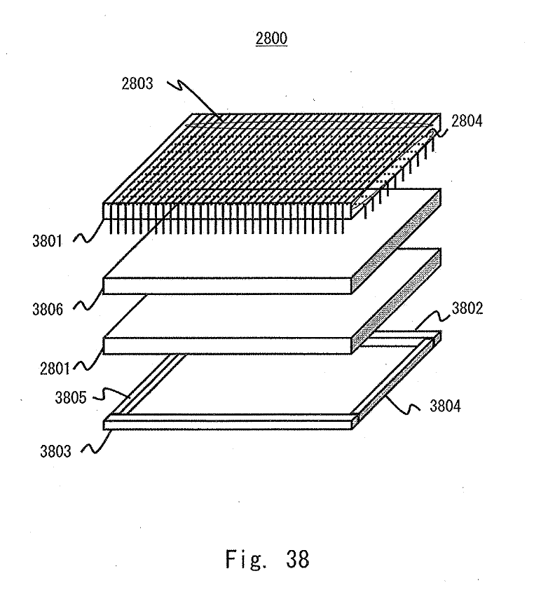

FIG. 38 is an assembly diagram schematically showing a three-dimensional configuration of the display apparatus 2800. First, vertical electrodes 2803 are disposed on one surface of a substrate 3801, and horizontal electrodes 2804 are disposed on the other surface thereof. Subsequently, the substrate 3801 is disposed on one surface of a display device 2801. Disposed on the other surface of the display device 2801 are a first X-side circuit 3802, a second X-side circuit 3803, a first Y-side circuit 3804, and a second Y-side circuit 3805. At this time, it is preferred to interpose a spacer 3806 between the substrate 3801 and the display apparatus 2801. The spacer 3806 is made of a material, such as glass, which has high transmittance and which does not degrade the Q of the coil. The spacer 3806 is used to increase the distance between the vertical electrodes 2803 and horizontal electrodes 2804, and the display apparatus 2801 so as to prevent the display apparatus 2801 from affecting the magnetic field.

The reason for employing such a configuration is to reduce the width of a frame which occurs when multiple display devices are arranged. If circuits that drives the X-side electrodes X or Y-side electrodes and switches between them are disposed around the display device 2801, it is impossible to dispose multiple display devices so as to be adjacent to each other (the frame cannot be narrowed). For this reason, these circuits are disposed on the back of the display device. Thus, the frame can be narrowed.

The substrate 3801 may be made of a material, such as glass, which has high transmittance and which does not degrade the Q of the coil. The vertical and horizontal electrodes need to be made of a material having low resistance and high transmittance and may be made of a material, such as indium tin oxide (ITO). Alternatively, these electrodes may be made of a thin line-shaped metal such that the impact on the visibility of a virtual object can be reduced. To prevent these electrodes from being short-circuited between X and Y, it is possible to form the vertical electrodes and horizontal electrodes separately, for example, by forming the vertical electrodes 2803 on one surface of the substrate 3801 and the horizontal electrodes 2804 on the other surface thereof. It is also possible to form one type of electrodes, then form an insulating film, and form the other type of electrodes. In particular, if the display device 2801 has a configuration in which there occurs an eddy current (a current that occurs due to a magnetic field generated by a vertical or horizontal electrode and works so as to cancel the magnetic field), it may be preferred to increase the distance between the display device and the electrodes. Accordingly, the configuration using an insulating film can be used in a case where there is a need to increase the distance between the display device and the electrodes.

The vertical and horizontal electrodes pass by the sides of the display device and reach the back thereof. The first X-side circuit 3802 disposed on the back of the display device include, for example, the vertical electrode connecting line 2805, the vertical electrode connecting line switch 2807, the X-side control apparatus 2809, and the reader/writer 2811. The second X-side circuit 3803 includes, for example, the inter-vertical electrode switch 2812. The first Y-side circuit 3804 includes, for example, the horizontal electrode connecting line 2806, the horizontal electrode connecting line switch 2808, and the Y-side control apparatus 2810. The second Y-side circuit 3805 includes, for example, the inter-horizontal electrode switch 2813. In the example of FIG. 32C or the like, the first Y-side circuit 3804 may be also provided with the reader/writer 2811. By causing the reader/writer disposed on the x side and the reader/writer disposed on the y side to simultaneously operate to match the phases of high-frequency signals, it is also possible to increase sensitivity.

From the above, the tenth embodiment of the present invention can be described as follows. First, the display means displays multiple commodity images on the display device. The display apparatus 2800 only has to have any one of the X-side and Y-side configurations. The receiving means includes multiple first electrodes disposed along a first direction on the surface of the display device and a first control apparatus configured to provide signals having a predetermined frequency to the first electrodes and to detect a first coordinate in the first direction corresponding to a position selected by a purchaser on the basis of changes in the signals. The receiving means receives a commodity corresponding to a commodity image identified on the basis of the first coordinate, as having been selected by the purchaser.

The first control apparatus measures power generated by the signals provided to the first electrodes and calculates the first coordinate using the results of measurements of the first electrodes. The receiving means then identifies a commodity image displayed in a position corresponding to the first coordinate on the display device and receives a commodity corresponding to the identified commodity image, as having been selected.

The association instruction means acquires purchaser identification information from the detected first coordinate and makes an instruction to associate the acquired purchaser identification information and commodity identification information with each other.

If the display apparatus 2800 has both X-side and Y-side configurations, the receiving means includes multiple second electrodes disposed along a second direction on the display device and a second control apparatus configured to detect a second coordinate in the second direction corresponding to a position selected by the purchaser on the basis of changes in signals which occur on the second electrodes. The receiving means receives a commodity corresponding to a commodity image identified on the basis of the first and second coordinates, as having been selected by the purchaser.

The second control apparatus also detects the second coordinate using power provided by the first control apparatus.

After detecting the first coordinate, the first control apparatus selects a first electrode corresponding to the first coordinate and provides a signal to the selected first electrode. With respect to each of the second electrodes, the second control apparatus measures power generated by the signal provided to the selected first electrode and calculates the second coordinate using the results of measurements of the second electrodes. Subsequently, the receiving means identifies a commodity image corresponding to the first and second coordinates among the multiple commodity images and receives a commodity corresponding to the identified commodity image, as having been selected by the purchaser.

The association instruction means also acquires purchaser identification information from the detected first and second coordinates and makes an instruction to associate the acquired purchaser identification information and commodity identification information with each other.

### Eleventh Embodiment of Invention

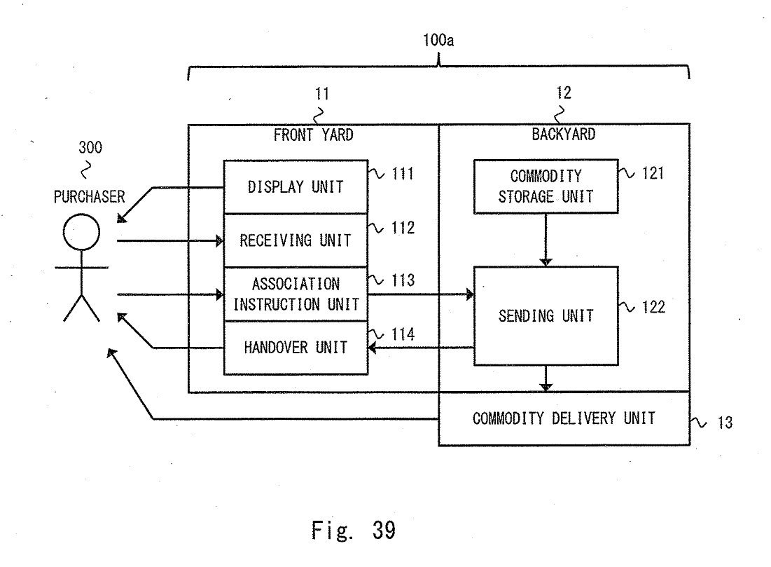

FIG. 39 is a block diagram showing a configuration of a store system 100a according to an eleventh embodiment of the present invention. The store system 100a includes the configuration of FIG. 1, as well as a commodity delivery unit 13. The commodity delivery unit 13 is delivery means that delivers a purchased commodity to the purchaser 300 using transportation means, such as a track.

In the first embodiment shown in FIG. 1, the front yard 11 associates a commodity selected by the purchaser 300 and the ID of the purchaser with each other; the sending unit 122 of the backyard 12 sends the commodity to the handover unit 114 of the front yard 11; and the handover unit 114 hands over the commodity to the purchaser 300. In the eleventh embodiment of the present invention shown in FIG. 39, on the other hand, the sending unit 122 of the backyard 12 sends a commodity to the commodity delivery unit 13. The commodity delivery unit 13 delivers the sent commodity to the purchaser 300 using the transportation means. Thus, the purchaser 300 can receive the purchased commodity.

Reception of a commodity at the handover unit 114 is advantageous in that the customer can immediately receive and use the commodity. However, depending on the type of a commodity, it may be preferred to provide the purchaser with a delivery option, since, for example, the commodity may be large in weight, or the purchaser may not use the commodity immediately. For this reason, in FIG. 39, the customer is allowed to select between reception at that site and delivery, depending on the type of the commodity. Thus, customer convenience is increased.

Preferably, the front yard 11 can receive selection as to whether to deliver the commodity from the purchaser 300 when the receiving unit 112 or the like receives selection of the commodity from the purchaser 300 or when the handover unit 114 hands over the commodity thereto. According to the selection made by the customer, the sending unit 122 sends the commodity taken out of the commodity storage unit 121 to either the handover unit 114 or the commodity delivery unit 13. That is, if the front yard 11 receives selection indicating delivery of the purchased commodity, the sending unit 122 sends the commodity taken out of the commodity storage unit 121 to the commodity delivery unit 13.

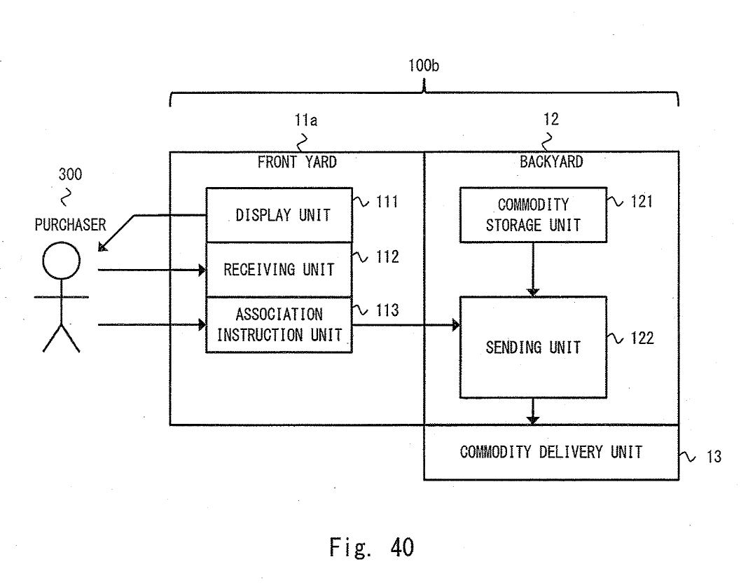

If the store system is disposed in limited space, such as the platform of a station, there may be employed a configuration in which all commodities are delivered without being received at the front yard. FIG. 40 is a block diagram showing a configuration of another example, a store system 100b, according to the eleventh embodiment of the present invention. For the above purpose, the store system 100b includes a front yard 11a obtained by eliminating the handover unit 114 from the front yard 11. Accordingly, a commodity is always delivered to the purchaser 300 via the commodity delivery unit 13. Thus, the customer can smoothly perform processes from selection of a commodity to payment through the interface which uses full-scale virtual objects according to the present invention, with a feeling that he or she is viewing real commodities. There has been no such virtual object-based payment system which can cope with even operations of multiple users at the congested platform of a station, or the like. In such a configuration, the front yard and backyard do not always need to be adjacent to each other, and the backyard may be disposed in a place having excess space.

From the above, the eleventh embodiment of the present invention can be described as follows. That is, an information access system includes a front yard and a backyard adjacent to the front yard. The front yard includes display means configured to display multiple images, receiving means configured to receive, from a user, selection of an object of use desired by the user from among objects of use corresponding to the displayed images, association instruction means configured to acquire user identification information identifying the user from the user and to make an instruction to associate the object-of-use identification information identifying the selected, desired object of use and the acquired user identification information with each other, and handover means configured to the selected, desired object of use to the user. The backyard includes object-of-use storage means configured to store multiple objects of use corresponding to the images and sending means configured to take out the selected, desired object of use from the object-of-use storage means on the basis of the associated object-of-use identification information and user identification information and to send the taken-out, desired object of use to the handover means.

### Twelfth Embodiment of Invention

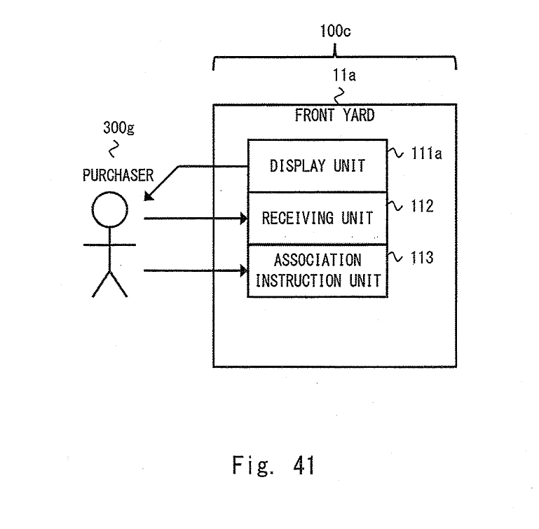

The excellent interface of the present invention can be used in a system that passes information. FIG. 41 is a block diagram showing a configuration of an information access system 100c that passes information.

The information access system 100c includes the front yard 11a but does not include the backyard 12 shown in FIG. 1 or the like. The front yard 11a includes a display unit 111a corresponding to the display apparatus 2800 shown in FIG. 28 and the like, the receiving unit 112, and the association instruction unit 113. The information access system 100c displays a virtual object to a user 300g, receives some operation performed on the virtual object by the user 300g, and updates the display contents of the display unit 111a in accordance with the operation. That is, the information access system 100c processes access to information from the user 300g.

The display unit 111a displays virtual objects. Among virtual objects are concepts, such as information, which have no shape, and data indicating a picture or character string. Multiple virtual objects belong to a single virtual object, and the virtual objects are layered, or linked to each other. As an example, there will be described a case in which the display unit 111a displays the concept of a cloud computing system as a virtual object and in which the user 300g travels along the system configuration from the superordinate to subordinate concepts.

Typically, a cloud computing system includes some components, such as a data center, a server, a terminal, and a network. The concept of a cloud computing system can be typified by a picture of a cloud. For this reason, the display unit 111a first displays an image indicating a picture of a cloud as the most superordinate concept. When the user 300g makes a gesture expanding the cloud picture, the receiving unit 112 receives the gesture, and the display unit 111a displays the components of a subordinate concept of the cloud computing system (for example, typical appearances of a data center, a network, terminal, and the like, or something like a block diagram). When the user 300g further makes a gesture expanding a particular component, the receiving unit 112 receives the gesture, and the display unit 111a descends the layers to display more subordinate concepts and displays elements, structures, and the like in the data center (a picture or block diagram of a server, an inter-server network, or the like).

The receiving unit 112 receives various gestures from the user 300g. The front yard 11a performs a process corresponding to each gesture and causes the display unit 111a to display the process. Thus, the user 300g can acquire various types of experience about a concept shown by the virtual object, such as expanding or contracting the concept, looking thereinto, descending the layers, hearing sound, viewing images, and the like. As described above, the receiving unit 112 may receive operations than other a gesture from the user 300g.

To authenticate the user or browse chargeable content, the association instruction unit 113 performs association between the content and the user ID, or the like.

Although FIG. 41 does not show a place for accumulating information, such a place may be included in the front yard 11a, in a server close to the front yard 11a, or in the data center on the cloud computing system.

The virtual object may be a layered service menu. In this case, the display unit 111a first displays the highest multiple menus. When the receiving unit 112 receives an operation for selecting one of the menus from the user 300g, the display unit 111a may display menus in a layer lower than the selected menu. When the desired menu is displayed, the user 300g holds an IC card or the like over the menu to indicate his or her intent to select the menu. As a result, the association instruction unit 113 acquires an ID from the IC card or the like, associates the selected menu and the ID with each other, and stores the associated information. The association instruction unit 113 can also make instructions to perform various types of processes on the basis of the associated information.

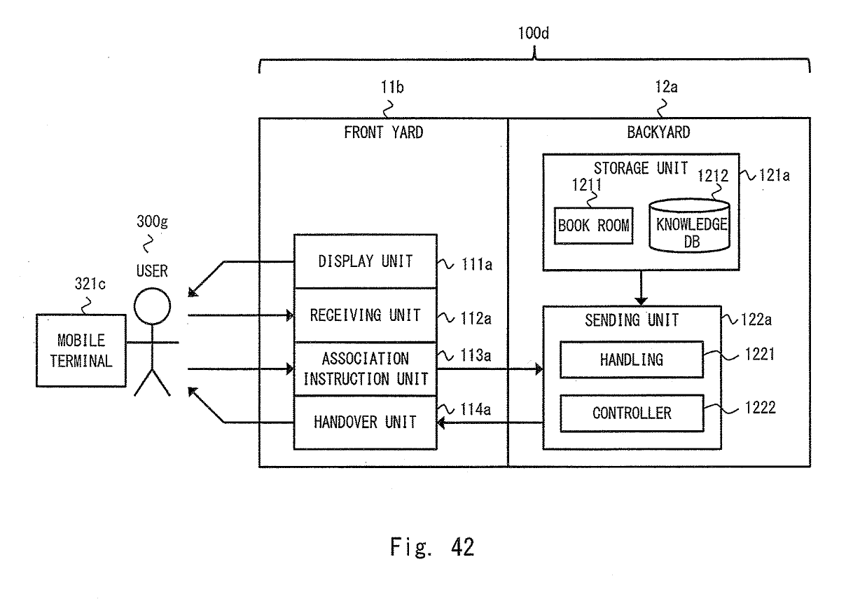

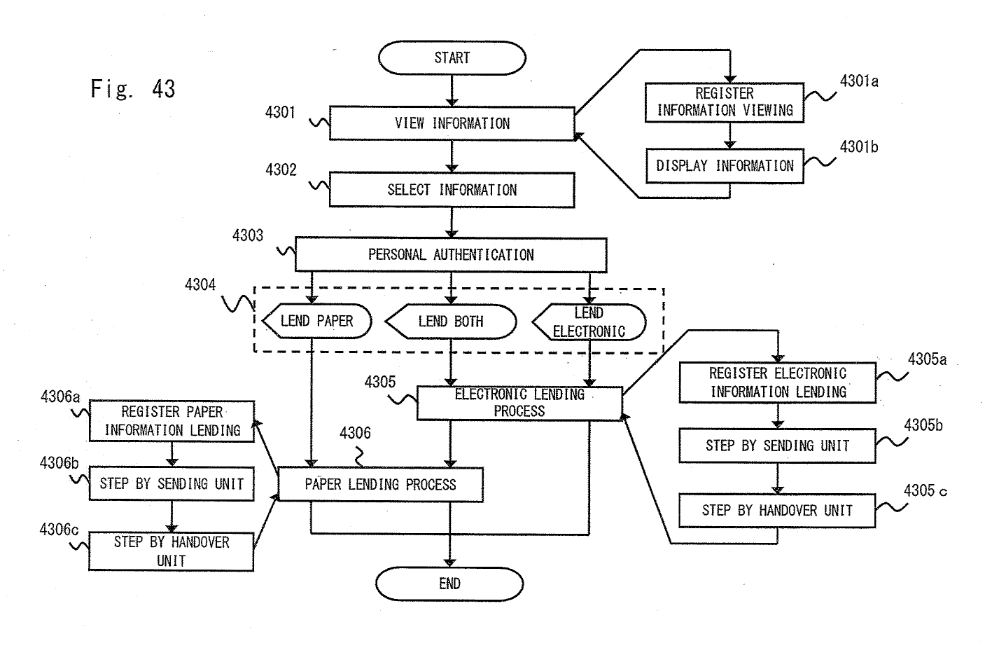

FIG. 42 is a block diagram showing a configuration of another example, an information access system 100d, according to the twelfth embodiment of the present invention. While a commodity and payment for the commodity are described in FIG. 1, the information access system 100d of FIG. 42 can handle information. The information access system 100d includes a front yard 11b and a backyard 12a. The front yard 11b includes the display unit 111a, a receiving unit 112a, an association instruction unit 113a, and a handover unit 114a. These components basically have functions equivalent to those in FIG. 1. The association instruction unit 113a associates the ID of a virtual object and the ID of a user with each other. The handover unit 114a hands over information. As seen above, the information access system 100d is not limited to a commodity and payment for the commodity. In providing free services in a library or the like, content and a user need to be associated with each other for two purposes: one is to identify an individual who will use the content to prevent theft, abuse, or the like of the content; and the other is to grasp usage histories of the user to learn preferences thereof so as to improve services.

Specifically, in the present embodiment, tangible or intangible information or item is handled, and the ID of information and the ID of a user are exchanged to use such information or item. It is assumed that components shown in FIG. 42 have functions or roles equivalent to or higher than those of FIG. 1 unless otherwise specified.

Examples of tangible information include books, and CDs, DVDs, magnetic tapes, and memories including information. As seen in the example of FIG. 41, examples of intangible information include information displayed on the display unit 111a and information captured by the mobile terminal 321c of the user via a network, such as a LAN. Intangible information is characterized in that there is no need to pass a physical medium to the user.

In the present embodiment, to exchange tangible or intangible information, a storage unit 121a is storing tangible or intangible information. The user 300g cannot access such information arbitrarily. As in the example of FIG. 1, this is advantageous in that theft is prevented, that the labor for managing the inventory is saved, that the space of the front yard is saved, and the like. To accumulate tangible information, the storage unit 121a includes a place, such as an archive 1211 or shelf. Preferably, these components are configured to be adaptable to automatic transportation means as shown in FIG. 4. The storage unit 121a also includes a knowledge database (DB) 1212. The knowledge DB 1212 is, for example, a hard disk or memory and has a function of accumulating data.

A sending unit 122a has a function of accessing and extracting tangible or intangible information in accordance with a request from the user 300g. With respect to tangible information, for example, the archive 1211 or shelf of the storage unit 121a is accessed, and necessary tangible information is extracted and then sent to the handover unit 114 of the front yard 11b. Similarly, with respect to intangible information, the knowledge DB 1212 is accessed, and necessary intangible information is extracted and then sent to the handover unit 114a serving as a user interface. To perform the above processes, the sending unit 122a has a function of handling tangible and intangible information (handling 1221).

The handling 1221 also functions as an input/output (I/O) for intangible information. The sending unit 122a also functions as a controller 1222 for controlling the handling function. Intangible information may be displayed on the display unit 111a via the sending unit 122a.

FIG. 43 is a flowchart showing the operation of the information access system 100d as described above. The operation includes an information viewing step 4301, an information selection step 4302, a personal authentication step 4303, a paper lending/electronic lending/both lending selection step 4304, an electronic lending step 4305, and a paper lending step 4306.

The information viewing step 4301 includes an information viewing registration step 4301a and an information display step 4301b. The electronic lending step 4305 includes an electronic information lending registration step 4305a, a sending unit processing step 4305b, and a handover unit processing step 4305c. The paper lending step 4306 includes a paper information lending registration step 4306a, a sending unit processing step 4306b, and a handover unit processing step 4306c.

The information viewing step 4301 is performed, for example, through the display unit 111a or receiving unit 112a. The user 300g can find necessary information at the receiving unit 112a by viewing details of a virtual object (information) displayed on the display unit 111a or performing an operation, such as descending of the layers. When the user finds necessary information, he or she can perform an operation on the found information, as necessary. For paper books, there is a limit to the number of books possessed by a library. Similarly, it may be necessary to impose a limit on the number of views of electronic data. For this purpose, in the information viewing registration step 4301a, when one user starts viewing data, the viewing user and the information being viewed are associated with each other, and a viewing flag is set in the information being viewed. Thus, the number of persons greater than or equal to the limit number are prevented from viewing the information. In the information display step 4301b, the user who is permitted to view information views the information. The user can view the information, for example, through the display unit 111a.

If the user 300g wants lending of information, he or she selects the desired information in the information selection step 4302. The user can confirm the desired information selected by him or her by highlighting the information (virtual object). In the personal authentication step 4303, the user 300g touches the display apparatus with an IC card by using the association instruction unit 113a, thereby associating the virtual object and the ID of the user with each other. The information access system 100d can proceed to the lending step only after checking whether lending to the user 300g is allowed (whether the user has reached the upper lending limit or whether there is return failure information with respect to the user, or the like). This personal authentication does not necessarily need to be performed in this stage and may be performed when the user starts using the information or immediately before he or she receives the information.

Among methods for lending information are lending of paper information, lending of electronic information, and lending of both. As used herein, the electronic information refers to intangible information described above and is transferred to a user terminal through a wired or wireless LAN or the like. The information access system 100d may have only one of these methods, or the user may select the desired one from among the lending methods.

The paper lending/electronic lending/both lending selection step 4304 is a step in which the user makes such selection. In this step, an example in which paper representing tangible information is lent is used for the sake of clarity. Those who want to rent only paper books, those who want to rent electronic data by transferring it to their mobile terminal, and those who want to do both are conceivable and can make such selection in this step. Of course, media other than paper described above may be handled in the paper lending step.

In the electronic information lending registration step 4305, the user and information to be used are associated with each other to lend the information, and an electronic information lending registration step 4305a for registering the fact indicating that the information is being lent is performed. As described above, the sending unit 122a accesses the information stored in the storage unit 121a and sends it to the handover unit 114a (sending unit processing step 4305b). The handover unit 114a sends the information to the mobile terminal 321c of the user via a wired or wireless LAN or the like (handover unit processing step 4305c). The communication method used at this time is not limited to communication via a LAN and may be communication via PAN, WAN, light, sound wave, or the like. Alternatively, the user 300g may bring a medium, such as a memory, with himself or herself and write data to the memory.

In the paper lending step 4306, as with electronic information, a paper information lending registration step 4306a is performed. As described above, the sending unit 122a accesses the archive or the like stored in the storage unit 121a and sends paper information, such as a book, to the handover unit 114a (sending unit processing step 4306b). The handover unit 114a of the front yard 11b hands over the paper information to the user 300g (handover unit processing step 4306c).

While a paper information return step is omitted in this flowchart, there is a step of cancelling the lending registration and returning the paper information to the storage unit. For return of electronic information, a similar step can be performed. Further, a configuration may be employed such that when a given date comes and the available period expires, use of the information is disabled. In this case, at the point in time when the deadline is reached, the lending registration is cancelled.

By first performing the personal authentication step 4303, it is also possible to provide services based on personal information or usage histories. Since the system first recognizes the background of the individual, it can provide information suitable to him or her. For example, in a case in which the user who wants to conduct research on cloud computing uses the information access system 100d, terms to be used or information to be introduced to the user may be changed depending on whether the user has knowledge about IT technology. By using technical terms to a more knowledgeable user, the user may be able to access necessary information easily. Further, by changing the image of a displayed virtual object in accordance with the specialty of the user, the user may able to reach necessary information easily. In this type of research, even when information is not lent to the user, the user may learn necessary information through the interface, including the display unit, receiving unit, or the like.

While the example in which the user performs operations on the display apparatus or the like has been described, the user may perform similar operations on a mobile terminal possessed by or lent to the user. While a display apparatus is characterized in that it can provide realism owing to its large, screen, it has a problem of being more costly than a mobile terminal. By using both, it is possible to provide a service suitable to the need of the user while reducing the cost.

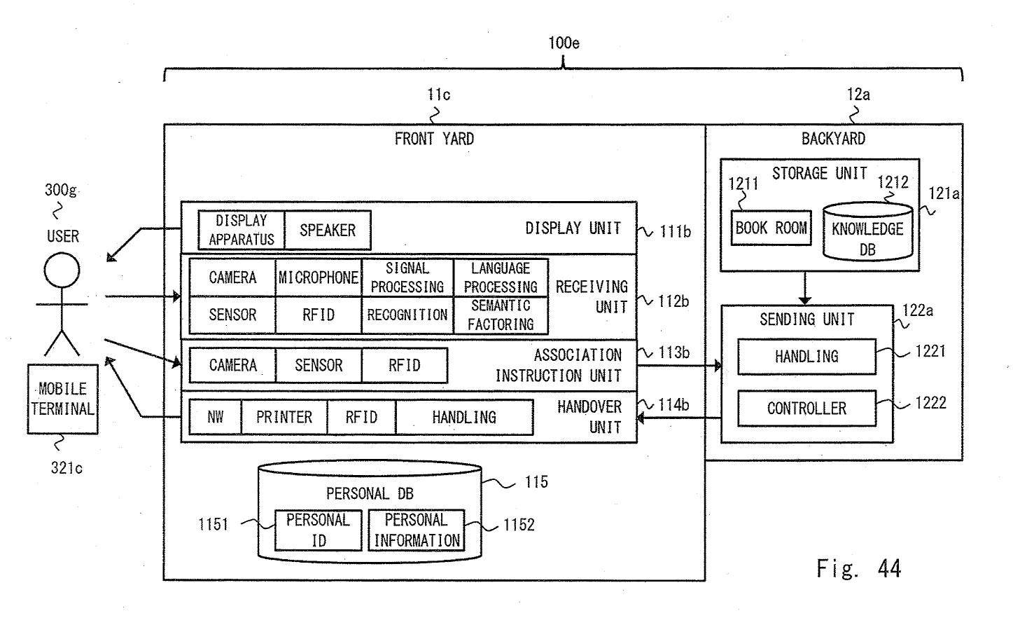

FIG. 44 is a diagram showing an information access system 100e which is obtained by further advancing the information access system 100d and which is an example configuration for providing various types of information to the user. The information access system 100e can be used in lending or research of information, as well as in educational services, consultative services, administrative services, and the like. The excellent user interface of the present invention can provide virtual experience, as well as can provide various types of services by learning user histories. Examples of such services in the field of education include learning systems which provide virtual nature experience, virtual society experience, and virtual history experience and teach a variety of curriculums. Examples of such services in the field requiring consultation with a specialist include systems which refer to personal information to support consultation about medicine, health care, finance, or law. Examples of such services in the field of administrative services include systems which support certification, application, or the like. Further, the application in the field of education or research can be expanded. For example, the information access system 100e can be used, for example, to create a new idea on the basis of research on the related art and to record the idea.

Based on these applications, the information access system 100e provides the variety of services described above in accordance with various operations performed by the user 300g holding the mobile terminal 321c. The information access system 100e includes a front yard 11c and the backyard 12a. The front yard 11c includes a display unit 111b, a receiving unit 112b, an association instruction unit 113b, a handover unit 114b, and a personal DB 115. The backyard 12a is equivalent to that of FIG. 42.

The personal DB 115 is a database that associates a personal ID 1151 identifying a user and personal information 1152 with each other and stores the associated information. The personal information 1152 includes static personal information, such as the age, sex, profession, and educational attainment of the person (components that do not change, such as past information), and dynamic personal information (components that change, such as knowledge), or the like.

The display unit 111b provides information with high realism through the sense of sight, hearing, or the like. For example, the display unit 111b includes a display apparatus, a speaker, and the like.

The receiving unit 112b includes a camera or microphone, as well as various types of sensors that measure biological reactions of the user. Among various sensors are an infrared sensor, a vibration sensor, a haemodynamometer, a thermometer, an electroencephalograph, a sudorometer, a myoelectric potential sensor, a sight line sensor using a camera, a respiratory frequency sensor, and a heartbeat sensor. The receiving unit 112b may be provided with an RFID reader-writer for reading personal operation histories from the mobile terminal 321c. The receiving unit 112b performs signal processing, for example, eliminates noise from the above sensors to extract the desired signal. According to the extracted signal, the receiving unit 112b performs various types of recognition, including character recognition, voice recognition, image recognition, and recognition of personal biological status. Further, the receiving unit 112b performs language processing, specifically, classifies recognized words to optimize spoken words and written words of the user. Thus, the receiving unit 112b can improve the recognition accuracy. The receiving unit 112b also can analyze the meaning intended by the user on the basis of the recognized words and specify a subsequent process. The receiving unit 112b also can update the personal DB 115 to redefine the knowledge level of the user.

Instead of identifying the personal ID using the reader/writer, the association instruction unit 113b may identify the personal ID through face authentication using a camera, or by using various types of sensors, including a fingerprint sensor, an iris sensor, and an intravenous sensor.

In addition to the handling function of passing tangible information, the handover unit 114b may have a network communication function of passing intangible information, a function of transferring information through an RFID reader/writer, a function of outputting paper using a printer, or the like.

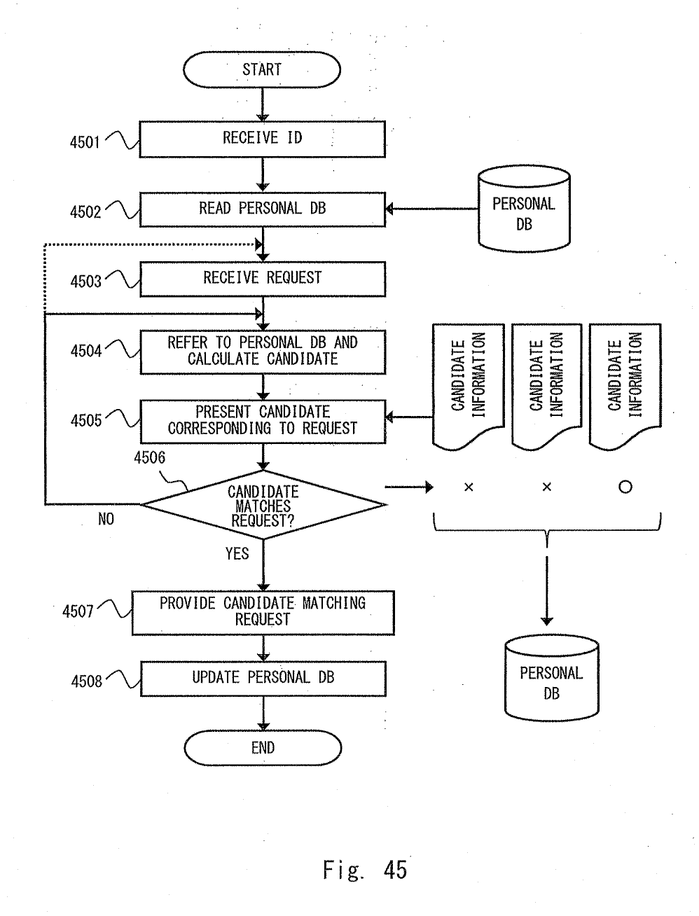

FIG. 45 shows the flow of the process when using the information access system 100d having the above applications. In an ID receiving step 4501, association between a service to be used and a customer ID, or the like is performed. Then, the association instruction unit 113b is used to perform personal authentication. In a personal DB reading step 4502, the static personal information, as well as the previous dynamic personal information are read. In a request receiving step 4503, the receiving unit 112b receives a more specific request. For example, in research, the receiving unit 112b receives a request about items to be researched; in education, it receives a request about a category or the like that the user wants to learn. In a personal DB reference/candidate calculation step 4504, the front yard 11c calculates candidate information according to the knowledge level of the user in response to the request while referring to the static and dynamic personal information. In a candidate-to-request presentation step 4505, the calculated candidate is presented to the user. For example, the display unit 111b displays the candidate. In a candidate/request matching determination step 4506, the user is asked about whether the presented candidate matches the request of the user. For example, the receiving unit 112b receives, from the user 300g, a reply indicating whether the candidate matches the request. If the candidate does not match the request, another candidate is calculated (4504) and then presented to the user (4505), and the user is asked again (4506). To confirm the true request of the user, the receiving unit 112b may newly receive a request from the user (4503). By repeating these steps, information that the user truly wants to obtain is narrowed down. Note that it is preferred to record the repeated candidate presentation and confirmation steps. The presentation of the candidate serves as an input to the user; the reply to the confirmation serves as an output from the user. By recording these steps, it is possible to know the reaction process of the user. This is useful in determining personalities of the user, such as characters, thinking process, and preferences. This record is used to update the dynamic personal information. Thus, when the user uses information next time, appropriate information can be provided to the user. In a candidate-matching-request providing step 4507, tangible or intangible information is provided through the display unit 111 or handover unit 114. In a personal DB update step 4508, the dynamic personal information is updated.

As described above, the dynamic personal information is a database representing the knowledge level, characters, the way of thinking, or the like of the individual. Since the system repeatedly learns the dynamic personal information, it is possible to generate a virtual thinking pattern of the user to improve the service level. By using the various types of sensors, signal processing, recognition, or the like, it is possible to make a variety of determinations using an implied signal to estimate the thinking pattern with improved accuracy.

### Thirteenth Embodiment of Invention

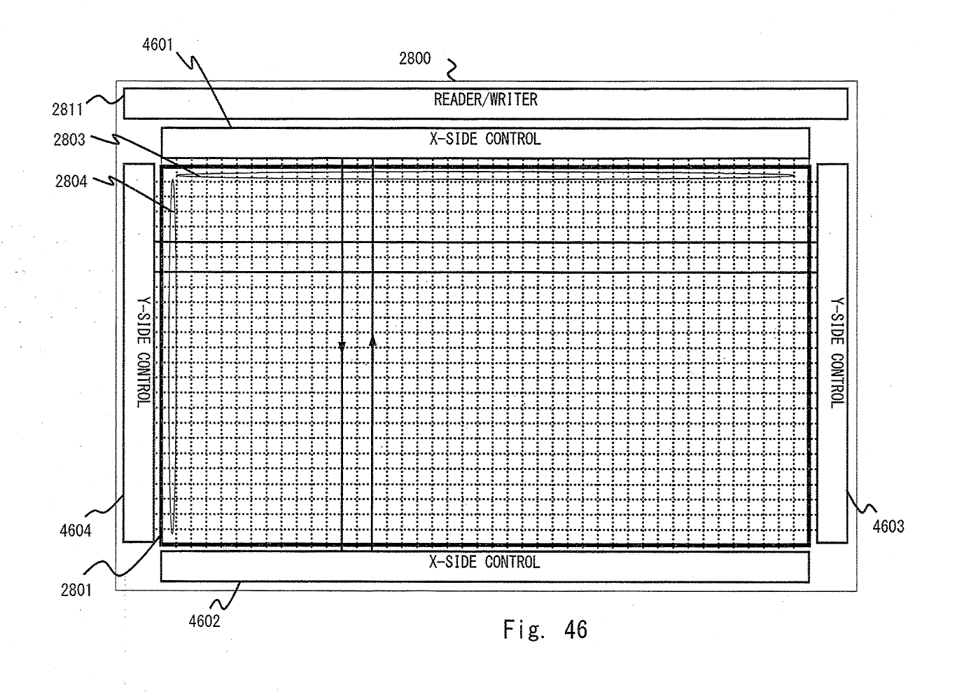

FIG. 46 shows a block diagram showing the functions of the display apparatus 2800 shown in FIG. 28. The display apparatus 2800 includes the display device 2801, X-side control 4601, X-side control 4602, Y-side control 4603, Y-side control 4604, the reader/writer 2811, the vertical electrodes 2803, and the horizontal electrodes 2804.

The vertical electrodes 2803 and the horizontal electrodes 2804 are disposed on the display device 2801. By passing a current through two or more of the vertical electrodes 2803, a magnetic field is generated. The purposes of using the generated magnetic field are to confirm the position of an IC card on the display device and to exchange information with the IC card. For the horizontal electrodes 2804, they are driven like the vertical electrodes in some cases; they simply perform detection without passing a current therethrough in other cases. This function of simply performing detection may be provided to the vertical electrodes.

The X-side control 4601, the X-side control 4602, the Y-side control 4603, and the Y-side control 4604 perform operations for selecting a particular electrode from among the multiple electrodes. When passing a current through the electrodes, these components perform operations for generating drive signals. Further, the components perform operations for measuring the drive signals to grasp the position of the IC card. The components then perform operations for sending the measurement results to the reader/writer 2811.

The reader/writer 2811 decodes the sent measurement results to read the signal sent from the IC card. The reader/writer 2811 also sends a signal to the IC card via the X-side and Y-side control apparatuses.

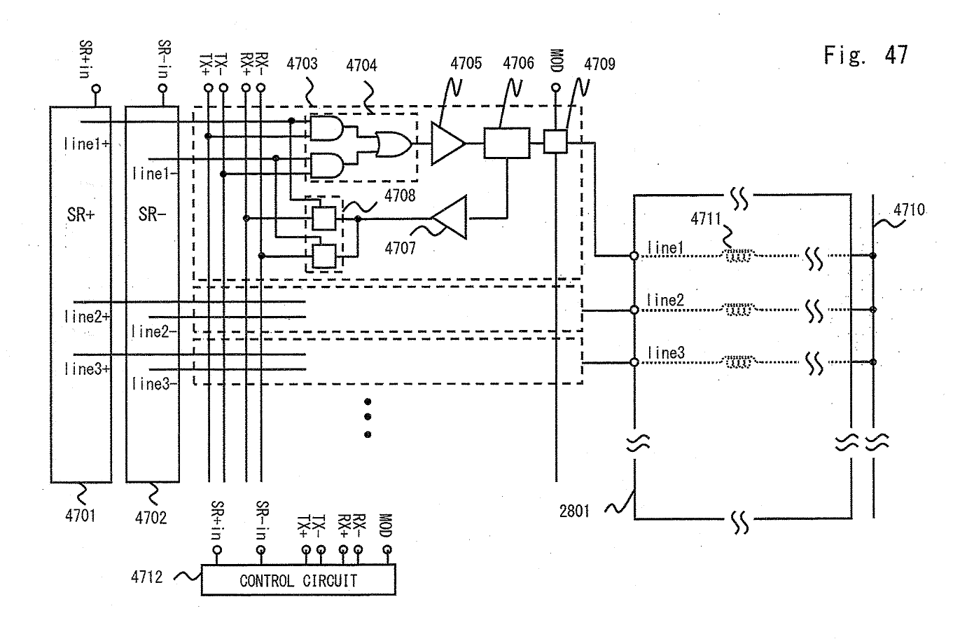

FIG. 47 is a circuit diagram showing the display apparatus 2800. The display apparatus 2800 includes a positive shift register 4701, a negative shift register 4702, a control circuit 4712, and multiple transmission/reception circuits 4703. The transmission/reception circuits 4703 are disposed on the electrodes, respectively, on the display device 2801. Each transmission/reception circuit 4703 includes a transmission selection circuit 4704, a transmission amplifier circuit 4705, a filter/matching/detection circuit 4706, a receiving amplifier circuit 4707, a receiving selection circuit 4708, and a modulation circuit 4709. These shift registers and transmission/reception circuits constitute the circuit of the X-side control 4601 or Y-side control 4603 of FIG. 46. In this example, the X-side control 4602 and the Y-side control 4604 have a function 4710 of short-circuiting ends of all the vertical electrodes 2803 or horizontal electrodes 2804. An inductance component 4711 represents the inductance of each electrode. As seen above, in FIG. 47, each electrode is provided with a drive circuit and thus resistance components of the switch can be reduced.

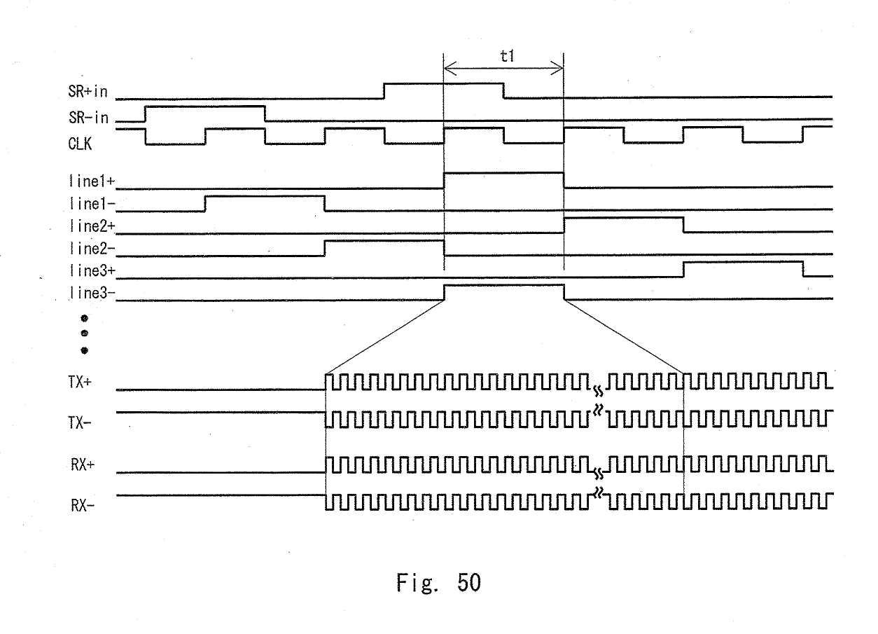

The operation of FIG. 47 will be described while using a timing chart of FIG. 50 together. An SR+in signal represents a data signal inputted to the positive shift register 4701; an SR−in signal represents a data signal inputted to the negative shift register 4702; a CLK signal represents a clock signal; line1+, line2+, and line3+ represent outputs of the positive shift register 4701; line1−, line2−, and line3− represent outputs of the negative shift register 4702; TX+ and TX− represent transmission signal input terminals added to the transmission/reception circuit 4703; and RX+ and RX− represent reception signal output terminals.

In this example, “H” is inputted to the SR−in signal and, after one CLK cycle, “H” is inputted to the SR+in signal. The reason is that in selecting two electrodes, electrodes are selected at an interval of two electrodes, as shown in FIG. 46. In this example, the electrode interval is set to a length corresponding to half the diameter of the coil of the IC card. The position is detected in units of the length corresponding to half the diameter of the coil. Since the interval between the electrodes, through which a current is passed, is preferably equal to the diameter of the coil, it is preferred to select electrodes as described above. If it is desirable to further increase the position detection accuracy, electrodes may be selected at intervals of three electrodes or four electrodes.

During a period t1 of FIG. 50, line1+ and line3− are selected. Thus, a signal based on the signal TX+ is provided to an electrode line1; a signal based on the signal TX− is provided to an electrode line3. The signals TX+ and TX− have opposite polarities, and signals having opposite phases are provided to the electrodes line1 and line3. Next, signals having opposite phases are provided to a pair of electrodes line2 and line4. As seen above, signals having opposite phases are sequentially provided to two lines at intervals of two or a certain number of lines.

As seen above, in the circuit of FIG. 47, the transmission/reception circuit 4703 generates a signal based on the signal TX+ or generates a signal based on the signal TX−, which is opposite in polarity. Since the signal TX− is a signal obtained by inverting the signal TX+, the signal TX− may be generated from the signal TX+ using an inverter in the transmission/reception circuit 4703 rather than providing it.

In FIG. 50, the signal RX+ is a positive reception signal; the signal RX− is a negative reception signal. For the reception signal, as with the transmission signal, when one electrode receives a positive signal, the electrode outputs a signal RX+ as a detected waveform. The same goes for a negative signal.

As described above, the transmission selection circuit 4704 of FIG. 47 controls selection which of the signal TX+ and signal TX− passes therethrough, on the basis of signals from the shift registers 4701 and 4702.

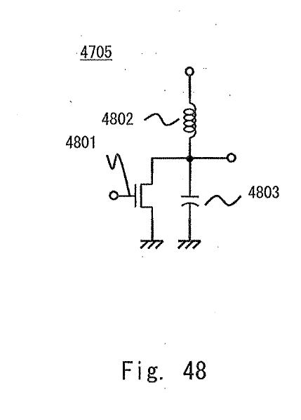

The output of the transmission selection circuit 4704 is provided to the transmission amplifier circuit 4705. FIG. 48 shows an example of a device-level circuit of the transmission amplifier circuit 4705. The transmission amplifier circuit 4705 includes an amplifier transistor 4801, an inductance 4802, and a capacitor 4803. The transmission amplifier circuit 4705 has a function of amplifying power up to power necessary to drive the vertical electrode 2803 or horizontal electrode 2804. The inductance 4802 and the capacitor 4803 function as a load together with a subsequent circuit and are set such that sufficient power is drawn at the drive frequency (e.g., 13.56 MHz).

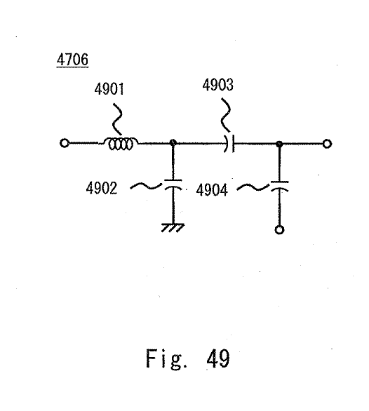

The output of the transmission amplifier circuit 4705 is provided to the filter/matching/detection circuit 4706. FIG. 49 shows an example of a device-level circuit of the filter/matching/detection circuit 4706. The filter/matching/detection circuit 4706 includes an inductance 4901, a first capacitor 4802, a second capacitor 4803, and a detection capacitor 4904. Since the output of the transmission amplifier circuit 4705 includes many high-frequency components (spurious components), a low-pass filter formed mainly by the inductance 4901 and the first capacitor 4802 reduces the spurious components. The first capacitor 4802 and the second capacitor 4803 function as a matching circuit and are set such that the inductance component 4711 of the electrode and the impedance preceding the matching circuit resonate to the drive frequency. Thus, a sufficient current is provided to the inductance component 4711. The detection capacitor 4904 has one end connected to one end of the inductance component 4711 and is used to detect a signal at the end of the inductance component 4711.

The signal detected by the detection capacitor 4904 is provided to the receiving amplifier circuit 4707. The transmission selection circuit 4704 functions as a buffer amplifier for driving the impedance of the parasitic capacitance or the like of subsequent stages. For this reason, depending on the impedance of subsequent stages, the receiving amplifier circuit 4707 may be omitted.

The output of the receiving amplifier circuit 4707 is provided to the receiving selection circuit 4708. As in the transmission side, the receiving selection circuit 4708 has a function of allocating the detected signal to one of the terminals RX+ and RX− on the basis of a signal from the shift register. For example, when the transmission/reception circuit 4703 is functioning as a positive transmission/reception circuit, both the transmission selection circuit 4703 and the receiving selection circuit 4708 pass a positive signal therethrough.

The modulation circuit 4709 has a function of modulating transmission power. For example, in the NFC standards, ASK of 100% or 8 to 30% is used as the modulation degree of the modulation method. To achieve such ASK, the modulation circuit 4709 is connected, for example, to the output of the transmission amplifier circuit 4706 to modulate transmission power. For this purpose, the modulation circuit 4709 may be connected to a portion other than the output of the transmission amplifier circuit.

The control circuit 4712 generates a signal necessary for the shift register or transmission/reception circuit or processes a reception signal outputted from the transmission/reception circuit. Examples of processing of a reception signal include processing of a measured waveform shown in FIGS. 34 to 37. Further, the control circuit 4712 controls communication between the reader/writer and the IC card after the coordinates of the IC card are identified. Specifically, the control circuit 4712 fixes the shift register to the coordinate position and sends a transmission signal sent from the reader/writer to the transmission/reception circuit, as well as sends a reception signal sent from the IC card to the reader/writer 2811.

In a configuration including both the vertical electrodes 2803 and the horizontal electrodes 2804, it is possible to provide a transmission/reception circuit as shown in FIG. 47 to one of both and to provide only a reception-related circuit to the other by omitting a transmission-related circuit. This is because, as described above, when the respective inductance components of the vertical electrodes, the IC card, and the horizontal electrodes are coupled together, for example, drive power from the vertical electrodes is provided to the IC card, as well as to the horizontal electrodes and thus the horizontal electrodes can detect a signal without having to have a transmission circuit and detect on which of the horizontal electrodes the IC card is located.

While the above description relates to the IC card, the description is also applicable to a terminal having an IC card function, as a matter of course.

### Fourteenth Embodiment of Invention

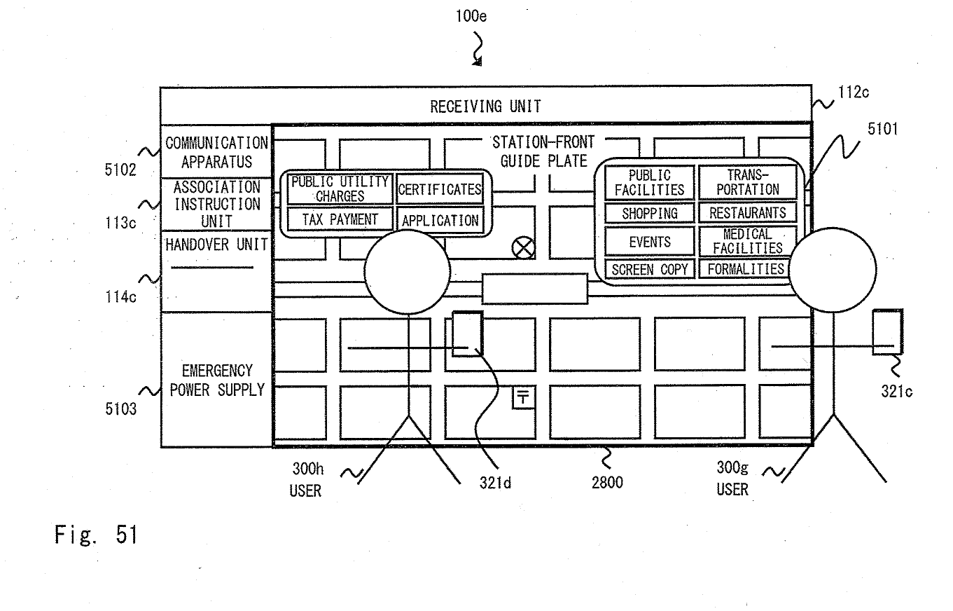

FIG. 51 is a block diagram showing a configuration of an information access system 100e according to a fourteenth embodiment of the present invention. The information access system 100e includes the display apparatus 2800, a pop-up screen 5101 displayed on the display apparatus, a communication apparatus 5102, and an emergency power supply 5103. The information access system 100e also includes a receiving unit 112c having a function similar to the receiving unit 112 shown in FIG. 44, an association unit 113c having a function similar to the association unit 113 shown in FIG. 44, and a handover unit 114c having a function similar to the handover unit 114 shown in FIG. 44. The information access system 100e processes operations performed by multiple users, 300g and 300h, in parallel, or performs parallel processing for detecting mobile terminals 321c and 321d possessed by these users.

The display apparatus 2800 has functions necessary to extract the coordinates or ID of an IC card. For this reason, the association unit 113c has a function related to a comparison between the coordinates of an IC card and the coordinates of a virtual object.

The display apparatus 2800 functions as a typical guide plate, for example, before the user 300g or the like operates it. If the display apparatus 2800 is disposed in front of a station, it may display a map of a station-front area. When the user 300g or the like requests a further service, the following services may be provided according to details of the request.

First, the information access system 100e may copy a map, a train timetable, or a guide for events or the like to the mobile terminal 321c or the like. For information about an area, it takes time and effort to know the location of the information (http, etc.), particularly for those who do not live in that area. For this reason, the receiving unit 112c, for example, receives an operation, such as a touch on the screen, gesture, or voice, performed by the user 300g. Based on the operation received, the information access system 100e displays the pop-up screen 5101 on the display apparatus 2800. At this time, the information access system 100e may highlight necessary information, for example, the position of a postal office, on the display apparatus 2800. The handover unit 114c may transmit a copy of the screen to the mobile terminal 321c. The handover unit 114c may also collectively transmit information files necessary for the user 300g. In these cases, the receiving unit 112c detects that the user 300g has touched the screen with the mobile terminal 321c, and the handover unit 114c transmits the information files through the coordinate recognition function and reader/writer function shown in FIG. 46. Examples of information thus obtained include information related to public facilities, transportation, shopping, restaurants, events, medical facilities, other shops or facilities, and municipalities. The user 300g can obtain such information by touching an icon in the pop-up screen 5101.

The information access system 100e may also receive and process payment of public utility charges or the like. By using the excellent human interface of the fourteenth embodiment of the present invention, the user 300g or the like can perform an operation easily as if he or she were at a real window. For example, the user 300h can make payment by selecting payment of public utility charges and then touching the screen with the mobile terminal 321d. If the user 300h needs a receipt as a certificate of the payment, he or she can receive the receipt through the handover unit 114c. A function of making payment using cash may be provided to the handover unit 114c. To avoid the pop-up screen 5101 from preventing another user from checking the map, the pop-up screen 5101 may be displayed in a transparent manner.

The information access system 100e may also issue certificates, such as a certificate of residence. The receiving unit 112c may check the personal ID of the user 300h upon a touch on the screen with the mobile terminal 321c and request the issuance of a certificate of residence or the like that the user is permitted to obtain. The handover unit 114c may output a special sheet which functions as a certificate. Thus, the user 300h can receive the formal certificate through the handover unit 114c.

The information access system 100e may also issue service coupons. Specifically, taking advantage of the fact that the user is nearby, the information access system 100e may issue coupons so that nearby shops can obtain an effect of attracting customers. In this case, the handover unit 114c transmits the coupons to the mobile terminal 321d. When the user 300h shows any coupon to the relevant shop, such an effect is obtained.

Examples of the communication apparatus 5102 include wireless apparatuses for a wireless wide area network (WWAN), a wireless local area network (WLAN), a wireless local area network (WPAN) or the like. Picocells or femtocells, which are relatively small cells, may be used in a WWAN. In the transmission of information to a mobile terminal, there is a limit to the transmission speed at which information can be transmitted through the reader/writer or the like of the display apparatus 2800 (typically, a maximum of about 424 kbps). For this reason, in the transmission of high-capacity data, including image data, it may be preferred to use the communication apparatus 5102. Communication through the communication apparatus 5102 can be permitted by obtaining authentication through the display apparatus 2800. Thus, the need for the user to take extra time and effort can be eliminated.

As seen above, by using the human interface of the present invention, which is similar to real experience, the user can obtain the following advantages: the user can acquire information faster and in an easier-to-see manner by consulting this apparatus than by conducting research by himself or herself; the user can copy the consultation result to the mobile terminal; the user can receive issuance of a special document; and the user can also make payment, including that through cash. Even when no general mobile line is available during a disaster, the communication apparatus 5102 and the emergency power supply 5103, such as a battery, allow the user to obtain necessary information.

The information access system 100e according to the fourteenth embodiment of the present invention can be described as follows. That is, an information processing apparatus includes a display device configured to display a image, terminal position detection means disposed on the display device and configured to detect a position of a terminal which has approached the display device, read/write means configured to read identification information included in the detected terminal and to write predetermined information to the terminal, and a control apparatus configured to identify, from the detected position of the terminal, an image displayed adjacent to the position and to cause the read/write means to write information associated with the identified image to the terminal.

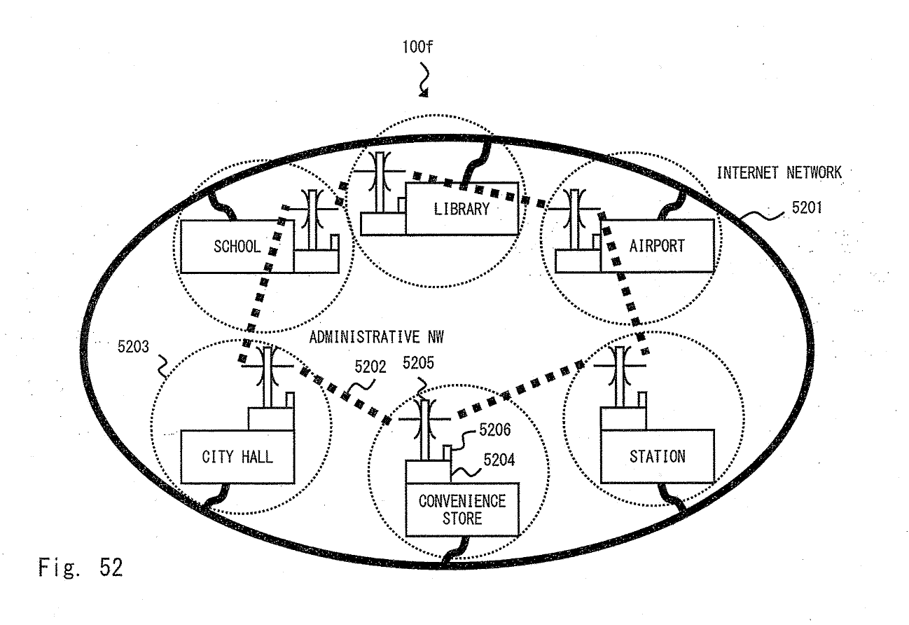

FIG. 52 is a diagram showing an information access system 100f that can maintain services essential for life even during a disaster and which is an example configuration for providing a wide range of services at low cost in normal times. The information access system 100f includes the Internet 5201, an administrative network 5202, a wireless-communication cell 5203, a battery 5204, an administrative communication apparatus (e.g., microwave communication apparatus) 5205, and a communication apparatus 5206. While the communication apparatus 5206 may be replaced with the communication apparatus 5102 of FIG. 51, it may be disposed separately.

Connected to the Internet 5201 are display apparatuses 2800 which are present at a variety of facilities, including city halls and schools, libraries, airports, stations, and convenience stores. Also connected to the Internet 5201 is the administrative network 5202, which is backed up by the emergency power supply 5204, such as a battery. While the traffic distribution policy may be defined in advance, it can be changed depending on the state of traffic during a disaster as necessary, for example, so that less urgent information is also passed when there is some room in traffic.

For example, in normal times, only traffic related to administrative services is passed through the administrative network, and the other information is passed through the Internet network. During a disaster or power failure, on the other hand, the Internet network or general mobile line may be disconnected. Since the display apparatus 2800 of FIG. 51 and the administrative network 5202 of FIG. 52 are backed up by batteries and thus can maintain services even during an emergency, it is possible to pass information other than administrative services through the administrative network. Information related to confirmation of human safety during a disaster, and the like are different from administrative services but have high publicness. Accordingly, it is conceivable to pass such information through the administrative network.

The communication apparatus 5206 is used when an emergency is determined to have occurred and there is a need to pass information other than administrative services for such a purpose. The wireless-communication cell 5203 is the cell range of wireless communication provided by the communication apparatus 5206. (In normal times, the wireless-communication cell 5203 can be used to transfer high-capacity data between the display apparatus and a mobile terminal, as shown in FIG. 51.)

For example, when a public institution permits such communication, it authenticates users to prevent unfairness from occurring among users. For example, the public institution investigates communication histories of a user related to this special communication on the basis of user information obtained from a touch on the screen of the display apparatus 2800 and permits the user to perform such communication within a predetermined period of time. For access to a web site or the like for confirming human safety, or the like, the public institution can perform flow control so that such access is permitted unconditionally.

As seen above, the information access system 100f is available even during a disaster or the like. Accordingly, it is possible for a public institution, such as the national or local government, to provide benefits or the like during a disaster or the like through the information access system 100f. Thus, it is possible to shortly receive benefits or the like even during a disaster or the like.

The information access system 100f according to the fourteenth embodiment of the present invention can be described as follows. That is, an information processing apparatus includes an emergency power supply, first communication means configured to perform communication via a closed network for communicating particular information to be used for a particular purpose, second communication means configured to perform communication via an open network for communicating information which is not limited to the particular information, acquisition means configured to acquire, from a terminal storing user information related to a user, the user information, and control means configured to cause the first communication means to communicate the particular information on the basis of the user information via the closed network and to cause the second communication means to communicate information other than the particular information via the open network on the basis of the user information. When the second communication means fails to perform the communication via the open network, the control means operates based on the emergency power supply and causes the first communication means to communicate information other than the particular information via the closed network on the basis of the acquired user information. Thus, it is possible to open the administrative network to the public during a disaster to, allow disaster victims to rapidly transmit or receive necessary information.

When the control means causes the first communication means to communicate information other than the particular information, it preferably determines whether the communication is permitted, on the basis of the user information. Thus, it is possible to impose some restriction to cause communication having high priority to use a limited network band stably.

### Fifteenth Embodiment of Invention

Patent Literature 4 described above is a technology that, by using multiple conductive plates embedded in the floor, detects the body position of an aged person or the like walking on the floor from the impact of the walking upon the electric field. However, Patent Literature 4 always performs detection, regardless of whether the user needs to stay in a particular place. For this reason, this technology has a problem that it cannot determine whether the user has clearly indicated he or her intention. In view of the foregoing, the following fifteenth to nineteenth embodiments of the present invention are intended to detect the position specified explicitly by the user with an easy operation.

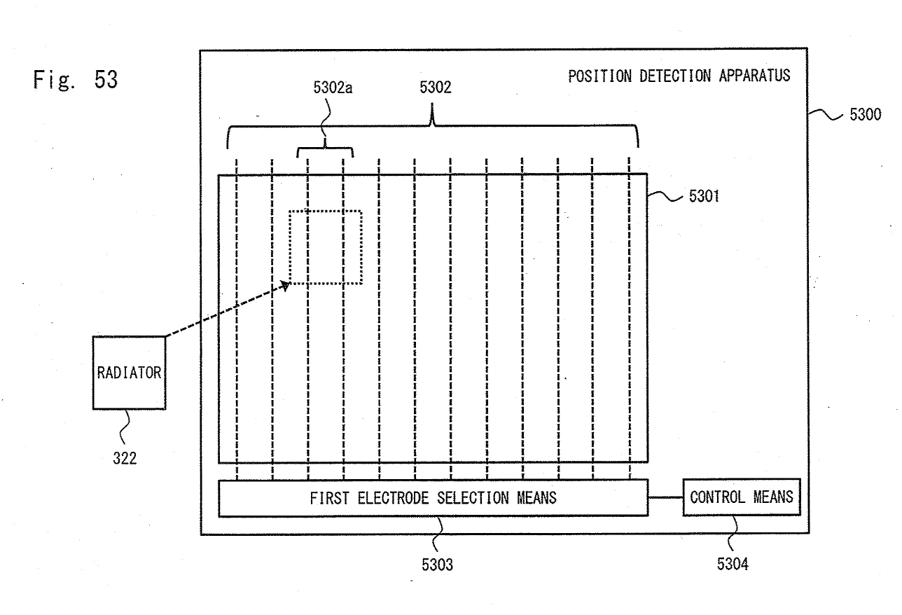

FIG. 53 is a block diagram showing a configuration of a position detection apparatus 5300 according to a fifteenth embodiment of the present invention. The position detection apparatus 5300 includes a display device 5301, multiple first electrodes 5302, first electrode selection means 5303, and control means 5304. When a radiator 322 radiating electromagnetic waves contacts or approaches the display device 5301, the position detection apparatus 5300 detects the position of the radiator 322′ on the display device 5301.

The first electrodes 5302 are disposed along a first direction on the display device 5301. While the first direction is the lateral direction (x-axis direction) in FIG. 53, it may be the longitudinal direction (y-axis direction) or other directions. The first electrode selection means 5303 provides signals having a predetermined frequency to the first electrodes 5302 and selects a group of first electrodes 5302a, which are some of the first electrodes 5302, on the basis of changes in the signals. For example, when each first electrode 5302 and the radiator 322 are forming a coil, the radiator 322 radiates electromagnetic waves on the basis of a high-frequency magnetic flux generated by driving each first electrode 5302 using a high-frequency signal. At this time, the first electrode selection means 5303 measures the signal for each first electrode 5302, calculates positions on the display device 5301 on the basis of the measurement results, and selects electrodes corresponding to the calculated positions, as the group of first electrodes 5302a. The control means 5304 detects the position on the display device 5301 that the electromagnetic wave radiator 322 has contacted or approached, on the basis of the positions of the group of first electrodes 5302a.

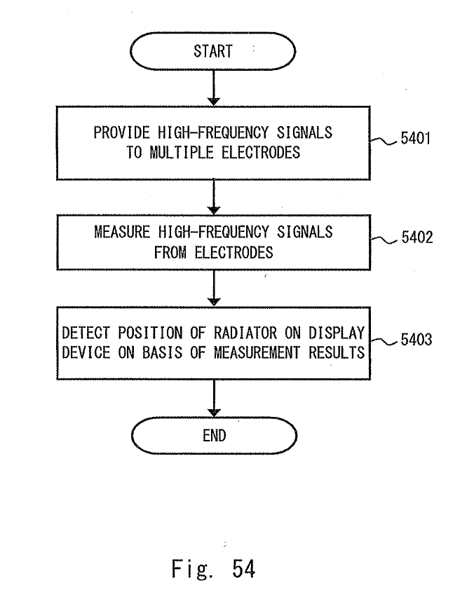

FIG. 54 is a flowchart showing the flow of a position detection process according to the fifteenth embodiment of the present invention. First, the first electrode selection means 5303 provides high-frequency signals to the first electrodes 5302 (step 5401). Next, the first electrode selection means 5303 measures the high-frequency signals from the electrodes (step 5402). The control means 5304 detects the position of the radiator 322 on the display device 5301 on the measurement results (step 5403).

Thus, when the user performs an easy operation on any position on the display device 5301, for example, the user brings the electromagnetic wave radiator 322 into contact with or close to such a position, it is possible to detect the position of the radiator 322 on the display device 5301. As a result, the position detection apparatus 5300 can detect the position which has been explicitly specified by the user with the easy operation.

### Sixteenth Embodiment of Invention

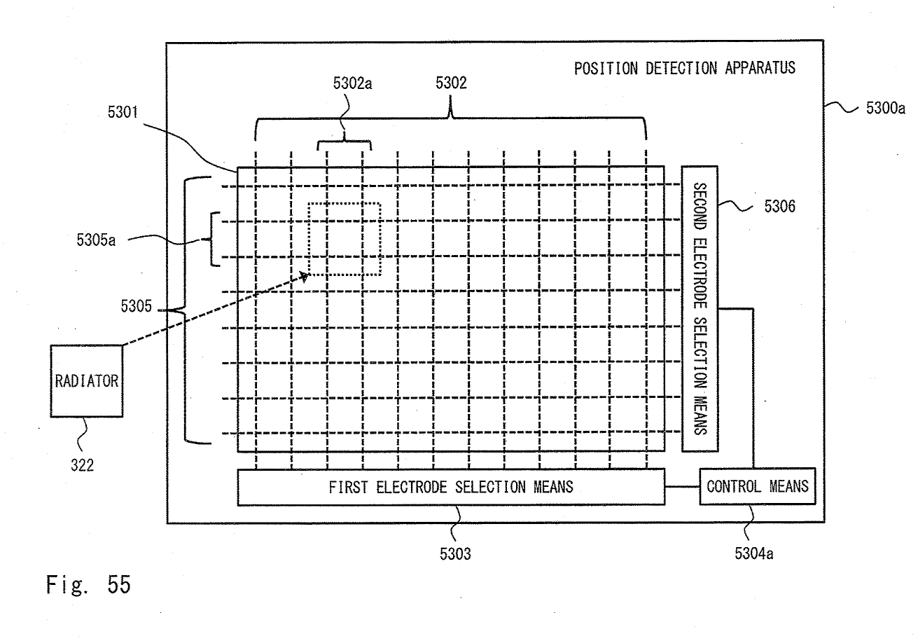

FIG. 55 is a block diagram showing a configuration of a position detection apparatus 5300a according to a sixteenth embodiment of the present invention. The position detection apparatus 5300a includes the configuration of the position detection apparatus 5300, as well as multiple second electrodes 5305 and second electrode selection means 5306.

The second electrodes 5305 are disposed along a second direction on the display device 5301. The second direction only has to be a direction different from the first direction. For example, when the first direction is the lateral direction (x-axis direction), the second direction is preferably the longitudinal direction (y-axis direction) or other directions. The second electrode selection means 5306 measures signals which occur on the second electrodes 5305 and selects a group of second electrodes 5305a, which are some of the second electrodes 5305, on the basis of changes in the signals. At this time, the second electrode selection means 5306 measures the signal for each second electrode 5305, calculates positions on the display device 5301 on the basis of the measurement results, and selects electrodes corresponding to the calculated positions, as the group of second electrodes 5305a. Based on the positions of the group of first electrodes 5302a and the positions of the group of second electrodes 5305a, the control means 5304a detects the position on the display device 5301 that the electromagnetic wave radiator 322 has contacted or approached.

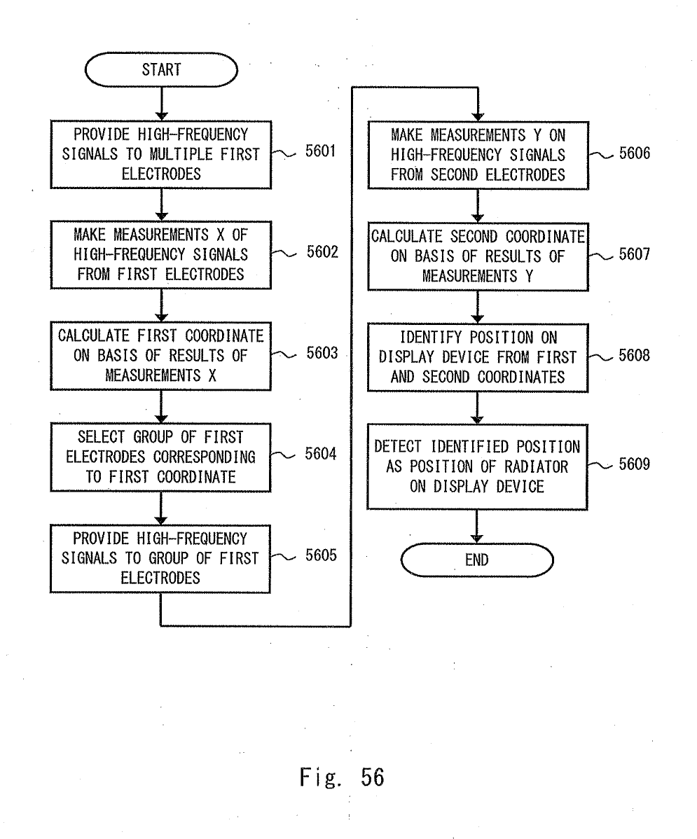

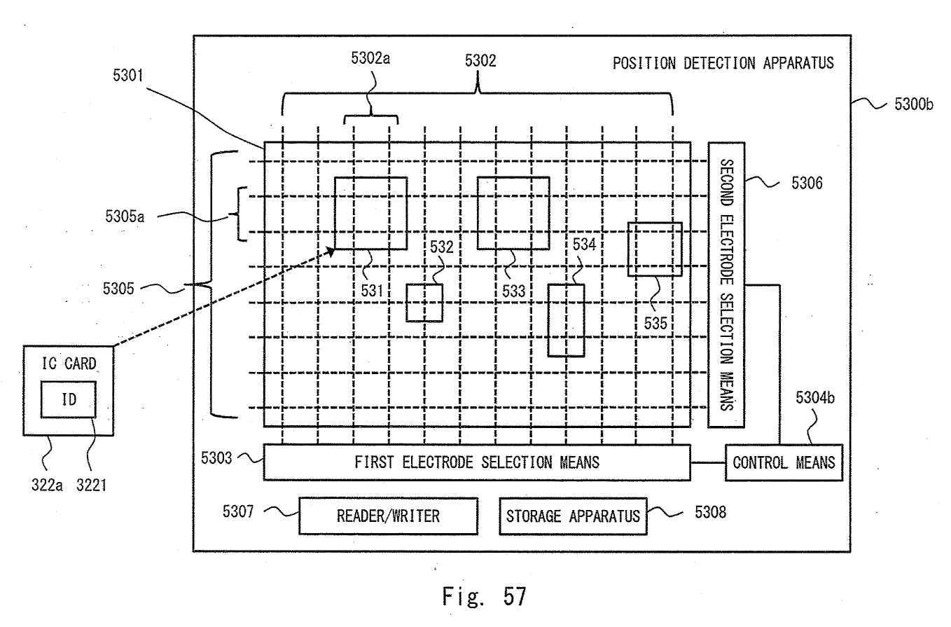

FIG. 56 is a flowchart showing the flow of a position detection process according to the sixteenth embodiment of the present invention. First, the first electrode selection means 5303 provides high-frequency signals to the first electrodes 5302 (step 5601). Next, the first electrode selection means 5303 performs measurements X of the high-frequency signals from the electrodes (step 5602). Based on the results of the measurements X, the first electrode selection means 5303 calculates a first coordinate (step 5603). As used herein, the first coordinate refers to a position which is uniquely determined in the first direction.

Next, the first electrode selection means 5303 selects the group of first electrodes 5302a corresponding to the first coordinate (step 5604). The first electrode selection means 5303 then provides high-frequency signals to the group of first electrodes 5302a (step 5605).

Next, the second electrode selection means 5306 performs measurements Y of the high-frequency signals from the second electrodes 5305 (step 5606). The second electrode selection means 5306 then calculates a second coordinate on the basis of the results of the measurements Y (step 5607). As used herein, the first coordinate refers to a position which is uniquely determined in the second direction. Next, based on the first and second coordinates, the control means 5304a identifies a position on the display device 5301 (step 5608). The control means 5304a then detects the identified position as the position of the radiator 322 on the display device 5301 (step 5609).

As seen above, in the sixteenth embodiment of the present invention, by detecting electromagnetic waves from the radiator 322 in each of the first and second directions, it is possible to more accurately identify the position on the display device 5301 that the radiator 322 has contacted or approached.

Preferably, the second electrode selection means 5306 selects the group of second electrodes 5305a using power provided by the first electrode selection means 5303. Thus, the amount of power consumption can be reduced compared to a case in which the second electrode selection means 5306 independently provides high-frequency signals to the second electrodes 5305. In the detection of the position that the radiator 322 has approached, for example, even if a radiator other than the radiator 322 approaches a first electrode 5302 other than the group of first electrodes 5302a, high-frequency signals are provided only to the group of first electrodes 5302a of the first electrodes 5302. Accordingly, the first coordinate corresponding to the second coordinate calculated by the second electrode selection means 5306 is always located around the group of first electrodes 5302a. As a result, erroneous detection can be prevented.

### Seventeenth Embodiment of Invention

FIG. 57 is a block diagram showing a configuration of a position detection apparatus 5300b according to a seventeenth embodiment of the present invention. When the user holds an IC card 322a around one of multiple images for selection displayed on the display device 5301, the position detection apparatus 5300b identifies an image displayed around the position around which the IC card is held. The position detection apparatus 5300b also acquires an ID 3221 stored in the IC card 322a and associates information corresponding to the identified image and the ID 3221 with each other. For example, in FIG. 57, when the IC card 322a contacts or approaches the display device 5301, an image 531 for selection is identified.

The position detection apparatus 5300b includes the configuration of the position detection apparatus 5300a, as well as a reader/writer 5307 and a storage apparatus 5308. The control means 5304b performs various types of control in the position detection process described above, as well as causes the display device 5301 to display multiple images 531 to 535 for selection. The sizes of the images 531 to 535 for selection do not need to be uniform. Note that the images 531 to 535 for selection are displayed at coordinates in the first direction (x axis) and in the second direction (y axis) on the display device 5301.

The reader/writer 5307 is acquisition means configured to control the first electrodes 5302 and the second electrodes 5305 via the first electrode selection means 5303 and the second electrode selection means 5306 and to acquire data from the IC card 322a. It is assumed that the ID 3221, which is identification information of the IC card 322a itself or identification information of the user possessing the IC card 322a, is stored in the IC card 322a in advance. The IC card 322a is an example of the electromagnetic wave radiator, and the electromagnetic wave radiator is not limited thereto.

The storage apparatus 5308 is a non-volatile storage apparatus, flash memory, or the like. The storage apparatus 5308 is storing the images 531 to 535 for selection, and the like. It is assumed that any information is associated with each of the images 531 to 535 for selection. Examples of the associated information include identification information which uniquely determines an article, data, or the like. In this case, it is assumed that the storage apparatus 5308 is storing information which defines the association between the images 531 to 535 for selection and the identification information.

The control means 5304a causes the reader/writer 5307 to acquire the ID 3221 of the IC card 322a from the position detected in the position detection process. The control means 5304a then associates the identified ID 3221 with information related to the image for selection displayed in the detected position and stores the associated information in the storage apparatus 5308.

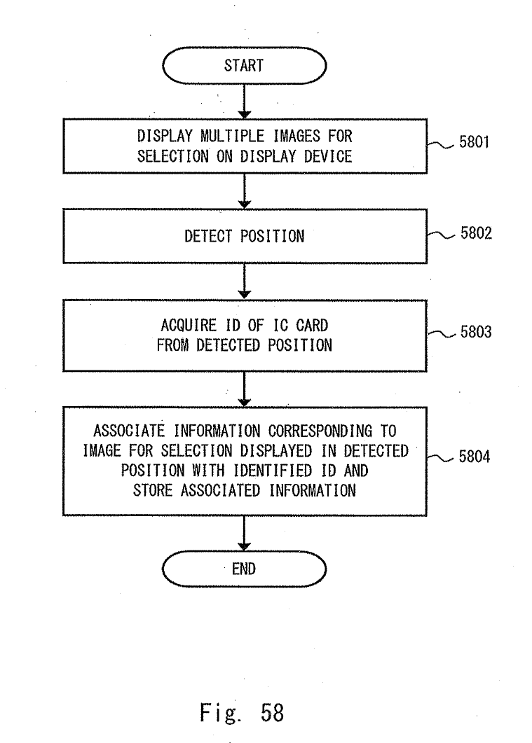

FIG. 58 is a flowchart showing the flow of a selected information association process according to the seventeenth embodiment of the present invention. First, the control means 5304b displays the images 531 to 535 for selection on the display device 5301 (step 5801). Next, the position detection apparatus 5300b performs a position detection process (step 5802). For example, the process of FIG. 54 or 56 may be performed.

The control means 5304a acquires the ID 3221 of the IC card 322a from the detected position using the reader/writer 5307 (step 5803). The control means 5304a then associates information corresponding to an image for selection displayed in the detected position with the acquired ID and stores the associated information in the storage apparatus 5308 (step 5804).

As seen above, in the seventeenth embodiment of the present invention, by performing the position detection process, as well as by reading the ID 3221 of the IC card 322a from the detected position using the function of the reader/writer 5307, the position selected by the user is associated with the information identifying the user. As a result, it is possible to reflect the intent selected by the user and further to apply the intent to various types of information processing. Further, in the seventeenth embodiment of the present invention, when the user holds the IC card 322a over one of displayed images for selection, it is possible to associate information related to the image for selection and the ID 3221 with each other. As a result, it is possible to reflect the intent selected by the user more accurately.

### Eighteenth Embodiment of Invention

A position detection apparatus according to an eighteenth embodiment of the present invention is an example of the first electrode selection means 5303 included in the position detection apparatus 5300, 5300a, or 5300b. That is, the first electrode selection means 5303 includes a shift register and transmission/reception circuits disposed at ends of the first electrodes. Each transmission/reception circuit includes a transmission amplifier circuit, means configured to change the polarity of a transmission signal on the basis of a signal from the shift register, and means configured to change the channel of a reception signal on the basis of a signal from the shift register. Similarly, the second electrode selection means 5306 may also have an equivalent configuration by disposing similar transmission/reception circuits at ends of the second electrodes.

An example configuration of the position detection apparatus 5300a or 5300b according to the eighteenth embodiment of the present invention is equivalent to what is obtained by eliminating the reader/writer 2811 from the display apparatus 2800 of FIG. 46. The internal configuration thereof is also equivalent to FIGS. 47, 48, and 49. The position detection apparatus 5300 is equivalent to what is obtained by eliminating the reader/writer 2811 from the display apparatus 2800 of FIG. 46 and then maintaining only one of the X-side and Y-side control apparatuses. A timing chart showing the operation of the first electrode selection means 5303 or the second electrode selection means 5306 according to the eighteenth of the present invention is equivalent to FIG. 50 described above. In other words, the display apparatus 2800 according to the thirteenth embodiment may be used as the position detection apparatus 5300, 5300a, or 5300b.

### Nineteenth Embodiment of Invention

A position detection apparatus according to a nineteenth embodiment of the present invention is an example of the position detection apparatus 5300, 5300a, or 5300b. That is, first electrodes are vertical electrodes which vertically cross a surface of a display device and are arranged horizontally at predetermined intervals. Second electrodes are horizontal electrodes which horizontally cross the surface of a display device and are arranged vertically at predetermined intervals. First electrode group selection means is an X-side control apparatus that provides high-frequency signals to the vertical electrodes and measures changes in the high-frequency signals. Second electrode group selection means is a Y-side control apparatus that measures high-frequency signals from the horizontal electrodes. The position detection apparatus according to the nineteenth embodiment of the present invention further includes a vertical electrode connecting line connected to the X-side control apparatus, a vertical electrode connecting switch connecting the vertical electrode connecting line and the vertical electrodes, a horizontal electrode connecting line connected to the Y-side control apparatus, a horizontal electrode connecting line switch connecting the horizontal electrode connecting line and the horizontal electrodes, an inter-vertical electrode switch connecting two vertical electrodes, and an inter-horizontal electrode switch connecting two horizontal electrodes.

An example configuration of the position detection apparatus 5300a or 5300b according to the nineteenth embodiment of the present invention is equivalent to FIG. 38 described above and is also equivalent to what is obtained by eliminating the reader/writer 2811 from the display apparatus 2800 of FIG. 28. The position detection apparatus 5300 is equivalent to what is obtained by eliminating the vertical electrodes 2803 or horizontal electrodes 2804 from FIG. 38 or 28. The display apparatus 2800 of FIG. 28 represents an example in which a one-loop coil is formed; FIG. 29 represents an example in which a multiple-loop coil is formed.

The position detection apparatus 5300 according to the nineteenth embodiment of the present invention is, for example, a position detection apparatus in which electrodes are disposed only in the x-axis direction. In this case, a position detection process can be formed, for example, by steps 3001 to 3005 of FIG. 30A. If at most one image for selection is displayed on each electrode and if only one IC card is held over (for example, FIG. 33B), a selected image can be uniquely identified.

If the reader/writer 5307 and the storage apparatus 5308 are included, the position detection process may further include steps equivalent to steps 3011 and 3012 of FIG. 30A. In this case, there is obtained an example distribution of measurement results of power as shown in FIG. 34. If the electrodes are disposed only in the y-axis direction, there is obtained an example distribution of measurement results of power as shown in FIG. 35.

Even when multiple IC card are simultaneously held over, it is possible to properly detect the selection positions of the IC cards if a single IC card is held over a single electrode (for example, FIG. 31B). In this case, the position detection process can be formed, for example, by steps 3001 to 3005a of FIG. 31A. In this case, there is obtained an example distribution of measurement results of power as shown in FIG. 36 or 37. For example, if x coordinates are only detected, it is possible to detect the selection positions of the IC cards even if the y coordinates are unknown.

However, if two or more images for selection are displayed on a single electrode (for example, FIG. 32C), it may not be possible to accurately detect the two or more selection positions by simply scanning the electrodes disposed in a single direction. For this reason, by disposing electrodes in two directions as in the position detection apparatus 5300a or 5300b and scanning both electrodes, it is possible to uniquely and accurately detect the selection positions on the two-dimensional display device 5301. The position detection process can be formed, for example, by FIGS. 32A and 32B. The position detection process for multiple selection positions which typically differ in x and y coordinates as shown in FIG. 31B can be formed by FIG. 31A.

Multiple images for selection may be associated with layered information. When the position on the display device that the radiator has contacted or approached is detected, the control means 5304b preferably displays, on the display device, an image for selection corresponding to information in a layer different from information corresponding to an image for selection displayed on the detected position, in place of the displayed image for selection.

### Twentieth Embodiment of Invention

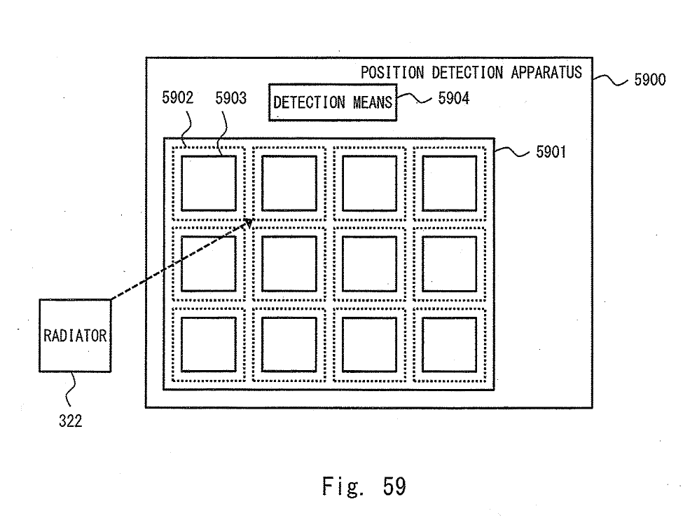

FIG. 59 is a block diagram showing a configuration of a position detection apparatus 5900 according to a twentieth embodiment of the present invention. The position detection apparatus 5900 includes a display device 5901, multiple electromagnetic wave processing means 5903, and detection means 5904. Multiple regions 5902 are defined on the display device 5901. The electromagnetic wave processing means 5903 are disposed on the display device 5901 and correspond to the regions 5902, respectively. The detection means 5904 detects the selection position on the display device 5901 that electromagnetic wave radiator 322 has contacted or approached.

Each electromagnetic wave processing means 5903 emits electromagnetic waves outward and receives electromagnetic waves which are emitted by the radiator 322 in response to the electromagnetic waves. Preferably, the electromagnetic wave processing means 5903 are, for example, ultrasonic actuator-sensor arrays, RFID readers/writers, or electrodes. The detection means 5904 identifies electromagnetic wave processing means 5903 that has received electromagnetic waves from the radiator 322 and detects, as the selected position, a region 5902 corresponding to the identified electromagnetic wave processing means 5903. Thus, the position detection apparatus 5900 can detect the region specified by the user.

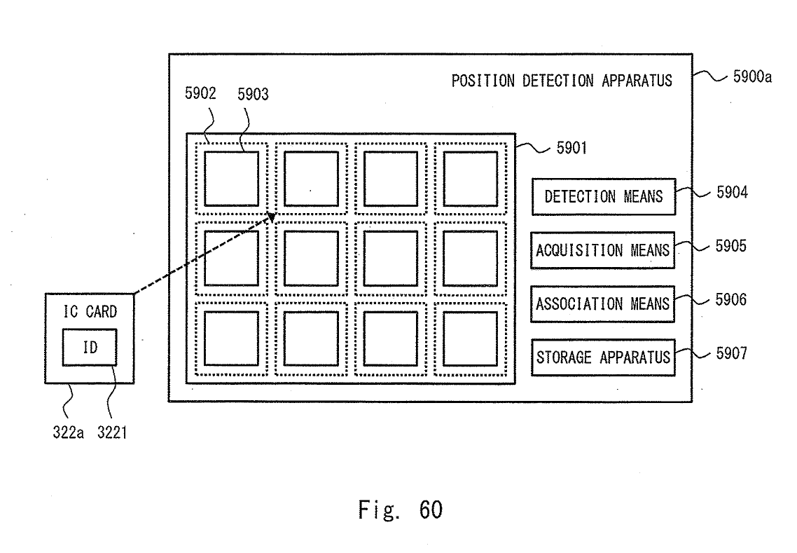

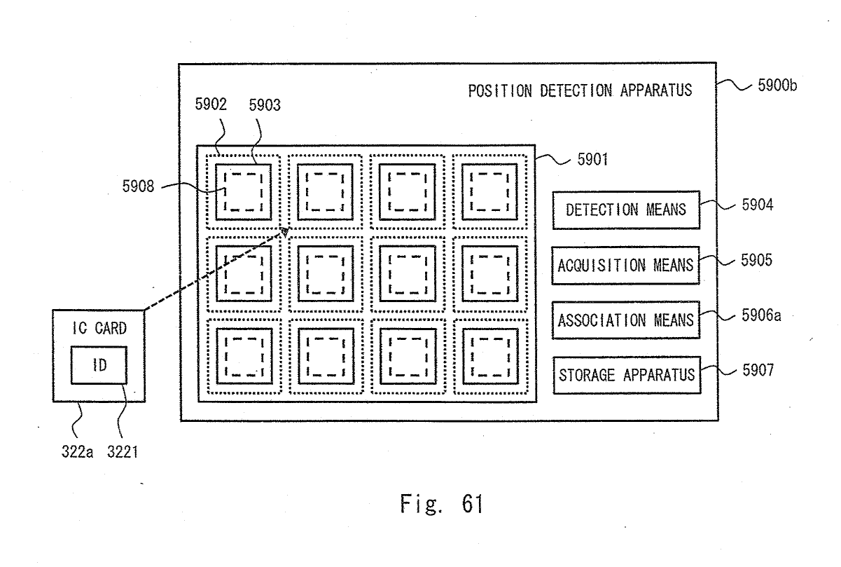

FIG. 60 is a block diagram showing a configuration of a position detection apparatus 5900a obtained by making improvements to the position detection apparatus 5900 according to the twentieth embodiment of the present invention. The position detection apparatus 5900a includes the configuration of the position detection apparatus 5900, as well as acquisition means 5905, association means 5906, and storage apparatus 5907. The IC card 322a is one example of the radiator 322 and is storing the ID 3221, which is identification information of the IC card 322a or the like. The acquisition means 5905 acquires the ID 3221 from the IC card 322a via the identified electromagnetic wave processing means 5903. In this case, each electromagnetic wave processing means 5903 serves as an RFID reader/writer. If the radiator 322 is in another form, each electromagnetic wave processing means 5903 may also be in a form other than a RFID reader/writer. The storage apparatus 5907 is a non-volatile storage apparatus, flash memory, or the like. The association means 5906 associates the identified ID 3221 with the region 5902 corresponding to the identified electromagnetic wave processing means 5903 and stores the associated information in the storage apparatus 5907.

As seen above, the position detection apparatus 5900a shown in FIG. 60 performs the position detection process, as well as reads the ID 3221 of the IC card 322a from the detected position by using the function of the electromagnetic wave processing means 5903 and associates the position selected by the user with the information identifying the user. As a result, it is possible to reflect the intent selected by the user and further to apply the intent to various types of information processing.

FIG. 61 is a block diagram showing a configuration of a position detection apparatus 5900b obtained by making improvements to the position detection apparatus 5900a according to the twentieth embodiment of the present invention. In the position detection apparatus 5900b, the association means 5906 of the position detection apparatus 5900a is replaced with association means 5906a. An image 5908 for selection is displayed in each region 5902 on the display device 5901. The association means 5906a identifies an image 5908 for selection displayed in a region 5902 corresponding to identified electromagnetic wave processing means 5903, associates information related to the identified image 5908 for selection with an acquired ID 3221, and stores the associated information in the storage apparatus 5907.

As seen above, when the user holds the IC card 322a over one of displayed images for selection, the position detection apparatus 5900b can associate information related to the image for selection with the ID 3221. As a result, it is possible to reflect the intent selected by the user more accurately.

### Twenty-first Embodiment of Invention

A position detection apparatus 5900c according to the twenty-first embodiment of the present invention is divided into multiple regions. Multiple images for selection are displayed in the regions of the position detection apparatus 5900c. Further, multiple electromagnetic wave processing means configured to detect an operation performed by a user are disposed in the regions. For this reason, when the respective electromagnetic wave processing means detect an operation performed by a user, it is possible to identify electromagnetic wave processing means which is closest to the user. From the region to which the identified electromagnetic wave processing means belongs, it is possible to identify the position selected by the user on the display device.

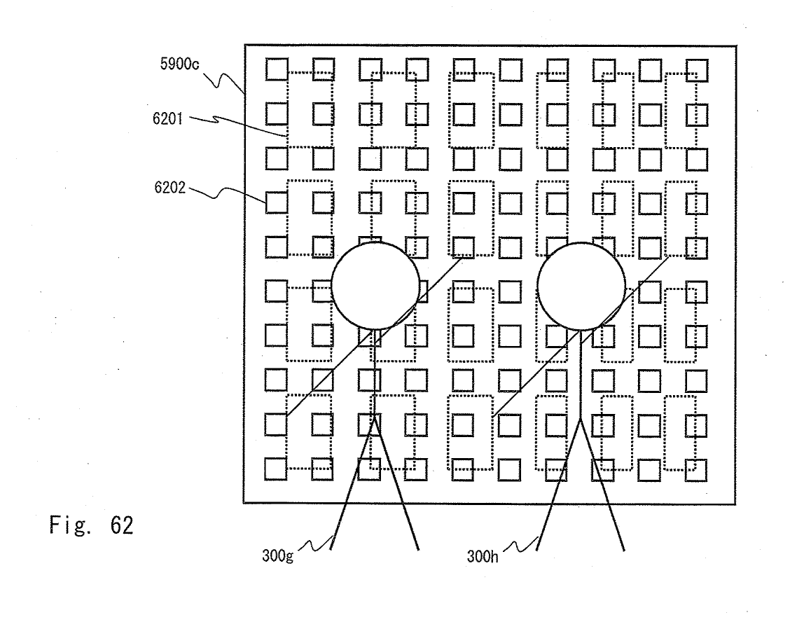

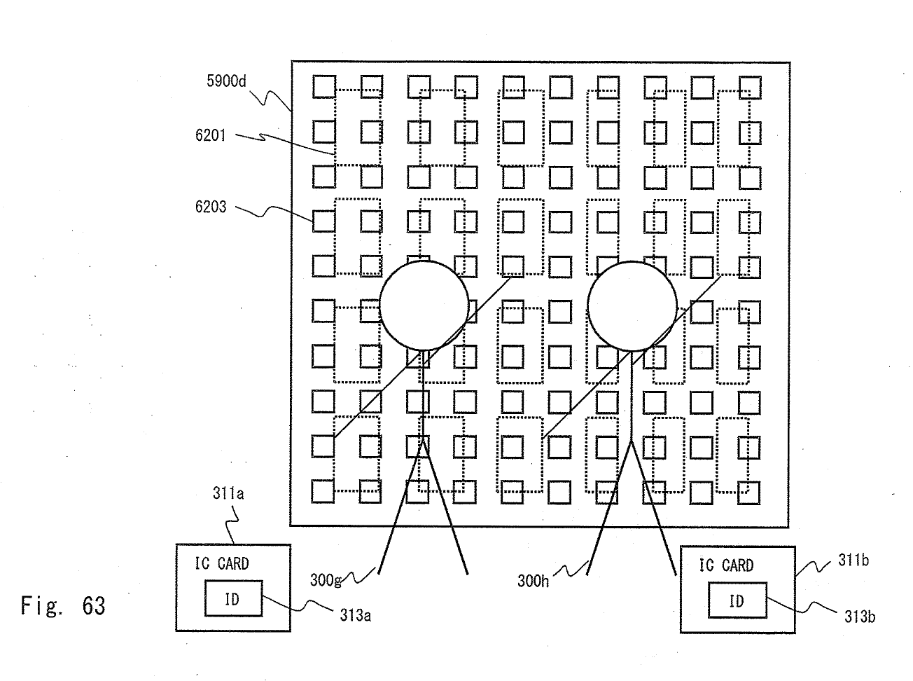

FIG. 62 is a block diagram showing a configuration of the position detection apparatus 5900c according to the twenty-first embodiment of the present invention. The position detection apparatus 5900c displays multiple images 6201 for selection. In this case, the images 6201 for selection correspond to the regions described above. Disposed in the regions of the position detection apparatus 5900c are multiple ultrasonic actuator-sensor arrays 6202. The ultrasonic actuator-sensor arrays 6202 are an example of the electromagnetic wave processing means. Accordingly, each ultrasonic actuator-sensor array 6202 can be said to be disposed around one of the images 6201 for selection. Now assume that since the images 6201 for selection have different sizes, the sizes of the regions are changed as necessary. Also assume that the users 300g and 300h view the images 6201 for selection on the same position detection apparatus 5900c and make selection.

FIG. 62 shows an example of disposition in which the ultrasonic actuator-sensor arrays 6202 are disposed on the position detection apparatus 5900c in a matrix. However, the disposition is not limited thereto. Any disposition may be used as long as the following are met: multiple electromagnetic wave processing means are disposed on the position detection apparatus 5900c; and the selected position is identified from the position of electromagnetic wave processing means which has received selection from a user. Each ultrasonic actuator-sensor array 6202 has both an ultrasound emitting function (an electromagnetic wave emitting function) and an ultrasound detection function (an electromagnetic wave receiving function). Ultrasound emitted from the position detection apparatus 5900c is reflected by the bodies of the users 300g and 300h and returns to around the position detection apparatus 5900c. Each ultrasonic actuator-sensor array 6202 detects the returning ultrasound using an ultrasonic sensor. Further, from the time when ultrasound is emitted and the time when the ultrasound returns, the ultrasonic actuator sensor arrays 6202 can determine the distance between the user acting as a reflector and themselves. By arranging these ultrasonic actuator sensor arrays on the display apparatus in a matrix, a hand gesture or body gesture made by a user is detected.

For example, when the user makes a hand gesture which forms a circle in space, one sensor makes a reaction and then an adjacent sensor makes a reaction. From a chain of reactions made by the sensors, it is possible to obtain the vector quantity of the hand gesture. By combining the vector quantity with the distance information, it is possible to read the hand gesture made by the user from these sensor signals.

By operating the sensors in parallel, it is possible to extract gestures of both hands separately or extract a gesture of adjacent another user. Since the users can operate the large position detection apparatus 5900c at a distance therefrom, they can see over many images and select images with a wide sight. Further, since the users can operate images for selection without having to touch the position detection apparatus 5900c, this detection method is more preferable in terms of sanitation than a method using a touchscreen or the like. There is also obtained an effect of reducing the frequency at which the apparatus is shocked or damaged.

Since what is needed here is to extract changes in the body position of the user, the following configuration is also possible: only sensors for detecting ultrasound are disposed on the display apparatus in a matrix; and ultrasonic actuators for emitting ultrasound are collectively disposed in any one position.

### Twenty-second Embodiment of Invention

Preferably, the position detection apparatus 5900c includes multiple acquisition means configured to acquire user identification information. That is, multiple acquisition means according to the twenty-second embodiment of the present invention are preferably disposed around the regions, respectively. When a user selects an image for selection displayed around one of the regions of the position detection apparatus 5900c, acquisition means disposed around that region acquires user identification information from the user and associates the acquired user identification information with information corresponding to the selected image for selection.

FIG. 63 is a block diagram showing a configuration of a position detection apparatus 5900d according to the twenty-second embodiment of the present invention. In comparison with the position detection apparatus 5900c, the position detection apparatus 5900d is provided with multiple RFID readers/writers 6203 in place of the ultrasonic actuator-sensor arrays 6202. The RFID readers/writers 6203 are IC card readers and are an example of the electromagnetic wave processing means and the acquisition means according to the twenty-second embodiment of the present invention. Now assume that the user 300g possesses the IC card 311a storing the user ID 313a and that the user 300h possesses the IC card 311b storing the user ID 313b.

FIG. 63 shows an example of disposition in which the RFID readers/writers 6203 are disposed on the position detection apparatus 5900d in a matrix. However, the disposition is not limited thereto. Any disposition may be used as long as the following are met: at least multiple electromagnetic wave processing means and multiple acquisition means are disposed on the position detection apparatus 5900d; a selected image is identified from the positions of electromagnetic wave processing means and acquisition means which have acquired user identification information from a user; and image identification information and the user identification information are associated with each other. Accordingly, each RFID reader/writer 6203 can be said to function as electromagnetic wave processing means and acquisition means. The multiple electromagnetic wave processing means and multiple acquisition means are disposed on the position detection apparatus 5900d at predetermined intervals.

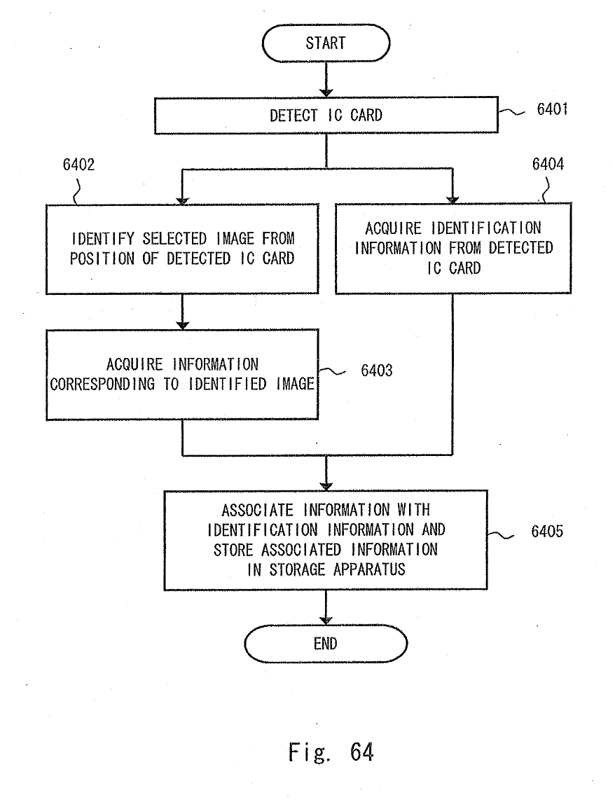

FIG. 64 is a flowchart showing the flow of a selection receiving process according to the twenty-second embodiment of the present invention. First, the user 300g touches the desired image 6201 for selection on the position detection apparatus 5900d with the IC card 311a on hand. At this time, an RFID reader/writer 6203 disposed closest to the image 6201 for selection detects the IC card 311a (step 6401).

Next, the RFID reader/writer 6203 identifies the selected image for selection from the position of the detected IC card 311a (step 6402). That is, the RFID reader/writer 6203, which has detected the IC card 311a, determines that an image for selection disposed closest to the RFID reader/writer 6203 is the selected image for selection, on the basis of the coordinate position of the RFID reader/writer 6203. The RFID reader/writer 6203 then acquires image identification information corresponding to the identified image for selection (step 6403). At this time, the RFID reader/writer 6203 may write, to the IC card 311a, the image identification information or the like of the image 6201 for selection selected by the user 300g.

After step 6401, the RFID reader/writer 6203 acquires the user ID 313a from the detected IC card 311a in parallel with steps 6402 and 6403 (step 6404). After steps 6403, the reader/writer 6203 associates the image identification information with the user identification information and stores the associated information in the storage apparatus (step 6405).

In FIG. 63, the RFID readers/writers 6203 are arranged in an array. Thus, when the user holds the IC card 311a over a certain RFID reader/writer 6203, it is possible to determine which of the images for selection on the position detection apparatus 5900d has been selected, from the position of the excited RFID reader/writer 6203. Since the arrayed RFID readers/writers 6203 are operated in, parallel, adjacent another user, 300h, can select a commodity in parallel. As a result, it is possible to increase the per-unit time processing capacity of the user. There is also obtained an advantage that the user can perform, with one motion, two operations: selection of a commodity; and sending of user identification information.

### Twenty-Third Embodiment of Invention

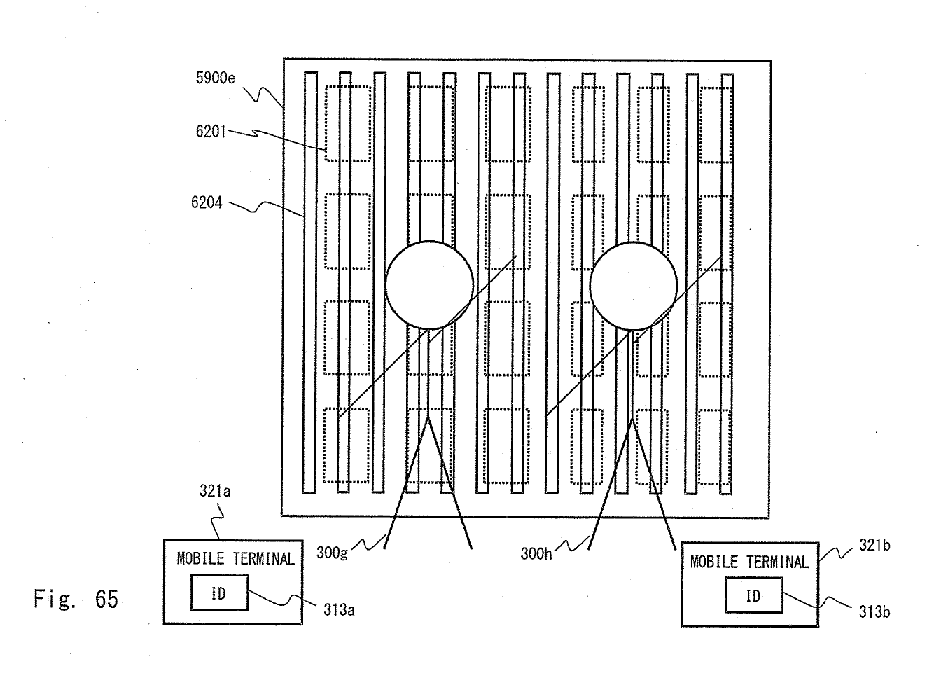

FIG. 65 is a block diagram showing a configuration of a position detection apparatus 5900e according to a twenty-third embodiment of the present invention. In comparison with the position detection apparatus 5900d, the position detection apparatus 5900e is provided with multiple electrodes 6204 in place of the readers/writers 6203. The electrodes 6204 are body area network readers and are an example of electromagnetic wave processing means and acquisition means according to the twenty-third embodiment of the present invention. Now assume that the user 300g holds the mobile terminal 321a storing the user ID 313a and that the user 300h holds the mobile terminal 321b storing the user ID 313b.

There have been developed body area networks in recent years, in which communication is performed by passing a weak current signal through a human body serving as a communication channel. For this reason, instead of the RFID reader/writers 6203, a body area network terminal carried by the user performs communication with the display device while using the human body as a communication channel.

In an example of FIG. 65, the electrodes 6204 for body area network are arranged on the position detection apparatus 5900e longitudinally (vertically) in stripes (in strip form). Thus, when the users 300g and 300h simultaneously select different images for selection and when the selected images for selection are displayed at the same height and in different columns, it is possible to distinguish these selection operations from each other and to process them in parallel. Note that the electrodes 6204 may be arranged laterally. In this case, when the users 300g and 300h simultaneously select different images for selection and when the selected images for selection are displayed in the same column and at different heights, the position detection apparatus functions similarly.

The mobile terminals 321a and 321b are, for example, watch-type body area network terminals. For example, when the user 300g touches any electrode 6204 with his or her fingertip or the like, a weak current flows from the electrode 6204 toward the fingertip (or vice versa) and then flows into the mobile terminal 321a worn by the user 300g.

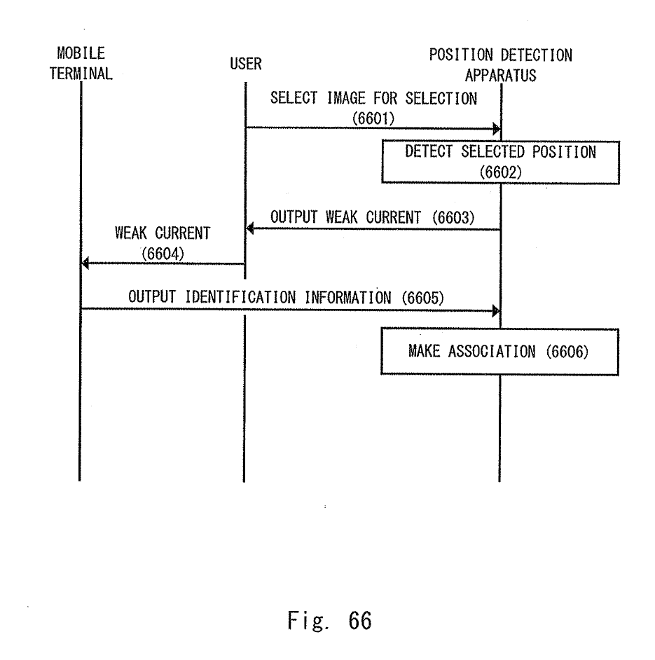

FIG. 66 is a sequence diagram showing the flow of a selection receiving process according to the twenty-third embodiment of the present invention. First, the user 300g selects an image 6201 for selection on the position detection apparatus 5900e (step 6601). Next, an electrode 6204 detects the user 300g (step 6602). The electrode 6204 then outputs a signal for acquiring the user ID 313a to the user 300g in the form of a weak current (step 6603). Next, the weak current flows into the mobile terminal 321a possessed by the user 300g (step 6604). The mobile terminal 321a reads the user ID 313a in response to the weak current and outputs it to the electrode 6204 (step 6605). Subsequently, the position detection apparatus 5900e associates the user ID 313a with image identification information (step 6606).

By forming the electrodes 6204 for body area network in stripes as shown in FIG. 65 and then processing signals from the electrodes 6204 separately, it is possible to, even when multiple users simultaneously touch the screen, extract multiple pieces of user identification information without intermingling the pieces of information. Transmission/reception circuits for body area network are disposed for the electrodes around the upper edge or lower edge of the position detection apparatus 5900e and exchange body area network signals with each other. For example, if four images 6201 for selection are arranged longitudinally as shown in FIG. 65, the electrode 6204 running from top to bottom has the four images as candidates. For example, the position detection apparatus 5900e may select an image from among these candidates using another means.

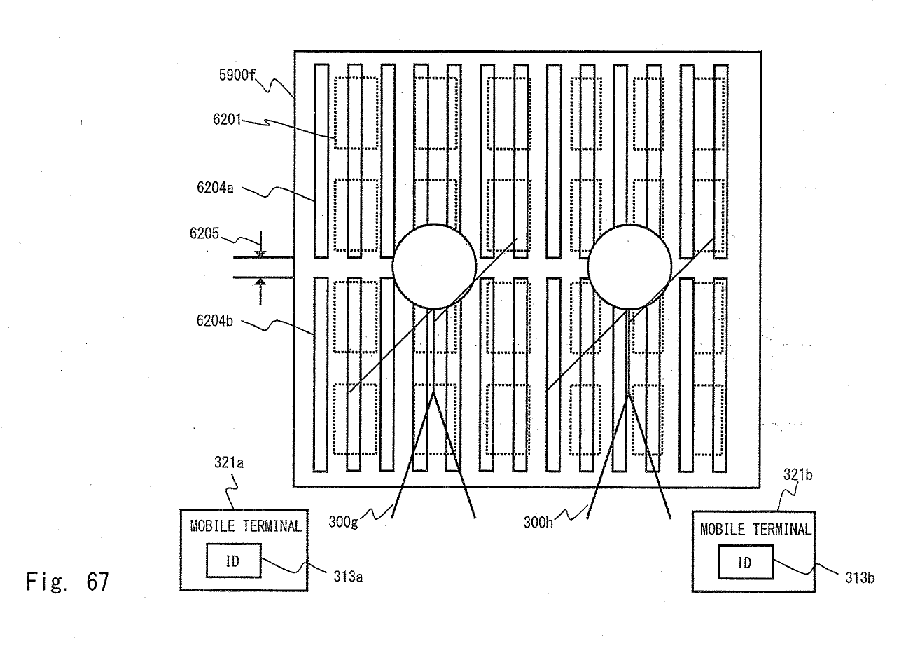

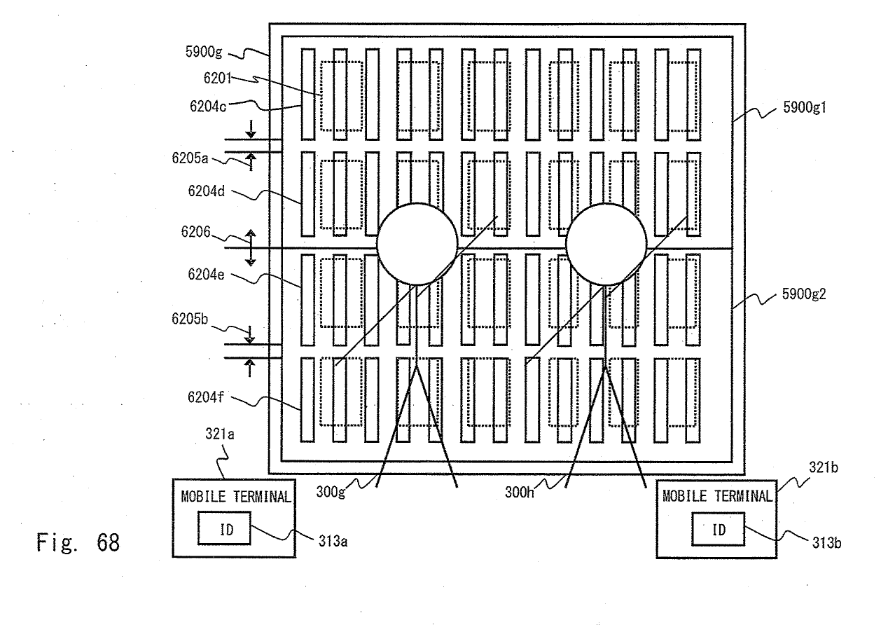

FIG. 67 is a block diagram showing a configuration of a position detection apparatus 5900f according to the twenty-third embodiment of the present invention. In FIG. 67, electrodes formed longitudinally in stripes are separated by an electrode spacing 6205. Body area network transmission/reception circuits for upper electrodes 6204a are disposed around the upper edge of the position detection apparatus 5900f; body area network transmission/reception circuits for lower electrodes 6204b are disposed around the lower edge thereof. Thus, the upper electrodes and the lower electrodes can be handled separately. As a result, for example, when the front of the position detection apparatus is crowded with users, it is possible to reduce the probability that multiple users will touch the same electrode and thus cause conflict between user identification information.

FIG. 68 is a block diagram showing a configuration of a position detection apparatus 5900g according to the twenty-third embodiment of the present invention. In the configuration of FIG. 68, the position detection apparatus 5900g has display regions 211e1 and 211e2, which are two displays partitioned by a boundary 717 of a display, which is an example of a display device. Electrodes are vertically separated by the boundary 717. Further, the electrodes located in the upper display, the display region 211e1, are separated by an electrode spacing 6205a; the electrodes located in the lower display, the display region 211e2, are separated by an electrode spacing 6205b. That is, each electrode is longitudinally divided into four electrodes: 6204c, 6204d, 6204e, and 6204f. Similarly, each electrode may be longitudinally divided into eight or sixteen electrodes. Any of the electrodes thus divided does not extend over multiple images for selection. As a result, it is possible to further reduce conflict between user identification information.

The electrodes for body area network shown in FIGS. 65, 66, and 67 may be used as electrodes for RFID reader/writer.

### Other Embodiments of Invention

The steps or process flows described in the first to twenty-third embodiments of the present invention may be performed by causing a typical sequential circuit, programmable sequential circuit, or computer such as a microprocessor to execute a control program. Specifically, it is only necessary to cause a computer disposed in a store or cloud computing to execute the control program. The control program may be stored in various types of non-transitory computer-readable media and then provided to the computer. Among the non-transitory computer-readable media are various types of tangible storage media. Examples of the non-transitory computer-readable media include magnetic recording media (e.g., flexible disks, magnetic tapes, hard disk drives), magneto-optical storage media (e.g., magneto-optical disks), compact disc read-only memories (CD-ROMs), compact disc recordables (CD-Rs), compact disc-rewritables (CD-RW), digital versatile discs (DVDs), ROM cartridges, battery-backed-up RAM memory cartridges, semiconductor memories (e.g., mask ROMs, programmable ROMs (PROMs), erasable PROMs (EPROMs), flash ROMs, and random access memories (RAMs). Alternatively, the program may be provided to a computer via various types of transitory computer-readable media. Examples of the transitory computer-readable media include electric signals, optical signals, and electromagnetic waves. These transitory computer-readable media can provide the program to a computer via a wired communication channel, such as an electric line or an optical fiber, or a wireless communication channel, such as a microwave link. The program may be provided via the Internet.

Of course, the present invention is not limited to the above embodiments, and various changes can be made thereto without departing from the spirit and scope of the invention described above.

Some or all of the embodiments can be described as in Supplementary Notes below, but the embodiments are not limited thereto.

(Supplementary Note 1) A store system comprising:

a front yard comprising:
a display unit that displays a plurality of commodity images;
a receiving unit that receives selection of a commodity desired by the purchaser from among commodities corresponding to the displayed commodity images;
an association instruction unit that acquires purchaser identification information identifying the purchaser and makes an instruction to associate commodity identification information identifying the selected commodity and the acquired purchaser identification information with each other; and
a handover unit that hands over the selected desired commodity to the purchaser; and

a backyard adjacent to the front yard, the backyard comprising:
a commodity storage unit that stores the commodities corresponding to the commodity images; and
a sending unit that takes out the selected commodity from the commodity storage unit on the basis of the associated commodity identification information and purchaser identification information and sends the taken-out commodity as the commodity desired by the purchaser to the handover unit.

(Supplementary Note 2) The store system according to Supplementary Note 1, wherein

the receiving unit receives selection of two or more commodities from the purchaser,

the association instruction unit makes an instruction to associate pieces of commodity identification information of the selected commodities and the acquired purchaser identification information with each other, and

the sending unit takes out all the selected commodities from the commodity storage unit on the basis of the associated pieces of commodity identification information of the commodities and purchaser identification information and sends all the taken-out commodities collectively to the handover unit.

(Supplementary Note 3) The store system according to Supplementary Note 2, further comprising a storage unit that stores commodity selection information obtained by associating the commodity identification information and the purchaser identification information with each other one-on-one and sending information which is a list of pieces of commodity identification information of the selected two or more commodities corresponding to each of purchaser identification information, wherein

each time the purchaser selects a commodity, the association instruction unit makes an instruction to associate commodity selection information of the selected commodity and the acquired purchaser identification information with each other and stores the associated information as commodity selection information in the storage unit, and

the sending unit reads pieces of commodity selection information from the storage unit, organizes pieces of commodity identification information corresponding to the purchaser identification information, stores the organized information as sending information in the storage unit, and takes out all commodities selected by the purchaser from the commodity storage unit on the basis of the sending information.

(Supplementary Note 4) The store system according to Supplementary Note 3, wherein each, time the commodity selection information is stored in the storage unit, the sending unit reads the commodity selection information, updates the sending information, and, each time the sending information is updated, takes out the selected commodity from the commodity storage unit on the basis of the updated sending information.

(Supplementary Note 5) The store system according to any one of Supplementary Notes 1 to 4, wherein the sending unit holds the purchased commodity taken out of the commodity storage unit for each purchaser and, when the handover unit receives input of the purchaser identification information, sends a purchased commodity corresponding to the inputted purchaser identification information of the held purchased commodities to the handover unit.

(Supplementary Note 6) The store system according to any one of Supplementary Notes 1 to 5, wherein the front yard further comprises refund unit, wherein

after the purchaser makes payment for the desired commodity and the handover unit hands over the desired commodity, the refund unit receives the desired commodity and, if no abnormality is found when the received commodity is checked, makes a refund for the commodity to the purchaser.

(Supplementary Note 7) The store system according to Supplementary Note 6, wherein the sending unit again stores, in the commodity storage unit, a commodity in which no abnormality has been found in the check.

(Supplementary Note 8) The store system according to any one of Supplementary Notes 1 to 7, wherein the receiving unit receives, from the purchaser, a request to output related information related to the commodities corresponding to the displayed commodity images and makes an instruction to output the related information.

(Supplementary Note 9) The store system according to any one of Supplementary Notes 1 to 8, wherein the receiving unit receives selection from a plurality of purchasers in parallel.

(Supplementary Note 10) The store system according to any one of Supplementary Notes 1 to 9, wherein the display unit selectively displays the commodity images by commodity type.

(Supplementary Note 11) The store system according to any one of Supplementary Notes 1 to 10, wherein the commodity images displayed by the display unit are images obtained by imaging the commodities when the commodities arrive.

(Supplementary Note 12) The store system according to any one of Supplementary Notes 1 to 11, wherein when commodities corresponding to the commodity images displayed on the display unit are commodities which are required to be sold by a high-level specialist, the receiving unit causes the display unit to display an image of the high-level specialist together with the commodity images and mediates communication of information related to the commodities between the high-level specialist and the purchaser.

(Supplementary Note 13) The store system according to Supplementary Note 8, wherein when the receiving unit receives, from the purchaser, a request to display a detailed image of the commodity as a request to output the related information while a typical image of the commodity is displayed as the commodity image on the display unit, the receiving unit causes the display unit to display the detailed image in place of the typical image.

(Supplementary Note 14) The store system according to Supplementary Note 8 or 13, wherein the receiving unit makes an instruction to output, as the related information, a physical quantity which stimulates the sense of sight, hearing, smell, taste, or touch related to the commodities.

(Supplementary Note 15) The store system according to any one of Supplementary Notes 8, 13, 14, wherein the receiving unit converts a motion made by the purchaser into a predetermined vector quantity and causes the display unit to output the related information in accordance with the resulting vector quantity.

(Supplementary Note 16) The store system according to any one of Supplementary Notes 1 to 15, wherein

the display unit is divided into a plurality of regions,

the association instruction unit comprises a plurality of association instruction unit, and the plurality of association instruction unit are disposed in the regions, respectively, and

when the purchaser selects a commodity image displayed in one of the regions of the display unit, the association instruction unit disposed in one of the regions acquires the purchaser identification information from the purchaser and makes an instruction to associate the acquired purchaser identification information and commodity identification information of a commodity corresponding to the selected commodity image with each other.

(Supplementary Note 17) The store system according to any one of Supplementary Notes 1 to 16, wherein

the receiving unit and the association instruction unit comprise a plurality of receiving units and a plurality of association instruction units, respectively, and

the plurality of receiving units and the plurality of association instruction units are disposed on the display unit at predetermined intervals.

(Supplementary Note 18) The store system according to Supplementary Note 16 or 17, wherein the association instruction unit is an IC card reader.

(Supplementary Note 19) The store system according to Supplementary Note 16 or 17, wherein the association instruction unit is a reader for body area network.

(Supplementary Note 20) The store system according to any one of Supplementary Notes 1 to 19, wherein the association instruction unit identifies the purchaser identification information on the basis of a result of image recognition of an image obtained by imaging the purchaser.

(Supplementary Note 21) The store system according to any one of Supplementary Notes 1 to 20, wherein the front yard further comprises a detection unit configured to detect one of a position and a motion of the purchaser, and when the detection unit detects that the purchaser has not operated the front yard for a predetermined period of time or more, the display unit displays purchaser support information for supporting purchase of the purchaser.

(Supplementary Note 22) A method for controlling a store system, the store system including a front yard that receives, from a purchaser, selection of a commodity and hands over the selected, desired commodity to the purchaser and a backyard adjacent to the front yard, the backyard including a commodity storage unit that stores a plurality of commodities, the method comprising:

displaying a plurality of commodity images on a display apparatus included in the front yard;

in the front yard, receiving selection of a commodity desired by the purchaser from among commodities corresponding to the displayed commodity images;

in the front yard, acquiring purchaser identification information identifying the purchaser;

in the front yard, associating commodity identification information identifying the selected commodity and the acquired purchaser identification information with each other;

in the backyard, taking out the selected commodity from the commodity storage unit on the basis of the associated commodity identification information and purchaser identification information; and

in the backyard, sending the taken-out commodity as the commodity desired by the purchaser to the front yard.

(Supplementary Note 23) A non-transitory computer-readable medium storing a control program for causing a computer to perform a process of controlling a store system, the store system including a front yard that receives, from a purchaser, selection of a commodity and hands over the selected, desired commodity to the purchaser and a backyard adjacent to the front yard, the backyard including a commodity storage unit that stores a plurality of commodities, the process comprising the steps:

displaying a plurality of commodity images on a display apparatus included in the front yard;

in the front yard, receiving selection of a commodity desired by the purchaser from among commodities corresponding to the displayed commodity images;

in the front yard, acquiring purchaser identification information identifying the purchaser;

in the front yard, associating commodity identification information identifying the selected commodity and the acquired purchaser identification information with each other;

in the backyard, taking out the selected commodity from the commodity storage unit on the basis of the associated commodity identification information and purchaser identification information; and

in the backyard, sending the taken-out commodity as the commodity desired by the purchaser to the front yard.

(Supplementary Note 24)

The store system according to any one of Supplementary Notes 1 to 21, further comprising a delivery means that delivers the desired commodity to the purchaser using transportation means, wherein

the front yard receives, from the purchaser, selection as to whether to deliver the desired commodity, and

when the front yard receives selection indicating that the desired commodity is to be delivered, the sending means sends the taken-out commodity to the delivery means.

(Supplementary Note 25)

The store system according to any one of Supplementary Notes 1 to 21 and 24, wherein

the display means displays the commodity images on a display device, and

the receiving means comprises:
a plurality of first electrodes disposed along a first direction on the display device; and
a first control apparatus that provides signals having a predetermined frequency to the first electrodes and to detect a first coordinate corresponding to a position selected by the purchaser in the first direction on the basis of changes in the signals, and

the receiving means receives a commodity corresponding to a commodity image identified based on the first coordinate, as having been selected by the purchaser.

(Supplementary Note 26)

The store system according to Supplementary Note 25, wherein

the first control apparatus measures power generated by the signals provided to the first electrodes and calculates the first coordinate using measurement results of the first electrodes, and

the receiving means identifies a commodity image displayed in a position corresponding to the first coordinate on the display device and receives a commodity corresponding to the identified commodity image, as having been selected.

(Supplementary Note 27)

The store system according to Supplementary Note 25 or 26, wherein the association instruction means acquires the purchaser identification information from the detected first coordinate and makes an instruction to associate the commodity identification information and the acquired purchaser identification information with each other.

(Supplementary Note 28)

The store system according to any one of Supplementary Notes 25 to 27, wherein

the receiving means comprises:
a plurality of second electrodes disposed along a second direction on the display device; and
a second control apparatus that detects a second coordinate corresponding to a position selected by the purchaser in the second direction on the basis of changes in signals on the second electrodes, and

the receiving means receives a commodity corresponding to a commodity image identified based on the first and second coordinates as having been selected by the purchaser.

(Supplementary Note 29)

The store system according to Supplementary Note 28, wherein the second control apparatus detects the second coordinate using power provided by the first control apparatus.

(Supplementary Note 30)

The store system according to Supplementary Note 28 or 29, wherein

after detecting the first coordinate, the first control apparatus selects a first electrode corresponding to the first coordinate and provides the signal to the selected first electrode,

the second control apparatus measures, with respect to each of the second electrodes, power generated by the signal provided to the selected first electrode and calculates the second coordinate using measurement results of the second electrodes, and

the receiving means identifies a commodity image corresponding to the first and second coordinates among the commodity images and receives a commodity corresponding to the identified commodity image, as having been selected by the purchaser.

(Supplementary Note 31)

The store system according to any one of Supplementary Notes 28 to 30, wherein the association instruction means acquires the purchaser identification information from the detected first and second coordinates and makes an instruction to associate the commodity identification information and the acquired purchaser identification information with each other.

(Supplementary Note 32)

The store system according to any one of Supplementary Notes 25 to 31, wherein

the first control apparatus comprises:
a shift register; and
a transmission/reception circuit disposed at ends of the first electrodes,

the transmission/reception circuit comprises:
a transmission amplifier circuit;
means that changes a polarity of a transmission signal on the basis of a signal from the shift register; and
means that changes a channel of a reception signal on the basis of a signal from the shift register.

(Supplementary Note 33)

The store system according to any one of Supplementary Notes 28 to 31, wherein

the first electrodes are vertical electrodes that vertically cross a surface of the display device and are horizontally disposed at predetermined intervals,

the second electrodes are horizontal electrodes that horizontally cross the surface of the display device and are vertically disposed at predetermined intervals,

the first control apparatus is an X-side control apparatus that provides high-frequency signals to the vertical electrodes and to measure changes in the high-frequency signals, the second control apparatus is a Y-side control apparatus that measures high-frequency signals from the horizontal electrodes, and

the receiving means comprises:
a vertical electrode connecting line connected to the X-side control apparatus;
a vertical electrode connecting line switch connecting the vertical electrode connecting line and the vertical electrodes;
a horizontal electrode connecting line connected to the Y-side control apparatus;
a horizontal electrode connecting line switch connecting the horizontal electrode connecting line and the horizontal electrodes;
an inter-vertical electrode switch connecting two vertical electrodes; and
an inter-horizontal electrode switch connecting two horizontal electrodes.

### (Supplementary Note B1)

An information access system comprising:

a front yard comprising:
display means that displays a plurality of images,
receiving means that receives, from a user, selection of an object of use desired by the user from among objects of use corresponding to the displayed images;
association instruction means that acquires, from the user, user identification information identifying the user and makes an instruction to associate object-of-use identification information identifying the selected desired object of use and the acquired user identification information with each other; and
handover means that hands over the selected desired object of use to the user; and

a backyard adjacent to the front yard, the backyard comprising:
object-of-use storage means that stores a plurality of objects of use corresponding to the images; and
sending means that takes out the selected desired object of use from the object-of-use storage means on the basis of the associated object-of-use identification information and user identification information and sends the taken-out desired object of use to the handover means.

(Supplementary Note C1)

An information processing apparatus comprising:

a display device that displays a image;

terminal position detection means disposed on the display device and that detects a position of a terminal which has approached the display device;

read/write means that reads identification information included in the detected terminal and writes predetermined information to the terminal; and

a control apparatus that identifies, from the position of the detected terminal, an image displayed adjacent to the position and causes the read/write means to write information associated with the identified image to the terminal.

(Supplementary Note D1)

An information processing apparatus comprising:

an emergency power supply;

first communication means that performs communication via a closed network for communicating particular information to be used for a particular purpose;

second communication means that performs communication via an open network for communicating information which is not limited to the particular information;

acquisition means that acquires, from a terminal storing user information related to a user, the user information; and

control means that causes the first communication means to communicate the particular information via the closed network on the basis of the user information and causes the second communication means to communicate information other than the particular information via the open network on the basis of the user information, wherein

when the second communication means fails to perform communication via the open network, the control means operates based on the emergency power supply and causes the first communication means to communicate information other than the particular information via the closed network on the basis of the acquired user information.

(Supplementary Note D2)

The information processing apparatus according to Supplementary Note D1, wherein when the control means causes the first communication means to communicate information other than the particular information, the control means determines whether to permit the communication, on the basis of the user information.

(Supplementary Note E1)

A position detection apparatus comprising:

a display device;

a plurality of first electrodes disposed along a first direction on the display device;

first electrode group selection means that provides signals having a predetermined frequency to the first electrodes and selects a group of first electrodes on the basis of changes in the signals, the group of first electrodes being some of the first electrodes; and

control means that detects a position on the display device on the basis of the positions of the group of first electrodes, the position on the display device being a position that an electromagnetic wave radiator has contacted or approached.

(Supplementary Note E2)

The position detection apparatus according to Supplementary Note E1, wherein the first electrode group selection means measures the signals of the first electrodes, calculates positions on the display device on the basis of results of the measurements, and selects electrodes corresponding to the calculated positions, as the group of first electrodes.

(Supplementary Note E3)

The position detection apparatus according to Supplementary Note E1 or E2, further comprising:

a plurality of second electrodes; and

second electrode group selection means that measures signals that occur on the second electrodes and selects a group of second electrodes on the basis of changes in the signals, the group of second electrodes being some of the second electrodes, wherein

the control means detects a position on the display device on the basis of the positions of the group of first electrodes and positions of the group of second electrodes, the position on the display device being a position that the electromagnetic wave radiator has contacted or approached.

(Supplementary Note E4)

The position detection apparatus according to Supplementary Note E3, wherein the second electrode group selection means measures the signals of the second electrodes, calculates positions on the display device on the basis of results of the measurements, and selects electrodes corresponding to the calculated positions, as the group of second electrodes.

(Supplementary Note E5)

The position detection apparatus according to Supplementary Note E3 or E4, wherein the second electrode group selection means selects the group of second electrodes using power provided by the first electrode group selection means.

(Supplementary Note E6)

The position detection apparatus according to any one of Supplementary Notes E1 to E5, wherein

the first electrode group selection means comprises:
a shift register; and
a transmission/reception circuit disposed at ends of the first electrodes, wherein

the transmission/reception circuit comprises:
a transmission amplifier circuit;
means that changes a polarity of a transmission signal on the basis of a signal from the shift register; and
means that changes a channel of a reception signal on the basis of a signal from the shift register.

(Supplementary Note E7)

The position detection apparatus according to any one of Supplementary Notes E3 to E5, wherein

the first electrodes are vertical electrodes that vertically cross a surface of the display device and are horizontally disposed along at predetermined intervals,

the second electrodes are horizontal electrodes that horizontally cross the surface of the display device and are vertically disposed at predetermined intervals,

the first electrode group selection means is an X-side control apparatus that provides high-frequency signals to the vertical electrodes and measures changes in the high-frequency signals,

the second electrode group selection means is a Y-side control apparatus that measures high-frequency signals from the horizontal electrodes, further comprising:

a vertical electrode connecting line connected to the X-side control apparatus;

a vertical electrode connecting line switch connecting the vertical electrode connecting line and the vertical electrodes;

a horizontal electrode connecting line connected to the Y-side control apparatus;

a horizontal electrode connecting line switch connecting the horizontal electrode connecting line and the horizontal electrodes;

an inter-vertical electrode switch connecting two vertical electrodes; and

an inter-horizontal electrode switch connecting two horizontal electrodes.

(Supplementary Note E8)

The position detection apparatus according to any one of Supplementary Notes E1 to E7, further comprising:

a storage apparatus; and

acquisition means that acquires data from the radiator, wherein the radiator holds identification information of the radiator, and

the control means causes the acquisition means to acquire the identification information of the radiator from the detected position, associates the acquired identification information and information related to the image for selection displayed in the detected position with each other, and stores the associated information in the storage apparatus.

(Supplementary Note E9)

The position detection apparatus according to any one of Supplementary Notes E1 to E8, wherein

the images for selection are associated with layered information, and

when the control means detects a position on the display device that the radiator has contacted or approached, the control means displays, on the display device, an image for selection corresponding to information in a layer other than information associated with the image for selection displayed in the detected position, in place of the displayed image for selection.

(Supplementary Note F1)

A method for controlling a position detection apparatus, comprising:

providing high-frequency signals to a plurality of first electrodes disposed along a first direction on a display device;

performing first measurements on the high-frequency signals from the first electrodes; and

detecting a position on the display device on the basis of results of the first measurements, the position on the display device being a position that a electromagnetic wave radiator has contacted or approached.

(Supplementary Note F2)

The method for controlling a position detection apparatus according to Supplementary Note F1, wherein

a first coordinate in the first direction is calculated on the basis of the results of the first measurements,

a group of first electrodes corresponding to the first coordinate are selected from among the first electrodes,

the high-frequency signals are provided to the selected group of first electrodes,

second measurements are performed on high-frequency signals from the second electrodes disposed along the second direction on the display device,

a second coordinate in the second direction is calculated on the basis of results of the second measurements, and

a position identified from the first and second coordinates on the display device is detected as the position on the display device that the electromagnetic wave radiator has contacted or approached.

(Supplementary Note F3)

The method for controlling a position detection apparatus according to Supplementary Note F1 or F2, wherein

a plurality of images for selection are displayed on the display device;

identification information of the radiator is acquired from the radiator on the basis of the detected position; and

information related to an image for selection displayed in the detected position, of the images for selection is associated with the acquired identification information.

(Supplementary Note G1)

A position detection apparatus comprising:

a display device on which a plurality of regions are defined;

a plurality of electromagnetic wave processing means disposed on the display device and corresponding to the regions, respectively; and

detection means that detects a selection position on the display device that an electromagnetic wave radiator has contacted or approached, wherein

each of the electromagnetic wave processing means emits electromagnetic waves outward and receives electromagnetic waves which are emitted by a radiator in response to the electromagnetic waves, and

the detection means identifies electromagnetic wave processing means which has received the electromagnetic waves from the radiator and detects a region corresponding to the identified electromagnetic wave processing means as the selection position.

(Supplementary Note G2)

The position detection apparatus according to Supplementary Note G1, wherein the radiator holds identification information of the radiator, further comprising:

acquisition means that acquires the identification information from the radiator via the identified electromagnetic wave processing means; and

association means that associates the acquired identification information with a region corresponding to the identified electromagnetic wave processing means and stores the associated information in a storage apparatus.

(Supplementary Note G3)

The position detection apparatus according to Supplementary Note G3, wherein

an image for selection is displayed in each of the regions on the display device, and

the association means identifies an image for selection displayed in the region corresponding to the identified electromagnetic wave processing means, associates information related to the identified image for selection with the acquired identification information, and stores the associated information in the storage apparatus.

While the invention of the present application has been described with reference to the embodiments, the invention is not limited thereto. Various changes understandable for those skilled in the art can be made to the configurations or details of the invention of the present application without departing from the scope of the invention.

The present application claims priority based on Japanese Patent Application No. 2011-078444, filed on Mar. 31, 2011, the disclosure of which is incorporated herein in its entirety.

### REFERENCE SIGNS LIST

### Reference Signs List

100 store system
11 front yard
111 display unit
112 receiving unit
113 association instruction unit
114 handover unit
12 backyard
121 commodity storage unit
122 sending unit
300 purchaser
300a purchaser
300b purchaser
300c purchaser
300d purchaser
300e purchaser
300f purchaser
301 device
301a device
302 purchaser ID
303 display unit
200 store system
200a store system
200b store system
21 front yard
21a front yard
21b front yard
211 display apparatus
212 commodity information IF
212a commodity information IF
213 purchaser ID input apparatus
214 commodity receiving unit
215 commodity information storage unit
215a commodity information storage unit
216 purchase information storage unit
217 commodity refund unit
218 related information output apparatus
22 backyard
22a backyard
221 commodity storage unit
222 sending unit
41 commodity image
42 commodity ID
41a typical commodity image
43 commodity-related information
431 detailed image
432 physical quantity ID
44 high-level specialist image
45 salesclerk image
46 purchase support information
51 commodity, selection information
52 sending information
61a commodity
61b commodity
62a sending mean
63a arrival and return means
64 shipping means
64a shipping means
64b shipping means
64c shipping means
65x sending container
65y sending container
65z sending container
65w sending container
66 temporary standby place
66a temporary standby place
66b temporary standby place
67 backyard terminal
68a commodity shelf
62b sending means
63b arrival and return means
68b commodity shelf
71a counter region
711a commodity image
712a high-level specialist image
71b counter region
711b commodity image
71c counter region
711c commodity image
721 salesclerk image
722 purchaser ID input means
723 commodity receiving window
724 purchaser ID input means
725 commodity refund window
211a display apparatus
211b display apparatus
211c display apparatus
211d display apparatus
211e display apparatus
2.11E+03 display regions
2.11E+04 display regions
311a IC card
312a purchaser ID
311b IC card
312b purchaser ID
321a mobile terminal
321b mobile terminal
711 commodity image
713 ultrasonic actuator-sensor arrays
714 RFID readers/writers
715 electrode
715a electrode
715b electrode
715c electrode
715d electrode
715e electrode
715f electrode
716 electrode spacing
716a electrode spacing
716b electrode spacing
717 boundary
400 control apparatus
401 CPU
402 RAM
403 ROM
404 communication IF
405 hard disk
406 control program
900 store system
91 purchaser
911 IC card
912 purchaser ID
92 store A
921 salesclerk
922 commodity sample
923 store terminal
93 store B
931 salesclerk
932 commodity sample
933 store terminal
94 store C
941 salesclerk
942 commodity sample
943 store terminal
95 common warehouse
951 worker
952 store A inventory
953 store B inventory
954 store inventory C
96 receiving place
2800 display apparatus
2801 display device
2802 IC card
2803 vertical electrode
2804 horizontal electrode
2805 vertical electrode connecting line
2806 horizontal electrode connecting line
2807 vertical electrode connecting line switch
2808 horizontal electrode connecting line switch
2809 X-side control apparatus
2810 Y-side control apparatus
2811 reader/writer
2812 inter-vertical electrode switch
2813 inter-horizontal switch
Pth threshold power
Xe1 and Xe2 coordinate
Xc1 coordinate
P1 position
P2 position
P3 position
P4 position
P5 point
P6 point
P7 point
P8 point
3801 substrate
3802 first X-side circuit
3803 second X-side circuit
3804 first Y-side circuit
3805 second Y-side circuit
3806 spacer
100a store system
100b store system
11 a front yard
111a display unit
13 commodity delivery unit
100c information access system
100d information access system
300g user
321c mobile terminal
11b front yard
112a receiving unit
113a association instruction unit
114a handover unit
12a backyard
121a storage unit
1211 archive
1212 knowledge DB
122a sending unit
1221 handling
1222 controller
11c front yard
111b display unit
112b receiving unit
113b association instruction unit
114b handover unit
115 personal DB
1151 personal ID
1152 personal information
4601 X-side control
4602 X-side control
4603 Y-side control
4604 Y-side control
4701 positive shift register
4702 negative shift register
4703 transmission/reception circuits
4704 transmission selection circuit
4705 transmission amplifier circuit
4706 filter/matching/detection circuit
4707 receiving amplifier circuit
4708 receiving selection circuit
4709 modulation circuit
4710 function
4711 inductance component
4712 control circuit
4801 amplifier transistor
4802 inductance
4803 capacitor
4901 inductance
4802 first capacitor
4803 second capacitor
4904 detection capacitor
100e information access system
5101 pop-up screen
5102 communication apparatus
5103 emergency power supply
112c receiving unit
113c association unit
114c handover unit
300g user
300h user
100f information access system
5201 Internet
5202 administrative network
5203 wireless-communication cell
5204 battery
5205 administrative communication apparatus
5206 communication apparatus
5300 position detection apparatus
5300a position detection apparatus
5300b position detection apparatus
5301 display device
5302 first electrode
5302a group of first electrodes
5303 first electrode selection means
5304 control means
5304a control means
5304b control means
5305 second electrode
5305a group of second electrodes
5306 second electrode selection means
5307 reader/writer
5308 storage apparatus
322 radiator
322a IC card
3221 ID
531 image for selection
0.532 image for selection
533 image for selection
534 image for selection
535 image for selection
5900 position detection apparatus
5900a position detection apparatus
5900b position detection apparatus
5900c position detection apparatus
5900d position detection apparatus
5900e position detection apparatus
5900f position detection apparatus
5900g position detection apparatus
5900g1 display region
5900g2 display region
5901 display device
5902 regions
5903 electromagnetic wave processing means
5904 detection means
5905 acquisition means
5906 association means
5906a association means
5907 storage apparatus
5908 image for selection
6201 image for selection
6202 ultrasonic actuator-sensor arrays
6203 RFID readers/writers
6204 electrode
6204a electrode
6204b electrode
6204c electrode
6204d electrode
6204e electrode
6204f electrode
6205 electrode spacing
6205a electrode spacing
6205b electrode spacing
6206 boundary
313a purchaser ID
313b purchaser ID

1. A store system comprising:
a front yard comprising:
a display unit that displays a plurality of commodity images;
a receiving unit that receives, from a purchaser, selection of a commodity desired by the purchaser from among commodities corresponding to the displayed commodity images;
an association instruction unit that acquires, from the purchaser, purchaser identification information identifying the purchaser and makes an instruction to associate commodity identification information identifying the selected commodity and the acquired purchaser identification information with each other; and
a handover unit that hands over the selected desired commodity to the purchaser; and
a backyard adjacent to the front yard, the backyard comprising:
a commodity storage unit that stores the commodities corresponding to the commodity images; and
a sending unit that takes out the selected commodity from the commodity storage unit on the basis of the associated commodity identification information and purchaser identification information and sends the taken-out commodity as the commodity desired by the purchaser to the handover unit.

2. The store system according to claim 1, wherein
the receiving unit receives selection of two or more commodities from the purchaser,
the association instruction unit makes an instruction to associate pieces of commodity identification information of the selected commodities and the acquired purchaser identification information with each other, and
the sending unit takes out all the selected commodities from the commodity storage unit on the basis of the associated pieces of commodity identification information of the commodities and purchaser identification information and sends all the taken-out commodities collectively to the handover unit.

3. The store system according to claim 2, further comprising a storage unit that stores commodity selection information obtained by associating the commodity identification information and the purchaser identification information with each other one-on-one and sending information which is a list of pieces of commodity identification information of the selected two or more commodities corresponding to each of the purchaser identification information, wherein
each time the purchaser selects a commodity, the association instruction unit makes an instruction to associate commodity identification information of the selected commodity and the acquired purchaser identification information with each other and stores the associated information as commodity selection information in the storage unit, and
the sending unit reads pieces of commodity selection information from the storage unit, organizes pieces of commodity identification information corresponding to the purchaser identification information, stores the organized information as sending information in the storage unit, and takes out all commodities selected by the purchaser from the commodity storage unit on the basis of the sending information.

4. The store system according to claim 1, wherein the front yard further comprises refund unit, wherein
after the purchaser makes payment for the desired commodity and the handover unit hands over the desired commodity, the refund unit receives the desired commodity and, if no abnormality is found when the received commodity is checked, makes a refund for the commodity to the purchaser.

5. The store system according to claim 1 wherein the receiving unit receives, from the purchaser, a request to output related information related to the commodities corresponding to the displayed commodity images and makes an instruction to output the related information.

6. The store system according to claim 5, wherein the receiving unit makes an instruction to output, as the related information, a physical quantity which stimulates the sense of sight, hearing, smell, taste, or touch related to the commodities.

7. The store system according to claim 1, wherein
the display unit is divided into a plurality of regions,
the association instruction unit comprises a plurality of association instruction unit, and the plurality of association instruction unit are disposed in the regions, respectively, and
when the purchaser selects a commodity image displayed in one of the regions of the display unit, association instruction unit disposed in the region acquires the purchaser identification information from the purchaser and makes an instruction to associate the acquired purchaser identification information and commodity identification information of a commodity corresponding to the selected commodity image with each other.

8. The store system according to claim 1, wherein
the receiving unit and the association instruction unit comprise a plurality of receiving unit and a plurality of association instruction unit, respectively, and
the plurality of receiving unit and the plurality of association instruction unit are disposed on the display unit at predetermined intervals.

9. A method for controlling a store system, the store system including a front yard that receives, from a purchaser, selection of a commodity desired by the purchaser and hands over the selected, desired commodity to the purchaser and a backyard adjacent to the front yard, the backyard including a commodity storage unit that stores a plurality of commodities, the method comprising:
displaying a plurality of commodity images on a display apparatus included in the front yard;
in the front yard, receiving, from a purchaser, selection of a commodity desired by the purchaser from among commodities corresponding to the displayed commodity images;
in the front yard, acquiring purchaser identification information identifying the purchaser;
in the front yard, associating commodity identification information identifying the selected commodity and the acquired purchaser identification information with each other;
in the backyard, taking out the selected commodity from the commodity storage unit on the basis of the associated commodity identification information and purchaser identification information; and
in the backyard, sending the taken-out commodity as the commodity desired by the purchaser to the front yard.

10. A non-transitory computer-readable medium storing a control program for causing a computer to perform a process of controlling a store system, the store system including a front yard that receives, from a purchaser, selection of a commodity desired by the purchaser and hands over the selected, desired commodity to the purchaser and a backyard adjacent to the front yard, the backyard including a commodity storage unit that stores a plurality of commodities, the process comprising:
displaying a plurality of commodity images on a display apparatus included in the front yard;
in the front yard, receiving, from a purchaser, selection of a commodity desired by the purchaser from among commodities corresponding to the displayed commodity images;
in the front yard, acquiring purchaser identification information identifying the purchaser;
in the front yard, associating commodity identification information identifying the selected commodity and the acquired purchaser identification information with each other;
in the backyard, taking out the selected commodity from the commodity storage unit on the basis of the associated commodity identification information and purchaser identification information; and
in the backyard, sending the taken-out commodity as the commodity desired by the purchaser to the front yard.

11. The store system according to claim 1, further a comprising delivery unit that delivers the desired commodity to the purchaser using transportation unit, wherein
the front yard receives, from the purchaser, selection as to whether to deliver the desired commodity, and
when the front yard receives selection indicating that the desired commodity is to be delivered, the sending unit sends the taken-out commodity to the delivery unit.

12. The store system according to claim 1, wherein
the display unit displays the commodity images on a display device, and
the receiving unit comprises:
a plurality of first electrodes disposed along a first direction on the display device; and
a first control apparatus configured to provide signals having a predetermined frequency to the first electrodes and to detect a first coordinate corresponding to a position selected by the purchaser in the first direction on the basis of changes in the signals, and
the receiving unit receives a commodity corresponding to a commodity image identified based on the first coordinate, as having been selected by the purchaser.

13. The store system according to claim 12, wherein
the first control apparatus measures power generated by the signals provided to the first electrodes and calculates the first coordinate using measurement results of the first electrodes, and
the receiving unit identifies a commodity image displayed in a position corresponding to the first coordinate on the display device and receives a commodity corresponding to the identified commodity image, as having been selected.

14. The store system according to claim 12, wherein the association instruction unit acquires the purchaser identification information from the detected first coordinate and makes an instruction to associate the commodity identification information and the acquired purchaser identification information with each other.

15. The store system according to claim 12, wherein
the receiving unit comprises:
a plurality of second electrodes disposed along a second direction on the display device; and
a second control apparatus configured to detect a second coordinate corresponding to a position selected by the purchaser in the second direction on the basis of changes in signals on the second electrodes, and
the receiving unit receives a commodity corresponding to a commodity image identified based on the first and second coordinates as having been selected by the purchaser.

16. The store system according to claim 15, wherein the second control apparatus detects the second coordinate using power provided by the first control apparatus.

17. The store system according to claim 15, wherein
after detecting the first coordinate, the first control apparatus selects a first electrode corresponding to the first coordinate and provides the signal to the selected first electrode,
the second control apparatus measures, with respect to each of the second electrodes, power generated by the signal provided to the selected first electrode and calculates the second coordinate using measurement results of the second electrodes, and
the receiving unit identifies a commodity image corresponding to the first and second coordinates among the commodity images and receives a commodity corresponding to the identified commodity image, as having been selected by the purchaser.

18. The store system according to claim 15, wherein the association instruction unit acquires the purchaser identification information from the detected first and second coordinates and makes an instruction to associate the commodity identification information and the acquired purchaser identification information with each other.

19. The store system according to claim 12, wherein
the first control apparatus comprises:
a shift register; and
a plurality of transmission/reception circuits disposed at ends of the first electrodes,
the transmission/reception circuit comprises:
a transmission amplifier circuit;
a first changing unit configured to change a polarity of a transmission signal on the basis of a signal from the shift register; and
a second changing unit configured to change a channel of a reception signal on the basis of a signal from the shift register.

20. The store system according to claim 15, wherein
the first electrodes are vertical electrodes that vertically cross a surface of the display device and are horizontally disposed at predetermined intervals,
the second electrodes are horizontal electrodes that horizontally cross the surface of the display device and are vertically disposed at predetermined intervals,
the first control apparatus is an X-side control apparatus configured to provide high-frequency signals to the vertical electrodes and to measure changes in the high-frequency signals,
the second control apparatus is a Y-side control apparatus configured to measure high-frequency signals from the horizontal electrodes, and
the receiving unit comprises:
a vertical electrode connecting line connected to the X-side control apparatus;
a vertical electrode connecting line switch connecting the vertical electrode connecting line and the vertical electrodes;
a horizontal electrode connecting line connected to the Y-side control apparatus;
a horizontal electrode connecting line switch connecting the horizontal electrode connecting line and the horizontal electrodes;
plurality of inter-vertical electrodes switch connecting two vertical electrodes; and
plurality inter-horizontal electrodes switch connecting two horizontal electrodes.

21.-39. (canceled)
